(19) United States
(12) Patent Application Publication
(10) Pub. No.: US 2026/0288494 A1
(43) Pub. Date: Sep. 24, 2026

(54) METHODS AND SYSTEMS FOR DYNAMICALLY GENERATING BUILD INSTRUCTIONS FOR SUBSTATION ALLOCATION

(71) Applicant: Starbucks Corporation, Seattle, WA (US)

(72) Inventors: Izaak M. Koller, Seattle, WA (US); Erich W. Hacker, Seattle, WA (US); Lucas S. Abrahamsen, Seattle, WA (US); Stephanie W. Lim, Seattle, WA (US); Lynnea M. Paddock, Shoreline, WA (US)

(21) Appl. No.: 19/570,640

(22) Filed: Mar. 18, 2026

Related U.S. Application Data
(60) Provisional application No. 63/774,541, filed on Mar. 19, 2025.

(51) Int. Cl. G06F 9/451; A47J 31/00; G06F 3/14

(52) U.S. Cl. CPC G06F 9/451; A47J 31/002; G06F 3/1423

(57) ABSTRACT

A method for preparing a beverage can include receiving one or more drink orders and adding the one or more beverage orders on a master queue. The method can also include receiving a selection of the one or more beverage orders on the queue and building one or more recipes for the selected beverage orders on the master queue. The method can further include sending build steps from the one or more recipes to corresponding substations. For each of the build steps, the method can include instructing the corresponding substation to dispense an ingredient or execute an action. To enable multiple users to simultaneously prepare beverage orders, beverage orders from the master queue can be allocated to a first queue for a first user and a second queue for a second user based on priority and capacity.

### RELATED APPLICATIONS

This application claims priority under 35 U.S.C. § 119 to U.S. Provisional Patent Application No. 63/774,541, filed Mar. 19, 2025, and entitled “METHODS AND SYSTEMS FOR DYNAMICALLY GENERATING BUILD INSTRUCTIONS FOR SUBSTATION ALLOCATION,” which is considered part of the disclosure of this application and the entire contents of which is hereby incorporated by reference.

### FIELD

The present disclosure relates to systems and methods for dynamically generating build instructions associated with an object for substation allocation and in certain embodiments.

### BACKGROUND

Beverages at a coffee store can include a large number of ingredients that can be combined in various ways and at various doses for customized beverages.

### SUMMARY

The systems, methods and devices of this disclosure each have several innovative aspects, no single one of which is solely responsible for the desirable attributes disclosed herein.

The systems, methods, and/or devices described herein can be implemented in fast-paced environments, such as a coffee shop, where vast amounts of orders can be continuously received while orders are simultaneously being built. The orders can be selected from a vast quantity of recipes, and the recipes themselves can include different and numerous ingredients, quantities of ingredients, sizes, preparation methods, etc., which can be modified to suit customer preferences. Furthermore, the orders may be built within a short time of receipt (e.g., three minutes, five minutes, etc.). Disclosed herein are systems, such as beverage preparation systems, methods, and/or devices to prepare beverage orders and/or other orders in real-time as orders are received with a speed, efficiency, and/or accuracy that greatly exceeds what individuals preparing orders could accomplish without the disclosed systems and methods. The beverage preparation systems can enable two users to prepare beverage orders as a team with one user performing initial build steps for a recipe and another user performing finishing build steps for the recipe. The beverage preparation systems can enable two users to prepare beverage orders separately and simultaneously at the same beverage preparation system.

The beverage preparation system can include one or more main displays (e.g., dashboards) that show a beverage order to be prepared. The displayed beverage order can include build steps that can be grouped into sets that correspond to different actions. For example, the build steps (e.g., dispensing steps) to be performed prior to blending one or more ingredients can be grouped together as a set and the build steps to be performed after blending the one or more ingredients can be grouped together as a set. When users are working together as a team to complete a beverage order, one user can perform the build steps for one set and the other user can perform the build steps for another set. When users are working separately but simultaneously on different beverage orders, the same user can perform the build steps for the two sets.

When users are working separately but simultaneously, received beverage orders can be allocated from a master queue of beverage orders to separate queues displayed on a first main display associated with the first user and a second main display associated with the second user. The allocation of the beverage orders can be based on priority (e.g., time of order receipt), capacity, and/or other criteria. For example, the queues of the first main display and the second main display can have the same capacity (e.g., two beverage orders allocated, one beverage order allocated) and can be filled such that the queue with the least number of allocated beverage orders receives the highest priority (e.g., oldest) beverage order from the master queue until the capacities of the queues of the first and second main displays are filled. In the event of a tie between the queues for the first main display and the second main display, the queue for the first main display can take priority over the second main display and receive the next highest priority (e.g., oldest) beverage order from the master queue.

When a user selects a beverage order from one of the main displays, build instructions for the recipe of the selected beverage order can be sent to substations configured to dispense ingredients according to the recipe. The substations can include displays that can display instructions and/or information guiding a user to complete build steps according to the recipe. With multiple beverage orders being prepared, graphical user interfaces displayed on the displays of the substations can include visual order identifiers, such as colors, patterns, and/or graphics, that correspond (e.g., are the same as or similar to) a visual order identifier for the corresponding beverage order displayed on a main display. A substation display can, in some variants, simultaneously display graphical user interfaces associated with different beverage orders, which can indicate the dispensing status of the ingredients to be dispensed by the substation.

In some variants, the techniques described herein relate to a system for dynamically allocating objects between first and second queues, the system including: one or more processors; and a computer-readable storage medium including machine-readable instructions that, when executed by the one or more processors, cause the one or more processors to: receive one or more objects; add the one or more objects to a master queue; alternately allocate a highest priority object from the one or more objects of the master queue to a first main display queue or a second main display queue until a first capacity of the first main display queue is reached and a second capacity of the second main display queue is reached; determine if a highest priority object of the first main display queue is complete; in response to determining that the highest priority object of the first main display queue is complete, add a highest priority object from the master queue to the first main display queue; determine if a highest priority object of the second main display queue is complete; in response to determining that the highest priority object of the second main display queue is complete, add a highest priority object from the master queue to the second main display queue; cause display, via one or more first main displays, a first graphical user interface with one or more objects of the first main display queue; and cause display, via one or more second main displays, a second graphical user interface with one or more objects of the second main display queue.

In some variants, the techniques described herein relate to a system, wherein execution of the machine-readable instructions by the one or more processors, further causes the one or more processors to: dynamically generate computer-executable build instructions for building each of the one or more objects of the first main display queue and the second main display queue; group portions of the computer-executable build instructions for each of the one or more objects of the first main display queue and the second main display queue into build sets based on one or more actions for building the one or more objects of the first main display queue and the second main display queue; and cause display, via the one or more first main displays or the one or more second main displays, the build sets of the one or more objects of the first main display queue and the second main display queue.

In some variants, the techniques described herein relate to a system, wherein execution of the machine-readable instructions by the one or more processors, further causes the one or more processors to: identify one or more substations, each of the one or more substations corresponding to a respective portion of the computer-executable build instructions; and transmit the respective portion of the computer-executable build instructions to each of the one or more substations, wherein each of the one or more substations executes a respective portion of the computer-executable build instructions, wherein executing a respective portion of the computer-executable build instructions causes each of the one or more substations to perform a build step to build the one or more objects of the first main display queue and the second main display queue; and cause display, via one or more displays of the one or more substations, the build step.

In some variants, the techniques described herein relate to a system, wherein execution of the machine-readable instructions by the one or more processors, further causes the one or more processors to: cause display, via one of the one or more displays of the one or more substations, the build steps for two objects simultaneously.

In some variants, the techniques described herein relate to a system, wherein execution of the machine-readable instructions by the one or more processors, further causes the one or more processors to: cause display, via the one or more first main displays, for each of the one or more objects of the first main display queue, a first main visual identifier; cause display, via the one or more second main displays, for each of the one or more objects of the second main display queue, a second main visual identifier; cause display, via the one or more displays of the one or more substations, a substation visual identifier associated with the build information, the substation visual identifier visually corresponding to the first main visual identifier of one of the one or more objects of the first main display queue or to the second main visual identifier of one of the one or more objects of the second main display queue.

In some variants, the techniques described herein relate to a system, wherein the substation visual identifier shares a color with the first main visual identifier of one of the one or more objects of the first main display queue or to the second main visual identifier of one of the one or more objects of the second main display queue.

In some variants, the techniques described herein relate to a system, wherein execution of the machine-readable instructions by the one or more processors, further causes the one or more processors to: cause display, via one or more displays of the one or more substations, the status of the build step.

In some variants, the techniques described herein relate to a system, wherein the status of the build step is one of ready to perform the build step, performing the build step, and the build step is complete.

In some variants, the techniques described herein relate to a system, wherein the build step is dispensing an ingredient.

In some variants, the techniques described herein relate to a system, wherein execution of the machine-readable instructions by the one or more processors, further causes the one or more processors to: cause display, via the first main display, an indication that the build sets of the one or more objects of the first main display queue are active, inactive, or complete; and cause display, via the second main display, an indication that the build sets of the one or more objects of the second main display queue are active, inactive, or complete.

In some variants, the techniques described herein relate to a system for dynamically allocating objects between first and second queues, the system including: one or more processors; and a computer-readable storage medium including machine-readable instructions that, when executed by the one or more processors, cause the one or more processors to: receive one or more objects; add the one or more objects to a master queue; determine if a first quantity of objects on a first main display queue is at a first capacity; in response to determining that the first quantity of objects on the first main display queue is not at the first capacity, add a highest priority object from the master queue to the first main display queue; determine if a second quantity of objects on a second main display queue is at a second capacity; in response to determining that the second quantity of objects on the second main display queue is not at the second capacity, add a highest priority object from the master queue to the second main display queue; cause display, via one or more first main displays, a first graphical user interface with one or more objects of the first main display queue; and cause display, via one or more second main displays, a second graphical user interface with one or more objects of the second first main display queue.

In some variants, the techniques described herein relate to a system, wherein execution of the machine-readable instructions by the one or more processors, further causes the one or more processors to: dynamically generate computer-executable build instructions for building each of the one or more objects of the first main display queue and the second main display queue; group computer-executable build instructions for each of the one or more objects of the first main display queue and the second main display queue into build sets based on one or more actions for building the one or more objects of the first main display queue and the second main display queue; and cause display, via the one or more first main displays or the one or more second main displays, the build sets of the one or more objects of the first main display queue and the second main display queue.

In some variants, the techniques described herein relate to a system, wherein execution of the machine-readable instructions by the one or more processors, further causes the one or more processors to: identify one or more substations, each of the one or more substations corresponding to a respective portion of the computer-executable build instructions; and transmit a respective portion of the computer-executable build instructions to each of the one or more substations, wherein each of the one or more substations executes a respective portion of the computer-executable build instructions, wherein executing a respective portion of the computer-executable build instructions causes each of the one or more substations to perform a build step to build the one or more objects of the first main display queue and the second main display queue; and cause display, via one or more displays of the one or more substations, the build step.

In some variants, the techniques described herein relate to a system, wherein execution of the machine-readable instructions by the one or more processors, further causes the one or more processors to: cause display, via one of the one or more displays of the one or more substations, the build step for two objects simultaneously.

In some variants, the techniques described herein relate to a system, wherein execution of the machine-readable instructions by the one or more processors, further causes the one or more processors to: cause display, via the one or more first main displays, for each of the one or more objects of the first main display queue, a first main visual identifier; cause display, via the one or more second main displays, for each of the one or more objects of the second main display queue, a second main visual identifier; cause display, via the one or more displays of the one or more substations, a substation visual identifier associated with the build information, the substation visual identifier visually corresponding to the first main visual identifier of one of the one or more objects of the first main display queue or to the second main visual identifier of one of the one or more objects of the second main display queue.

In some variants, the techniques described herein relate to a system, wherein the substation visual identifier shares a color with the first main visual identifier of one of the one or more objects of the first main display queue or to the second main visual identifier of one of the one or more objects of the second main display queue.

In some variants, the techniques described herein relate to a system, wherein execution of the machine-readable instructions by the one or more processors, further causes the one or more processors to: cause display, via one or more displays of the one or more substations, the status of the build step.

In some variants, the techniques described herein relate to a system, wherein the status of the build step is one of ready to perform the build step, performing the build step, and the build step is complete.

In some variants, the techniques described herein relate to a system, wherein the build step is dispensing an ingredient.

In some variants, the techniques described herein relate to a system, wherein execution of the machine-readable instructions by the one or more processors, further causes the one or more processors to: cause display, via the first main display, an indication that the build sets of the one or more objects of the first main display queue are active, inactive, or complete; and cause display, via the second main display, an indication that the build sets of the one or more objects of the second main display queue are active, inactive, or complete.

In some variants, the techniques described herein relate to a system for dynamically allocating objects between first and second queues, the system including: one or more processors; and a computer-readable storage medium including machine-readable instructions that, when executed by the one or more processors, cause the one or more processors to: receive one or more objects; add the one or more objects to a master queue; determine if a first quantity of objects of a first main display queue is at a first capacity; determine if a second quantity of objects of a second main display queue is at a second capacity; determine if the first quantity of objects of the first main display queue is less than or equal to the second quantity of objects; in response to determining that the first quantity of objects is not at the first capacity but is less than or equal to the second quantity of objects, add a highest priority object from the master queue to the first main display queue; in response to determining that the first quantity of objects is not at the first capacity and is not less than or equal to the second quantity of objects, add a highest priority object from the master queue to the second main display queue; in response to determining that the first quantity of objects is at the first capacity and the second quantity of objects is not at the second capacity, add a highest priority object from the master queue to the second main display queue; cause display, via one or more first main displays, a first graphical user interface with the one or more objects of the first main display queue; and cause display, via one or more second main displays, a second graphical user interface with the one or more objects of the second first main display queue.

In some variants, the techniques described herein relate to a system, wherein execution of the machine-readable instructions by the one or more processors, further causes the one or more processors to: dynamically generate computer-executable build instructions for building each of the one or more objects of the first main display queue and the second main display queue; group computer-executable build instructions for each of the one or more objects of the first main display queue and the second main display queue into build sets based on one or more actions for building the one or more objects of the first main display queue and the second main display queue; and cause display, via the one or more first main displays or the one or more second main displays, the build sets of the one or more objects of the first main display queue and the second main display queue.

In some variants, the techniques described herein relate to a system, wherein execution of the machine-readable instructions by the one or more processors, further causes the one or more processors to: identify one or more substations, each of the one or more substations corresponding to a respective portion of the computer-executable build instructions; and transmit a respective portion of the computer-executable build instructions to each of the one or more substations, wherein each of the one or more substations executes a respective portion of the computer-executable build instructions, wherein executing a respective portion of the computer-executable build instructions causes each of the one or more substations to perform a build step to build the one or more objects of the first main display queue and the second main display queue; and cause display, via one or more displays of the one or more substations, the build step.

In some variants, the techniques described herein relate to a system, wherein execution of the machine-readable instructions by the one or more processors, further causes the one or more processors to: cause display, via one of the one or more displays of the one or more substations, the build steps for two objects simultaneously.

In some variants, the techniques described herein relate to a system, wherein execution of the machine-readable instructions by the one or more processors, further causes the one or more processors to: cause display, via the one or more first main displays, for each of the one or more objects of the first main display queue, a first main visual identifier; cause display, via the one or more second main displays, for each of the one or more objects of the second main display queue, a second main visual identifier; cause display, via the one or more displays of the one or more substations, a substation visual identifier associated with the build information, the substation visual identifier visually corresponding to the first main visual identifier of one of the one or more objects of the first main display queue or to the second main visual identifier of one of the one or more objects of the second main display queue.

In some variants, the techniques described herein relate to a system, wherein the substation visual identifier shares a color with the first main visual identifier of one of the one or more objects of the first main display queue or to the second main visual identifier of one of the one or more objects of the second main display queue.

In some variants, the techniques described herein relate to a system, wherein execution of the machine-readable instructions by the one or more processors, further causes the one or more processors to: cause display, via one or more displays of the one or more substations, the status of the build step.

In some variants, the techniques described herein relate to a system, wherein the status of the build step is one of ready to perform the build step, performing the build step, and the build step is complete.

In some variants, the techniques described herein relate to a system, wherein the build step is dispensing an ingredient.

In some variants, the techniques described herein relate to a system, wherein execution of the machine-readable instructions by the one or more processors, further causes the one or more processors to: cause display, via the first main display, an indication that the build sets of the one or more objects of the first main display queue are active, inactive, or complete; and cause display, via the second main display, an indication that the build sets of the one or more objects of the second main display queue are active, inactive, or complete.

In some variants, the techniques described herein relate to a system including: one or more processors; and a computer-readable storage medium including machine-readable instructions that, when executed by the one or more processors, cause the one or more processors to: receive two objects; dynamically generate computer-executable build instructions for build steps for building each of the two objects; display, via one or more main displays, the two objects with the build steps; identify one or more substations, each of the one or more substations corresponding to a respective portion of the computer-executable build instructions; transmit the respective portion of the computer-executable build instructions to each of the one or more substations, wherein each of the one or more substations executes a respective portion of the computer-executable build instructions, wherein executing a respective portion of the computer-executable build instructions causes each of the one or more substations to perform the build step to build the one of the two objects; and cause display, via one or more displays of the one or more substations, the build steps, wherein one of the one or more displays of the one or more substations displays the build steps for the two objects simultaneously.

In some variants, the techniques described herein relate to a system, wherein execution of the machine-readable instructions by the one or more processors, further causes the one or more processors to: cause display, via the one or more main displays, for each of the two objects, a main visual identifier; cause display, via the one or more displays of the one or more substations, a substation visual identifier associated with the build step, the substation visual identifier visually corresponding to the main visual identifier of one of the two objects.

In some variants, the techniques described herein relate to a system, wherein the substation visual identifier shares a color with the main visual identifier.

In some variants, the techniques described herein relate to a system, wherein execution of the machine-readable instructions by the one or more processors, further causes the one or more processors to: cause display, via one or more displays of the one or more substations, the status of the build step.

In some variants, the techniques described herein relate to a system, wherein the status of the build step is one of ready to perform the build step, performing the build step, and the build step is complete.

In some variants, the techniques described herein relate to a system, wherein the build step is dispensing an ingredient.

In some variants, the techniques described herein relate to a system, wherein execution of the machine-readable instructions by the one or more processors, further causes the one or more processors to: cause display, via the one or more main displays, one or more build sets for each of the two objects, each of the one or more build sets including a group of build steps associated with a single action for the corresponding object.

In some variants, the techniques described herein relate to a system, wherein the one or more build sets includes an initial build set and a final build set, the initial build set to be attended to by a first user and the final build set to be attended to by a second user.

In some variants, the techniques described herein relate to a system, wherein the one or more build sets includes an initial build set and a final build set, the initial build set and the final build set to be attended to by a single user.

In some variants, the techniques described herein relate to a system including: one or more processors; and a computer-readable storage medium including machine-readable instructions that, when executed by the one or more processors, cause the one or more processors to: receive two objects; dynamically generate computer-executable build instructions for build steps for building each of the two objects; group build steps for each of the two objects into build sets based on one or more actions for building the two objects; display, via one or more main displays, the two objects with the build steps grouped into the build sets; identify one or more substations, each of the one or more substations corresponding to a respective portion of the computer-executable build instructions; transmit the respective portion of the computer-executable build instructions to each of the one or more substations, wherein each of the one or more substations executes a respective portion of the computer-executable build instructions, wherein executing a respective portion of the computer-executable build instructions causes each of the one or more substations to perform a build step to build the one of the two objects; cause display, via one or more displays of the one or more substations, the build steps; and cause display, via the one or more main displays, a status of each of the build sets, wherein the status includes an indication of one of active, inactive, and complete.

In some variants, the techniques described herein relate to a system, wherein the build sets include an initial build set and a final build set, the initial build set to be attended to by a first user and the final build set to be attended to by a second user.

In some variants, the techniques described herein relate to a system, wherein the build sets includes an initial build set and a final build set, the initial build set and the final build set to be attended to by a single user.

In some variants, the techniques described herein relate to a system including: one or more processors; and a computer-readable storage medium including machine-readable instructions that, when executed by the one or more processors, cause the one or more processors to: receive two objects; dynamically generate computer-executable build instructions for build steps for building each of the two objects; group build steps for each of the two objects into build sets based on one or more actions for building the two objects; cause display, via one or more main displays, the two objects with the build steps grouped into the build sets; receive a first selection by a user of a first object of the two objects; identify a first set of one or more substations, each of the first set of one or more substations corresponding to a respective portion of the computer-executable build instructions corresponding to the first object; transmit the respective portion of the computer-executable build instructions for the first object to each of the one or more substations of the first set, wherein each of the one or more substations of the first set executes a respective portion of the computer-executable build instructions corresponding to the first object, wherein executing a respective portion of the computer-executable build instructions for the first object causes each of the first set of one or more substations to perform a build step to build the first object of the two objects; receive one or more indications from the first set of the one or more substations that the one or more build steps associated with the first set of the one or more substations have been performed; determine that a first build set of the build sets associated with the first object has been completed; cause display, via the one or more main displays, a complete status for the first build set of the build sets associated with the first object and an active status for a second build set of the build sets associated with the first object; receive a second selection by the user of a second object of the two objects; and cause display, via the one or more main displays, an active status for a first build set of the build sets associated with the second object.

In some variants, the techniques described herein relate to a system, wherein the grouping of the build steps for the first build set of the build sets associated with the first object is based on a blending action.

In some variants, the techniques described herein relate to a system for dynamically allocating objects between first and second queues, the system including: one or more processors; and a computer-readable storage medium including machine-readable instructions that, when executed by the one or more processors, cause the one or more processors to: receive objects; add the objects to a master queue; allocate the objects from the master queue to a first main display queue associated with a first user and a second main display queue associated with a second user; cause display, via one or more first main displays, a first graphical user interface with the objects allocated to the first main display queue; and cause display, via one or more second main displays, a second graphical user interface with the objects allocated to the second main display queue.

In some variants, the techniques described herein relate to a system, wherein the objects are beverage orders and the allocation of the objects from the master queue to the first main display queue and the second main display queue includes ordering the beverage orders of the first main display queue and the second main display queue to include a non-blended beverage order between blended beverage orders.

In some variants, the techniques described herein relate to a system, wherein the objects are beverage orders and the allocation of the objects from the master queue to the first main display queue and the second main display queue includes ordering the beverage orders of the first main display queue and the second main display queue to avoid sequential blended beverage orders.

In some variants, the techniques described herein relate to a system, wherein the objects are beverage orders and the allocation of the objects from the master queue to the first main display queue and the second main display queue includes allocating blended beverage orders between the first main display queue and the second main display queue based on a blending availability of a first blender associated with the first main display queue and a second blender associated with the second main display queue.

In some variants, the techniques described herein relate to a system, wherein the objects are beverage orders and the allocation of the objects from the master queue to the first main display queue and the second main display queue includes evenly allocating blended beverage orders between the first main display queue and the second main display queue.

In some variants, the techniques described herein relate to a system, wherein the objects are beverage orders and the allocation of the objects from the master queue to the first main display queue and the second main display queue includes alternatingly allocating blended beverage orders between the first main display queue and the second main display queue.

In some variants, the techniques described herein relate to a system, wherein the objects are beverage orders and the allocation of the objects from the master queue to the first main display queue and the second main display queue includes alternatingly allocating beverage orders with an estimated build time above a threshold between the first main display queue and the second main display queue.

In some variants, the techniques described herein relate to a system, wherein the objects are beverage orders and the allocation of the objects from the master queue to the first main display queue and the second main display queue includes alternatingly allocating beverage orders with a number of build steps above a threshold between the first main display queue and the second main display queue.

In some variants, the techniques described herein relate to a system, wherein the objects are beverage orders and the allocation of the objects from the master queue to the first main display queue and the second main display queue includes allocating the objects between the first main display queue and the second main display queue based on one or more characteristics of a first user associated with the first main display queue and/or a second user associated with the second main display queue.

In some variants, the techniques described herein relate to a system, wherein the one or more characteristics includes experience with preparing one or more beverage orders.

In some variants, the techniques described herein relate to a system, wherein the one or more characteristics includes beverage preparation preferences.

In some variants, the techniques described herein relate to a system, wherein the one or more characteristics includes ability.

In some variants, the techniques described herein relate to a system including: one or more processors; and a computer-readable storage medium including machine-readable instructions that, when executed by the one or more processors, cause the one or more processors to: receive a plurality of objects; dynamically generate computer-executable build instructions for build steps for building each of the plurality of objects; group build steps for each of the plurality of objects into build sets based on one or more actions for building the plurality of objects; cause display, via one or more main displays, the plurality of objects with the build steps grouped into the build sets; receive a selection by a user of one or more objects of the plurality of objects; identify one or more substations, each of the one or more substations corresponding to a respective portion of the computer-executable build instructions associated with the selected one or more objects; transmit the respective portion of the computer-executable build instructions associated with the selected one or more objects to each of the one or more substations, wherein each of the one or more substations executes a respective portion of the computer-executable build instructions associated with the selected one or more objects, wherein executing a respective portion of the computer-executable build instructions associated with the selected one or more objects causes each of the one or more substations to perform a build step to build the selected one or more objects of the plurality of objects; cause display, via one or more displays of the one or more substations, the build steps; and cause display, via the one or more main displays, a status of each of the build sets, wherein the status includes an indication of one of active, inactive, and complete.

In some variants, the techniques described herein relate to a system for dynamically allocating objects between first and second queues, the system including: one or more processors; and a computer-readable storage medium including machine-readable instructions that, when executed by the one or more processors, cause the one or more processors to: receive objects; add the objects to a master queue; cause display, via one or more first main displays, a first graphical user interface with the master queue; cause display, via one or more second main displays, a second graphical user interface with the master queue; receive an active status indication from a first user via the one or more first main displays; in response to receiving an active status indication from the first user, allocate one or more objects from the master queue to a first main display queue and display the allocated one or more objects via the one or more first main displays; receive an active status indication from a second user via the one or more second main displays; in response to receiving an active status indication from the second user, allocate one or more objects from the master queue to a second main display queue and display the allocated one or more objects via the one or more second main displays; cause display, via the one or more first main displays, the first graphical user interface with an updated master queue with the one or more objects allocated to the first main display queue and the second main display queue removed; and cause display, via the one or more second main displays, the second graphical user interface with the updated master queue with the one or more objects allocated to the first main display queue and the second main display queue removed.

In some variants, the techniques described herein relate to a system, wherein execution of the machine-readable instructions by the one or more processors, further causes the one or more processors to: receive an inactive status indication from the first user via the one or more first main displays; in response to receiving the inactive status indication from the first user, pause allocation of the one or more objects from the master queue to the first main display queue; receive an inactive status indication from the second user via the one or more second main displays; in response to receiving the inactive status indication from the second user, pause allocation of the one or more objects from the master queue to the second main display queue and display.

In some variants, the techniques described herein relate to a system or method, wherein the objects are beverage orders.

### BRIEF DESCRIPTION OF THE DRAWINGS

Various embodiments are depicted in the accompanying drawings for illustrative purposes, and should in no way be interpreted as limiting the scope of the embodiments. Various features of different disclosed embodiments can be combined to form additional embodiments, which are part of this disclosure.

FIG. 1A schematically illustrates an embodiment of a beverage station.

FIG. 1B schematically illustrates another embodiment of a beverage station.

FIG. 2A is a flow diagram illustrative of a method of creating a beverage.

FIG. 2B is a flow diagram illustrative of a method of creating multiple beverages.

FIG. 3 illustrates a block diagram illustrating an embodiment of a computer hardware system configured to run software for implementing one or more embodiments of the system, methods, and devices disclosed herein.

FIG. 4 illustrates another embodiment of a beverage preparation system or station for multiple users preparing beverages in series.

FIG. 5A is a flow diagram illustrative of a method of controlling beverage order allocation to main display queues.

FIG. 5B is a flow diagram illustrative of a method of controlling beverage order allocation to main display queues.

FIG. 5C is a flow diagram illustrative of a method of controlling beverage order allocation to main display queues.

FIG. 5D is a flow diagram illustrative of a method of controlling beverage order allocation to main display queues.

FIG. 6 illustrates another embodiment of a beverage preparation system or station for multiple users preparing beverages simultaneously.

FIG. 7A illustrates an example master beverage order queue.

FIG. 7B illustrates an example of a graphical user interface for a first main display at a first time.

FIG. 7C illustrates an example of a graphical user interface for a second main display at the first time.

FIG. 7D illustrates an example of the graphical user interface for the first main display at a second time.

FIG. 7E illustrates an example of the graphical user interface for the second main display at a third time.

FIG. 7F illustrates an example of the graphical user interface for the first main display at a fourth time.

FIG. 8A illustrates an example graphical user interface for a main display.

FIG. 8B illustrates example graphical user interface icons.

FIG. 9A illustrates an example graphical user interface for a main display.

FIG. 9B illustrates an example graphical user interface for editing a beverage order on a main display.

FIG. 10A illustrates an example graphical user interface for a main display that indicates a build step for a beverage order has not been started.

FIG. 10B illustrates an example graphical user interface for a main display that indicates a build step for a beverage order is active.

FIG. 10C illustrates an example graphical user interface for a main display that indicates a build step for a beverage order has been completed.

FIG. 11A illustrates an example graphical user interface for a main display that indicates a first build step for a beverage order is active and a second build step for the beverage order has not been started.

FIG. 11B illustrates an example graphical user interface for a main display that indicates a first build step for a beverage order is complete and a second build step for the beverage order has been started.

FIG. 11C illustrates an example graphical user interface for a main display that indicates the first and the second build steps for the beverage order are complete.

FIG. 12A illustrates an example graphical user interface for a main display that indicates ingredient notifications.

FIG. 12B illustrates an example graphical user interface for a main display that indicates ingredient notifications.

FIG. 12C illustrates an ingredient management system for a beverage preparation system or station.

FIG. 13A illustrates an example graphical user interface for a main display that indicates a current queue of beverage orders.

FIG. 13B illustrates an example graphical user interface for a main display that indicates a historical queue of beverage orders.

FIG. 13C illustrates an example graphical user interface for a main display that indicates a current queue of beverage orders with a remake order selected from the historical queue of beverage orders of FIG. 13B.

FIG. 14A illustrates an example graphical user interface for a substation display that indicates an ingredient is ready to be poured.

FIG. 14B illustrates an example graphical user interface for the substation display that indicates an ingredient is being poured.

FIG. 14C illustrates an example graphical user interface for the substation display that indicates the pouring of an ingredient is complete.

FIG. 15 illustrates an example graphical user interface for a substation display for a single user process.

FIG. 16A illustrates an example graphical user interface for a substation display that indicates an ingredient is ready to be poured that is for an active beverage order from the first main display.

FIG. 16B illustrates an example graphical user interface for the substation display of FIG. 16A that indicates an ingredient is ready to be poured that is for an active beverage order from the second main display.

FIG. 17A illustrates an example graphical user interface for a syrup substation display that indicates crème base for a first active beverage order is ready to pour and brown sugar syrup for a second active beverage order is ready to pour.

FIG. 17B illustrates an example graphical user interface for the syrup substation display that indicates crème base for the first active beverage order is ready to pour and the brown sugar syrup for the second active beverage order is pouring.

FIG. 17C illustrates an example graphical user interface for the syrup substation display that indicates crème base for the first active beverage order is ready to pour and the brown sugar syrup for the second active beverage order has been poured.

FIG. 17D illustrates an example graphical user interface for the syrup substation display that indicates crème base for the first active beverage order is ready to pour.

FIG. 17E illustrates an example graphical user interface for the syrup substation display that indicates crème base for the first active beverage order is being poured.

FIG. 17F illustrates an example graphical user interface for the syrup substation display that indicates crème base for the first active beverage order has been poured.

FIG. 18A illustrates an example graphical user interface for a first main display with a first active beverage order.

FIG. 18B illustrates an example graphical user interface for a second main display with a second active beverage order.

FIG. 18C illustrates an example graphical user interface for a first ice substation display that indicates ice for the first active beverage order is currently being poured.

FIG. 18D illustrates a powder substation display.

FIG. 18E illustrates an example graphical user interface for a cold press extract and coffee substation display that indicates signature expresso for the first active beverage order is ready to pour.

FIG. 18F illustrates an example graphical user interface for a syrup substation display that indicates caramel syrup for the first active beverage order is ready to pour.

FIG. 18G illustrates an example graphical user interface for a milk substation display that indicates milk for the first active beverage order is ready to pour.

FIG. 18H illustrates an example graphical user interface for a refresher and tea substation display that indicates pink drink for the second active beverage order is ready to pour.

FIG. 18I illustrates an example graphical user interface for a second ice substation display that indicates ice for the second active beverage order is currently being poured.

FIG. 19A illustrates an example graphical user interface for a first main display with a first active beverage order.

FIG. 19B illustrates an example graphical user interface for a second main display with a second active beverage order.

FIG. 19C illustrates an example graphical user interface for a first ice substation display that indicates ice for the first active beverage order is currently being poured.

FIG. 19D illustrates a powder substation display.

FIG. 19E illustrates an example graphical user interface for a cold press extract and coffee substation display that indicates signature expresso for the first active beverage order is ready to pour.

FIG. 19F illustrates an example graphical user interface for a syrup substation display that indicates Frappuccino roast syrup for the second active beverage order is ready to pour.

FIG. 19G illustrates an example graphical user interface for a milk substation display that indicates milk for the first active beverage order and the second active beverage order is ready to pour.

FIG. 19H illustrates a refresher and tea substation display.

FIG. 19I illustrates an example graphical user interface for a second ice substation display that indicates ice for the second active beverage order has been poured.

FIG. 20A illustrates an example graphical user interface for the syrup substation display that indicates brown sugar syrup for the second active beverage is ready to pour.

FIG. 20B illustrates an example graphical user interface for the syrup substation display to alter the syrup to be poured for the second beverage order.

FIG. 20C illustrates an example graphical user interface for the syrup substation display to alter the syrup to be poured for the second beverage order.

FIG. 20D illustrates an example graphical user interface for the syrup substation display that indicates four units of vanilla syrup for the second active beverage are ready to pour.

FIG. 21 illustrates another embodiment of a beverage preparation system or station for multiple users to prepare beverages simultaneously.

FIG. 22A illustrates an example graphical user interface in an active state for a first main display at a first instance.

FIG. 22B illustrates an example graphical user interface in an inactive state for a second main display at the first instance.

FIG. 22C illustrates an example graphical user interface in an inactive state for the first main display at a second instance.

FIG. 22D illustrates an example graphical user interface in an inactive state for the second main display at the second instance.

FIG. 22E illustrates an example graphical user interface in an active state for the first main display at a third instance.

FIG. 22F illustrates an example graphical user interface in an inactive state for the second main display at the third instance.

FIG. 22G illustrates an example graphical user interface in an active state for the first main display at a fourth instance.

FIG. 22H illustrates an example graphical user interface in an active state for the second main display at the fourth instance.

FIG. 22I illustrates an example graphical user interface in an inactive state for the first main display at a fifth instance.

FIG. 22J illustrates an example graphical user interface in an active state for the second main display at the fifth instance.

### DETAILED DESCRIPTION

Various systems and methods are described below to illustrate various examples that may achieve one or more desired improvements. These examples are only illustrative and not intended in any way to restrict the general disclosure presented and the various aspects and features of this disclosure. The general principles described herein may be applied to embodiments and applications other than those discussed herein without departing from the scope of the disclosure. Indeed, this disclosure is not limited to the particular embodiments shown, but is instead to be accorded the widest scope consistent with the principles and features that are disclosed or suggested herein.

Beverages at a coffee store are often associated with standard (or default) recipes. For example, a standard recipe may be and/or may include a predetermined recipe with specific ingredients and ingredient proportions, designed to yield a particular taste or calorie count, follow a particular dietary restriction, or the like. Conventionally, in response to receiving a beverage order, a barista recollects the recipe from memory and creates the beverage by retrieving ingredients, such as pumping, scooping, or pouring ingredients from their respective containers. In response to receiving multiple beverage orders, a barista can create drinks in sequence, one after the other. In some cases, a barista can prepare multiple drink orders simultaneously, but this can cause a barista to coordinate between steps of the multiple drink orders based on memory and equipment availability. This can be further complicated if the drink orders received are customized, requiring a barista to either memorize the customizations or reference the orders, such as on a display or on a receipt. In many cases, relying on the memory of a barista, can often lead to errors or mistakes.

Furthermore, customers often request modifications or customizations to the standard recipe. For example, a customer may want half the sugar and twice the amount of vanilla flavor, as compared to the standard recipe for a particular beverage. This can cause precise control of dosing various ingredients. Additionally, ingredient modifications often complicate beverage orders and further exacerbate the burden on baristas. For example, a customer ordering a customized beverage may receive a beverage with errors or there can be delays in preparing the beverage, which can negatively affect the customer's experience. Additionally, customization can restrict the ability to create a beverage or create beverages simultaneously, particularly as the operational approach and systems may be designed around specific, pre-determined beverage build recipes.

An aspect of the present disclosure, is the recognition that creating customized beverage can be time consuming and complex. Customized beverages can get increasingly complex and burdensome as recipes change, new recipes are added, and more customizations are possible. To alleviate these burdens, customizations can be printed on an order sticker or a receipt for a barista. However, this can be inefficient for operation. Order stickers or receipts are limited in size and shape. Order stickers or receipts can also be limited in what or how they communicate. For example, stickers or receipts can include inputs or ingredients, but may not be able to convey methods or order of operations.

The process can be labor intensive and space intensive, particularly if the locations for the tasks or ingredients are spaced apart. Creating a beverage can include collecting and retrieving a variety of ingredients in various locations by hand. Additionally, creating a beverage may include moving a container to various stations to use different equipment. Various steps can take time and space, such as pulling an espresso shot or blending various ingredients.

Not only can these inefficiencies be time consuming, such inefficiencies can also cost more, especially in terms of labor costs. Additionally, baristas can often use excess amounts of ingredients to ensure the cup is full at the end of preparation, which can often lead to waste. As more ingredients and methods are offered, various ingredients or equipment can be positioned far away from each other, which can cause baristas to travel long distances between steps and increase production time.

To address these or other concerns, disclosed herein is a system (e.g., a computing system, a beverage preparation system) for building collections of build instructions that are grouped as a file (e.g., a sequence file) for customized beverages and controlling a station (e.g., a beverage preparation station). In some cases, the system may include the station (e.g., the beverage preparation station may be part of the beverage preparation system). In some cases, the system may be separate from the station (e.g., the station and the system may be implemented using different processors, controllers, etc.). In some cases, the system may be the computing system that causes implementation of one or more operations at the station (e.g., a physical station within an environment that includes equipment, machines, inventory, etc.). While reference will be made herein to a beverage preparation system and/or a beverage preparation station, it will be understood that the system may be any system and may be in communication with and/or may control any station.

The file generated by the beverage preparation system can include computer-executable instructions for building customized beverages. The computer-executable instructions can be performed by a plurality of substations to build the customized beverages. In some cases, the file can include multiple subsets or portions of build instructions and the system can assign one or more subsets or portions of the build instructions to a particular subsystem for execution. For example, the system can assign a first portion of the build instructions to a first subsystem for execution and a second portion of the build instructions to a second subsystem for execution.

The beverage preparation system to prepare one or more beverages. For example, the beverage preparation system may include data processing hardware (e.g., one or more hardware processors) and memory (e.g., computer-readable storage medium storing instructions such as computer-readable instructions, machine-readable instructions, computer code, machine-executable instructions, computer-executable instructions, commands, etc.). The data processing hardware may execute the instructions which may cause the data processing hardware to perform one or more processes (e.g., operations) as discussed herein to prepare one or more beverages.

The beverage preparation system can identify, from a queue, one or more drink orders (e.g., corresponding to one or more beverages). Based on the one or more drink orders, customer data associated with the one or more drink orders, store data, user data, ingredient data, machine data, or any other data associated with the one or more drink orders, the beverage preparation system can dynamically generate computer-executable build instructions for building all or a portion of the one or more beverages. Further, the beverage preparation system can identify one or more substations. For example, the beverage preparation system can identify one or more substations in a particular store. All or a portion of the one or more substations may correspond to a respective portion of the computer-executable build instructions. For example, the beverage preparation system can dynamically assign a respective portion of a plurality of portions of the computer-executable build instructions to all or a portion of the one or more substations for execution.

Based on dynamically assigning a portion of the computer-executable build instructions to all or a portion of the one or more substations, the beverage preparation system can transmit a respective portion of the computer-executable build instructions to all or a portion of the one or more substations. All or a portion of the one or more substations can execute a respective portion of the computer-executable build instructions. All or a portion of the one or more substations can include one or more substation displays to instruct a user regarding a build step to be performed at the substation (e.g., dispense an ingredient). Execution of a respective portion of the computer-executable build instructions can cause all or a portion of the one or more substations to perform a build step (e.g., dispense an ingredient) to build the one or more beverages. Therefore, the beverage preparation system can build the one or more beverages.

In some cases, to dynamically generate the computer-executable build instructions for building all or a portion of the one or more beverages, the beverage preparation system can access a model (e.g., a machine learning model) for dynamically generating build steps for building the one or more beverages. The model may parse data associated with the one or more drink orders. For example, the data may include customer data associated with a customer, step sequence data, step technique data, ingredient data, or other step data. Based on parsing the data, the model can generate the build steps.

In some cases, the beverage preparation system may monitor building of the one or more beverages by the one or more substations. The beverage preparation system can determine a time period for building the one or more beverages based on monitoring the building of the one or more beverages. Further, the beverage preparation system can dynamically update a time period for one or more associated beverages based at least in part on the time period for the one or more beverages.

The beverage preparation station (e.g., a physical station within an environment) can include a dashboard to show baristas or users what next steps can be taken to build one or more beverages and allow a user to select which one or more drinks to work on. The dashboard can indicate what build steps and/or sets of build steps have been are active (e.g., to be performed), inactive (e.g., future step not being performed), completed, etc. In some variants, substation displays can indicate the status of a build step at the substation (e.g., ready to perform build step, performing build step, build step completed).

The beverage preparation system can advantageously assist in training baristas or users more quickly while requiring less memorization. This can reduce time for training, reduce stress during training, and reduce training overall, all while maintaining product quality and without delaying time for beverage production. The beverage preparation system can advantageously allow a user to coordinate various steps of building one or more beverages simultaneously.

The beverage preparation system can provide one or more sequences (e.g., orderings, arrangements, hierarchies, etc.) of one or more beverages and/or food items (e.g., via the dashboard). For example, all or a portion of the one or more sequences can identify a sequence for preparing the one or more beverages and/or food items. The beverage preparation system can enable a user to select (e.g., choose) a sequence of the one or more sequences and may build collections of build instructions based on the selection (e.g., received via the dashboard). In some cases, the beverage preparation system can enable a user to select a sequence from the queue. In other cases, the beverage preparation system can enable a user to select a sequence and the beverage preparation system may define the queue according to the sequence. By enabling a user to select a particular sequence, the beverage preparation system can enable a user to select a sequence of preparing the one or more beverages and/or food items. Further, the beverage preparation system can enable a user to select a particular beverage and/or food items to be prepared at a particular point in the sequence (e.g., first, last, second, third, after or before a particular related beverage and/or food item, etc.). In some cases, the system can enable a user to customize a sequence of the one or more beverages and/or food items (e.g., by defining the sequence based on received user input) and/or can generate a customized sequence based on user input.

In one example, the beverage preparation system can identify orders (e.g., from a queue). For example, the orders may include a first drink order associated with a first customer, a second drink order associated with the first customer, and a third drink order associated with a second customer. The beverage preparation system may receive a selection of a particular order (e.g., the first drink order) to be completed (e.g., fulfilled) first (e.g., prior to other orders of the orders).

Based on the section, the beverage preparation system can dynamically generate a sequence of the one or more orders. Further, the beverage preparation system may arrange the first drink order and the second drink order within the sequence such that the first drink order and the second drink order are completed within a same time period. The beverage preparation system can build (e.g., define, generate, etc.) the one or more sequences (e.g., using a dynamic sequence schema). For example, the dynamic sequence schema may indicate how to sequence a given set of orders. In another example, the dynamic sequence schema may indicate a hierarchy of sequence build factors (e.g., store data (e.g., how busy the store is), customer data (e.g., a customer wait time), operator data (e.g., an operator's experience, an operator's preference for particular objects), etc.) such that the beverage preparation system can build the one or more sequences using a sequence build factor that is ranked higher than other sequence build factors (e.g., is ranked above the other sequence build factors) in the hierarchy.

In some cases, to generate the sequence, the beverage preparation system can access and/or utilize a machine learning model (e.g., a supervised, unsupervised, reinforcement, etc. machine learning model) to dynamically generate the one or more sequences. For example, the beverage preparation system may include and/or utilize artificial intelligence to build the one or more sequences. The machine learning model may generate the sequence based on at least one of operator data, customer data, or store data. The beverage preparation system may provide data associated with one or more orders, customer data associated with the one or more orders, store data, user data, ingredient data, machine data, or any other data associated with the one or more orders to the machine learning model as an input. Based on the provided input, the machine learning model may output one or more sequences. Further, the beverage preparation system (or a separate component) may train the machine learning model using a training data set that includes one or more sequences selected by one or more users and may output the one or more sequences based on the training of the machine learning model.

In one example, the beverage preparation system can build the one or more sequences based on store data identifying how busy the store is at a particular time (e.g., a number of customers in the store, a number of orders in a queue, a number of orders fulfilled within a particular time period (e.g., ten minutes, one hour, etc.), an order rate, etc.). For example, based on store data indicating that the store is busy as compared to the store during other time periods and/or as compared to different stores during the same or different time period, the beverage preparation system can build the one or more sequences for selection.

In some cases, the beverage preparation system can build the one or more sequences based on customer data associated with the one or more beverages and/or food items such that beverages and/or food items associated with the same customer may be ready within a same time period. For example, a customer may order multiple beverages (e.g., a latte, an americano, a cappuccino, etc.) and/or multiple food items (e.g., a bagel with cream cheese, a bagel sandwich, a slice of pumpkin bread, etc.) and the beverage preparation system can generate all or a portion of the one or more sequences such that the multiple beverages and/or multiple food items are ready for pickup and/or handoff to the customer at the same time period regardless of the sequence selected by the user. In some cases, a sequence may include beverages and/or food items associated with the same customer being prepared at different time periods (e.g., initiating preparation of the items at different times) based on the build times for the various items such that the items are ready for pickup and/or handoff to the customer at the same time period.

In some cases, the beverage preparation system can provide the one or more sequences to the user for selection based on provided data associated with one or more orders, customer data associated with the one or more orders, store data, user data, ingredient data, machine data, or any other data associated with the one or more orders. For example, the beverage preparation system can provide the one or more sequences to the user for selection based on how busy the store is at a particular time. Further, the beverage preparation system may provide less sequences for the user to select from if the beverage preparation system determines that the store is comparatively busy as compared to more sequences for the user to select from if the beverage preparation system determines that the store is comparatively not busy. In some cases, the beverage preparation system may determine that the business of the store (e.g., a number of customers in the store, a number of orders in a queue, a number of orders fulfilled within a particular time period (e.g., ten minutes, one hour, etc.), an order rate, etc.) satisfies (e.g., matches, exceeds, etc.) a particular threshold level and based on that determination may preselect a sequence of orders for the user.

By dynamically building the sequences of orders, the beverage preparation system can dynamically allocate orders (e.g., individual orders, orders associated with a same customer, orders associated with a same group, orders received at a same time, orders for a same drink, etc.) to particular substations, queues, etc. In this manner, the beverage preparation system can increase the computational efficiency of an object build process as compared to a system that uses a first-in-first-out manner of allocating orders to substations.

In response to a selected sequence of orders and/or a selected order, the beverage preparation system can output the selected sequence of orders and/or the selected order (e.g., via a display). Further, based on a selected sequence (e.g., provided via an input to the beverage preparation system), the beverage preparation system can build a file for the recipes for the selected orders and send corresponding build steps to the appropriate substations. The controller can route at least a portion of the file (e.g., a portion of computer-executable instructions) to all or a portion of the substations such that the orders are fulfilled, prepared, etc. and/or the beverages and/or food items and provided to the customer at a particular time.

The beverage preparation station can include one or more substations (e.g., one or more physical substations) to dispense various ingredients or execute various actions to build one or more beverages. The beverage preparation system (e.g., via the beverage preparation station) can control substations to automatedly dispense ingredients in precise measurements in accordance with the customized beverage order. For example, the beverage preparation system may route instructions directly to the substations or to the substations via the beverage preparation station. The beverage preparation system can not only improve efficiency but also advantageously improve beverage uniformity amongst beverage orders. Furthermore, by automating the dispensing of precise amounts of ingredients, the beverage preparation system advantageously improves beverage quality and consistency. The beverage preparation system (e.g., via the beverage preparation station) can sense manual actions taken at various substations. The beverage preparation system (e.g., via the beverage preparation station) can also track and display steps as they are completed, which can allow the beverage preparation system to predict a time the one or more beverages are to be completed. The beverage preparation system and/or the beverage preparation station can also advantageously eliminate or reduce the need for users to memorize drink orders and customizations. This can also reduce confusion and error in coordinating steps in preparing a drink or in preparing multiple drinks. The beverage preparation system and/or the beverage preparation station allows users to create drink orders with reduced effort and stress, allowing users to multitask in conducting multiple steps and improving speed and efficiency.

In light of the description herein, it will be understood that the embodiments disclosed herein substantially improve beverage quality and efficiency in preparing beverages by partially automating the dispensing of ingredients and/or performing actions for any of thousands or millions of possible ingredient modifications/combinations. Specifically, the embodiments disclosed herein enable a system to receive customized orders, build recipes (including, for example, ingredients, precise amounts of ingredients, and sequence instructions), display build steps to create beverages in accordance with a recipe, facilitate precise and automated dispensing of precise amounts of ingredients in accordance with a recipe, automate performing actions in accordance with a recipe, or sense when manual steps have been taken in accordance with a recipe (including, for example, when a dispensed ingredient has been removed from a substation and when a container has been returned). The ability to build recipes (for example, in real time or near real time) improves beverage quality and consistency by precisely dispensing amounts of the beverage ingredients in accordance with a recipe; reduces beverage-creation time, as less time is spent by baristas measuring and/or manually dispensing ingredients; and reduces complexity, memorization effort, and training burden, by reducing recipe memorizations and mentally-performed recipe modifications. The tracking of the amounts of ingredients can also allow the beverage preparation system to calculate nutrition data, including amounts of sugar and/or calories.

The beverage production system can advantageously dispense ingredients from bulk storage, thereby requiring fewer plastic containers or pump assemblies, which advantageously reduces waste in the form of smaller packaging for ingredients, and reduces cleaning time for pumps and assemblies. Furthermore, by automating dispensing and improving precision, the beverage preparation system can improve the ability to determine and track detailed actuals for ingredient consumption, which advantageously reduces manual inventory counting and estimation, thereby improving accuracy in tracking inventory and planning for inventory restocking. The beverage preparation system can also automatically initiate replenishment of ingredients based on the automatic tracking for the inventory. Additionally, the beverage production station can reduce the space occupied by the various ingredients and equipment by streamlining and optimizing inefficiencies to create a smaller footprint, which advantageously allows users to operate more efficiently by requiring less travel between substations.

Lastly, the beverage production system can allow users to not only operate efficiently but also more accurately. Users can complete multiple steps of a drink order simultaneously or build multiple drinks simultaneously as less time is spent by users in memorizing orders, coordinating and keeping track of steps mentally, and manually measuring ingredients. With assistance from the beverage production system, while waiting for a build step to be executed, the user can jump to other steps. For example, if a longer build step is being executed (e.g., an espresso is being pulled, milk is steaming, or ingredients are blending), the beverage production system can show other build steps (e.g., adding an ingredient) available to work on while waiting for the build step to be completed during the wait time. The beverage production system can also determine if all or a portion of the build steps are based on a predecessor build step prior to displaying or allowing execution of the build step, thus preventing errors by the user. All or a portion of the build steps can be tracked and recorded to allow the beverage preparation system to keep track of the build steps to build the one or more drink orders correctly and efficiently. Additionally, the beverage production system can reduce the physical strain on the user in reducing bending, walking, or even reaching.

Although various steps can be automated to assist a user, the beverage production system still permits the art of human crafting to create a beverage. This can allow human touches that automated machines cannot perform to be incorporated into drinks, such as latte art, whip cream topping, or sprinkle or drizzle toppings. Additionally, the beverage production system can allow for human input in deciding which beverages to create and which steps to take, which can allow beverages to be made quickly and also accommodate the complexity of the customizations.

Many of the embodiments described herein involve a customizable beverage, such as an espresso-based beverage, a blended beverage, a hot beverage, a cold beverage, a coffee beverage, a tea beverage, etc. However, it should be appreciated that certain features and aspects of the embodiments disclosed herein may be applicable to various types of beverages. Further, it should be appreciated that certain features and aspects of the embodiments disclosed herein may be applicable to various types of foods, such as sandwiches, bagels, wraps, etc.

It will be understood that this process may be repeated tens, hundreds, or more times per hour as the beverage production system receives orders. As such, the process described herein can improve efficiency, beverage uniformity amongst beverage orders, beverage quality, and beverage consistency. Moreover, given the nature of beverage preparation systems and the small time window available to receive orders, determine a manner of building the order, and cause the order to be built, it is not feasible or possible for a human to perform the functions described herein at the same speed and/or with the same efficiency and this process could not be performed in the human mind with or without a physical aid.

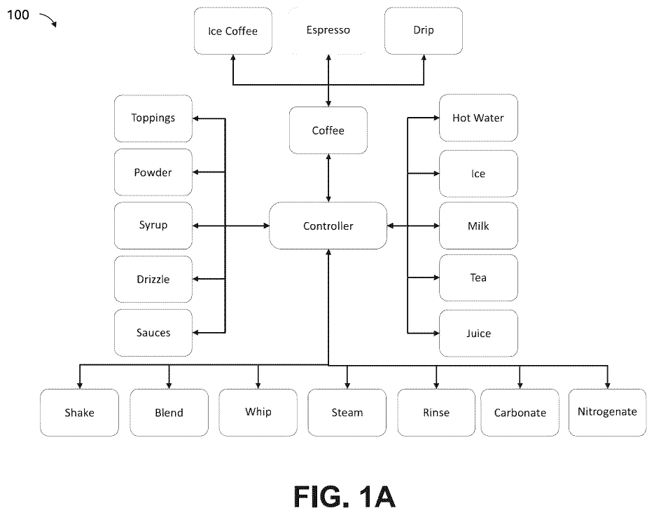

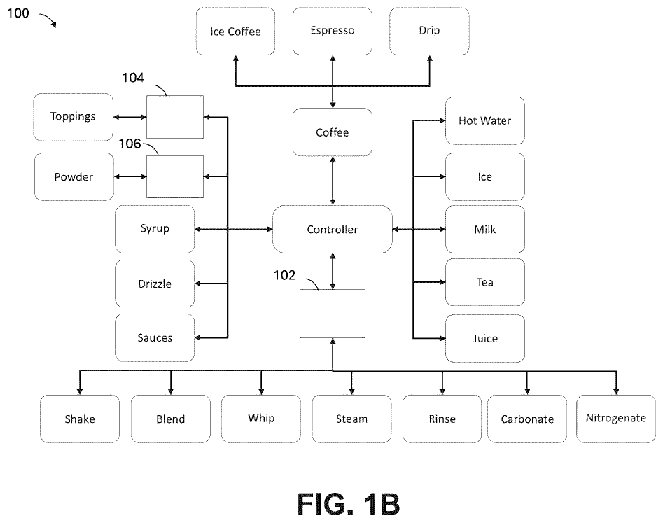

FIG. 1A schematically illustrates an embodiment of a beverage preparation system 100 (e.g., that may include and/or may be a beverage preparation station). The beverage preparation system 100 can include a variety of substations that create and/or dispense ingredients. The beverage preparation system 100 can include a variety of substations that facilitate or actuate performance of an action to ingredients.

The one or more substations can be controlled from, or by, one or more controllers. For example, the individual substations may be controlled from, or by, a single centralized controller that supplies power and control signals (which may include data or other information, such as build steps in accordance with drink orders) to all or a portion of the one or more substations. In other configurations, all or a portion of the one or more substation may be controlled by its own dedicated local controller or subgroups of dispensers may be controlled by a controller.

The one or more substations that dispense ingredients can automatically dispense the correct amount of ingredients in accordance with the recipes and based on the received build step at the corresponding substation. All or a portion of the one or more substations can act as individualized modules that receive parameterized information or instructions, prepare the ingredient accordingly, dispense the ingredient in the precise amount, and send a signal to the controller that the step has been completed. All or a portion of the one or more substations can be changed or adapted to dispense any ingredient by changing certain dispensing parameters.

The one or more substations can perform an action in accordance with the recipes and based on the received build step at the corresponding substation. All or a portion of the one or more substations can act as individualized modules that receive parameterized information or instructions, activate a piece of equipment accordingly, perform the action, and send a signal to the controller that the step has been completed.

The beverage preparation system 100 can include one or more coffee machines to produce and/or dispense various types of coffee, such as espresso, iced coffee, drip coffee, cold brew coffee, cold brew espresso, cold brew, and/or nitro coffee. These one or more machines can include: an espresso machine, a coffee brewer, a cold brewer, an iced coffee dispenser, or a nitro tap. For example, as shown in FIG. 1A, the beverage preparation system 100 can include one or more apparatuses to produce and/or dispense iced coffee, espresso, and drip coffee.

The beverage preparation system 100 can include one or more substations that produce and/or dispense various ingredients, such as hot water, ice, milk, tea, and/or juice. In some examples, one or more substations can produce or dispense bases for beverages, such as Frappuccino bases. For example, the beverage preparation system 100 can include a substation that includes a hot water heater that heats water and dispenses hot water. For example, the beverage preparation system 100 can include a substation that includes an ice machine that forms and dispenses ice. For example, the beverage preparation system 100 can include containers that are configured to hold and dispense various ingredients, such as various types of milk, juice, or tea. In some embodiments, these containers can be refrigerated or insulated. In some embodiments, these containers can be heated or insulated. For example, the beverage preparation system 100 can include a substation that includes a tea brewer that produces tea and dispenses tea. As previously described, the one or more substations can be connected to bulk storage.

The beverage preparation system 100 can include one or more substations that dispense various ingredients, such as inclusions or modifiers. For example, the beverage preparation system 100 can include one or more substations that dispense toppings, powders, syrup, drizzle, sauces, or other flavorings. For example, these can include sprinkles, spices, candy, shavings, and/or whip cream.

The beverage preparation system 100 can also include one or more substations that store or dispense cups or lids. The beverage preparation system 100 can also include one or more substations (e.g., label printer, labeler, label maker) that print drink orders or recipes, such as stickers or receipts.

The beverage preparation system 100 can include one or more substations that provide equipment to perform an action. For example, the beverage preparation system 100 can include one or more substations that allow for heating, blending, whipping, shaking, foaming, steaming, carbonating, and/or nitrogenating ingredients. For example, the beverage preparation system 100 can include a heater, a shaker, a blender, a whip cream dispenser, a steam wand, a steamer, or a frother. For example, the beverage preparation system 100 can include a substation that allows for rinsing and/or drying, such as a rinser or dryer. For example, the beverage preparation system 100 can include a substation that allows for carbonating or nitrogenating, such as a machine to add carbonation, nitrogen, and/or other gases to a beverage.

Each individual task or ingredient can be facilitated by separate substations. Tasks or ingredients can also be grouped into various substations. For example, similar ingredients can be grouped into a single substation. For example, similar toppings, powders, syrup, drizzle, sauces, or other flavorings can be grouped into a single substation. In some embodiments, various milks can be grouped into a single substation. In some examples, ingredients and actions commonly used together can also be grouped into a single substation. For example, ingredients and equipment commonly used to make a blended beverage can be grouped into a single substation.

The beverage preparation system 100 can include one or more main dashboards 102 (e.g., one or more main displays). The one or more main dashboards 102 can also display the recipes and any customizations for all or a portion of the beverage orders, including any or all steps to build the beverage order such as ingredient portions and parameters. The build steps can be grouped into sets that correspond to distinct actions. For example, build steps that include dispensing ingredients to be blended together can be grouped together, whereas build steps to be performed after blending can be performed together. The one or more main dashboards 102 can allow a user to modify the drink orders or the queue for the drink orders. The one or more main dashboards 102 can display a queue of beverage orders received and ready to be initiated, which can include displaying the queue in a priority order. The one or more main dashboards 102 can also display the progress or status of the various beverage orders and/or the build steps and/or sets of build steps for all or a portion of the beverage orders. The one or more main dashboards 102 can act as a user interface, which can include allowing a user to select one or more beverage orders to start working on it by selecting it on the queue. In some examples, the one or more main dashboards 102 can be touchscreen or can have one or more buttons. The user can select several beverage orders to work on in parallel as well as in series. In some examples, the user can work on up to four beverage orders to work on simultaneously or in parallel. This advantageously allows a user to work on multiple beverage orders simultaneously or in parallel and efficiently, without limiting the beverage orders to being built serially. Moreover, this advantageously allows a user to work on multiple steps simultaneously or in parallel and efficiently move between various steps for a single beverage order or multiple beverage orders. For example, a user can select two espresso-based drinks or blended drinks, which can include lengthy build steps that take time, such as preparing the espresso shots, steaming milk, or blending ingredients. The user can simultaneously select two cold drinks or drip coffee drinks, which can include shorter steps or less steps than other beverage orders. For example, a user can work on shorter steps (e.g., adding ice) while waiting for a length build step (e.g., pulling an espresso) of a single beverage order. The one or more main dashboards 102 can also display the recipes and any customizations for all or a portion of the beverage orders, including any or all steps to build the beverage order such as ingredient portions and parameters. The one or more main dashboards 102 can allow a user to modify the drink orders or the queue for the drink orders.

The beverage preparation system can enable multiple user to attend to beverage orders in series and/or in parallel. For example, to operate in parallel, the beverage preparation system can include two dashboards that can display distinct beverage orders from a master queue (e.g., a main queue, a principal queue, a lead queue, etc.). A first dashboard can be associated with a first user. A second dashboard can be associated with a second user. Based on capacity and/or priority, beverage orders can be allocated to either the first dashboard for the first user or the second dashboard for the second user. A first beverage order allocated to the first dashboard can be initiated, which can include the controller communicating build steps corresponding to the first beverage order to substations. A second beverage order allocated to the second dashboard can be simultaneously initiated with the first beverage order, which can include the controller communicating build steps corresponding to the second beverage order to substations. The first beverage order displayed on the first dashboard and instructions for build steps displayed at substations that correspond to the first beverage order can include a mutual (e.g., same) visual identifier (e.g., symbol, name, color, border, pattern, graphic, etc.) to enable the first user to quickly identify build steps at substations that correspond to the initiated first beverage order. The second beverage order displayed on the second dashboard and instructions for build steps displayed at substations that correspond to the second beverage order can include a mutual (e.g., same) visual identifier (e.g., symbol, name, color, border, pattern, graphic, etc.) that is different from the visual identifier for the first beverage order to enable the second user to quickly identify build steps at substations that correspond to the initiated second beverage order. To operate in series, the controller can group build steps to be performed by a first user and those to be performed by a second user, which can include grouping build steps into sets based on actions. For example, the controller can group build steps to be performed prior to shaking ingredients together (e.g., dispense steps) for a first user and finishing steps (e.g., including shaking, pouring into a cup, and placing a lid on the cup) for a second user.

The beverage preparation system 100 can include a controller to connect the one or more main dashboards 102 and the one or more substations, which can include substation displays. The controller can receive drink orders and any input on the one or more main dashboards 102. Based on the received drink orders, the controller can build (e.g., generate) a data object that includes instructions (e.g., computer code, machine-executable instructions, computer-executable instructions, commands, etc.) for building the drink orders. In some cases, the controller can write the computer-executable instructions to a data object. For example, the data object may be a file, a data store, a container, etc. The data object will be referred to herein as a file, however, it will be understood that the controller can build any data object.

The controller can build a file (e.g., a build file, a computer file, etc.) for the recipe for the selected drink orders and send corresponding build steps to the appropriate substations. The controller can route at least a portion of the file (e.g., a portion of computer-executable instructions) to all or a portion of the subsystems. The portion of the file may cause all or a portion of the subsystems to execute a corresponding build step. For example, the controller can cause the substations to dispense ingredients, display dispense instructions, and/or perform an action in accordance with the drink orders. The controller can also receive information or data from all or a portion of the substations, such as a status of the substation or data from the one or more sensors at all or a portion of the substations.

In some cases, the controller can dynamically build or generate the file for the recipe for the selected drink orders. To dynamically build or generate the file, the controller may provide the data associated with the drink orders to a machine learning model (e.g., to a computing system implementing the machine learning model). In some cases, the beverage preparation system 100 may implement the machine learning model and may provide the data associated with the drink orders directly to the machine learning model. The controller may provide the data associated with the drink orders (e.g., and a prompt generated by the controller) to the machine learning model, the machine learning model may generate the file (e.g., the build steps), and the controller may obtain the file as an output of the machine learning model.

The beverage preparation system 100 or a separate component may train the machine learning model to output a file based on the data associated with the drink orders. For example, the beverage preparation system 100 may provide the machine learning model a set of training data that includes data associated with training drink orders and an expected output (e.g., an expected set of build steps to be implemented via computer-executable instructions to build the training drink orders). By training the machine learning model in this manner, the beverage preparation system 100 can effectively learn build steps for building drink orders using knowledge from prior drink orders which may enable the beverage preparation system 100 (or other components) to use less storage and/or processing capacity, reduce system complexity, etc. In some embodiments, the expected output may include expected computer-executable instructions to build the drink orders. Therefore, the beverage preparation system 100 can train the machine learning model to output a file (e.g., build steps or computer-executable instructions) based on data associated with the drink orders.

In some embodiments, the controller may provide data associated with one or more users of the one or more subsystems, one or more stores (e.g., identifying and/or indicating systems of a store, capabilities of a store, etc.), one or more subsystems (e.g., subsystems within a store), etc. to the machine learning model (e.g., with the data associated with the drink orders and/or the prompt). For example, the controller may provide, to the machine learning model, data indicating that a user is an experienced user (e.g., five years of experience), an inexperienced user (e.g., between one and five years of experience), a new user (e.g., less than a year of experience), etc. In this manner, the beverage preparation system 100 can train the machine learning model to output files that are customized (e.g., customized build steps, a customized order of build steps, etc.) for a particular user (e.g., different build steps may be provided for an experienced user v. an inexperienced user), a particular store, a particular set of subsystems, etc.

In some cases, the controller (e.g., the machine learning model as implemented by the controller) can dynamically build the file by parsing data associated with the drink orders. Further, the controller can parse data associated with the drink orders, one or more users for building the drink orders, one or more machines for building the drink orders, one or more customers associated with the drink orders, a sequence of steps for building the drink orders, a technique for building the drink orders, one or more ingredients for building the drink orders, or one or more build steps. For example, the data associated with the drink orders may include customer data identifying a customer, step sequence data identifying a sequence of steps, step technique data identifying a technique, ingredient data identifying one or more ingredients, and step data identifying one or more build steps.

Based on building the file, the beverage preparation system 100 can initiate dispensing customized ingredients and/or sense actions taken to create customized beverage orders. The beverage preparation system 100 can advantageously allow users to build beverages, keep track of steps completed, and/or any updates in real time. This allows the beverage preparation system to calculate the build time for a particular drink. This data can also be recorded and/or used to better predict build times for drink orders. The data can be recorded to a specific user to better predict build times for specific users. The build times can also be estimated based on the number of user steps taken. The build times can also be estimated based on a comparison of estimated times to complete all or a portion of the build steps versus the actual time taken to complete all or a portion of the build steps. The beverage preparation system 100 can also advantageously automate some steps, such as dispensing ingredients, which can allow a user to produce beverages efficiently and accurately. The beverage preparation system 100 can advantageously allow a user to initiate steps and take actions manually, allowing the user to control the order of steps and the timing of steps. This combination of manual and automated steps can allow users to decide what steps and what drink orders to complete while building drinks efficiently.

The beverage preparation system 100 can send a portion of the file (e.g., a portion of the computer-executable instructions) to all or a portion of the subsystems. The portion of the file may include computer-executable instructions to cause a subsystem to perform a build step for building the beverage. Further, the portion of the file may include recipe steps, such as ingredient portions and parameters, for selected or active drinks to corresponding substations. The computer-executable instructions may include a command for the corresponding substation. The portion of the file may include computer-executable instructions that, when executed by a subsystem, can cause display of the command at a display at the corresponding substation, dispensing of an ingredient in accordance with the beverage order recipe, and/or waiting for a user to take an action which the corresponding substation can sense, which can cause dispensing of the ingredient associated with the substation.

The controller may build one or more files for a plurality of different beverage orders, a plurality of different beverage orders, and/or a plurality of different recipes. For example, the controller may build a first file for a first drink order that corresponds to a cortado and a second file for a second drink order that corresponds to an americano; the first file and the second file may include separate and/or different build steps. A file may include different build steps for different subsystems. In some cases, a first file and a second file may include a build step (different build steps) for the same subsystem. For example, a first file for a first drink order that corresponds to a cortado and a second drink order that corresponds to an americano may include a build step for a particular subsystem to prepare espresso. The subsystem can include a display that can display information for both orders simultaneously. In some variants, the subsystem can perform the build step for two orders simultaneously (e.g., prepare and/or dispense an ingredient such as espresso). In some variants, the subsystem can perform the build steps for orders at the same substation in sequence (e.g., prepare and/or dispense an ingredient such as espresso one after the other).

In some cases, all or a portion of the drink orders may be associated with a particular priority. For example, the priority of a drink order may be based on a customer associated with the drink order, a time of receipt of the drink order, a type of the drink order (e.g., an americano with multiple additions, a black coffee with no additions, etc.), an order type of the drink order (e.g., an online order, an in-person order, etc.), etc. In some embodiments, the controller may assign a priority to all or a portion of the drink orders. For example, the controller may assign a priority to all or a portion of the drink orders based on one or more other drink orders (e.g., one or more previous drink orders). The master queue of orders for the beverage preparation system and/or the queues of the one or more dashboards (e.g., a first main display queue and/or a second main display queue) can include prioritized orders.

Each substation can include a display or dashboard. The display or dashboard can display the build step(s) received at the corresponding substation. The display can also show an instruction for a user to take to execute a build step. The display can also show a status or progress of the build step at the corresponding substation, such as the substation is waiting to dispense an ingredient or is in the process of preparing an ingredient. The display or dashboard can act as a user interface, allowing a user to select one or more options or build steps. In some examples, the display or dashboard can be touchscreens or can have one or more buttons. In some examples, a user can select a particular build step they want to work on at the corresponding substation. In some examples, a user can update a status of a build step or the build station at the corresponding substation. In some examples, the display for all or a portion of the substations can display the drink or order name associated with the particular build step displayed on the particular substation. All or a portion of the displays of the substations that are building a particular beverage order can be made to look cohesive, such as by displaying the same or similar visual indicators. For example, the associated substations that are associated with build steps for a particular drink could all be the same color or show the same border design. The same or similar visual indicators can be used on the main dashboard(s) for that particular drink order. All or a portion of the various substations can include its own display or dashboard. For example, as shown in FIG. 1B, a substation for dispensing toppings can have its own substation display or dashboard 104 and a substation for dispensing powder can have its own substation display or dashboard 106.

The interfaces of the main display and/or the displays of one or more substations can be customized based on user preferences, abilities, or experience level. For example, the displays can hide or group steps for more experienced users. The displays can use abbreviations or shorthand based on user preference. Various visual styles can be used based on user preference, such as various contrast, color styles, formatting, and accessibility features.

The substations can include one or more sensors, which can sense when one or more actions are taken at the substation. For example, a substation can include one or more weight sensors, light sensors, pressure sensors, vibration sensors, contact sensors, proximity sensors, magnetic sensors, flow sensors, reed sensors, ultrasonic sensors, or various other types of sensors. The one or more sensors can allow the substation to sense a user's one or more actions. In some embodiments, a substation can sense when a container or vessel is automatically filled, when the filled container is removed, or when an empty container is returned to the substation. In some embodiments, a substation can sense when a container is positioned at the substation, when an action at the substation is taken, and when a container has been removed from the substation. In some embodiments, a substation can contain a trigger, such as a paddle, button, and/or tap switch, and the substation can sense when the trigger is initiated. In some embodiments, a substation can sense when a container is removed from the substation or when a container has been returned to the substation.

The beverage preparation system 100 can include displays at all or a portion of the substations. All or a portion of the substations can display a relevant build step or command to create a particular beverage. The substation can display instructions to a user to execute a manual step for a particular beverage order at the substation. The substation can display an ingredient and a measurement that has been dispensed at the substation. The substation can also display a status of the substation. In some variants, substation displays can display build step instructions for multiple (e.g., two or more) beverage orders simultaneously.

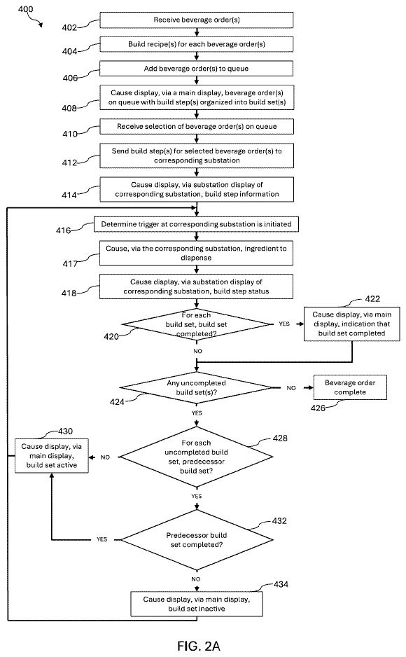

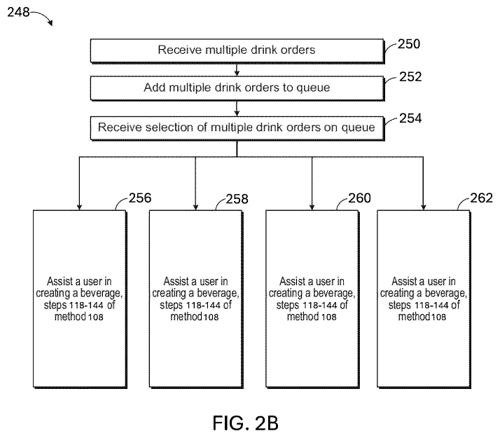

FIG. 2A is a flow diagram illustrative of an embodiment of a method 400 implemented by the beverage preparation system 100 to dynamically assist a user in creating one or more beverages. Although described as being implemented by a controller, it will be understood that the elements outlined for method 400 can be implemented by one or more computing devices or components that are associated with the beverage preparation system 100. Thus, the following illustrative embodiment should not be construed as limiting.

At block 402, the controller receives one or more drink or beverage orders. The one or more drink orders can be received from a plurality of locations, such as through one or more point of service systems in a restaurant or through mobile orders. Customers can customize the one or more drink orders. Further, the controller can receive the one or more drink orders directly or via a network from one or more computing systems. The controller can receive the one or more drink orders as one or more packets of data. In some cases, the controller can identify metadata associated with the one or more drink orders. For example, the controller can identify a store, a customer, equipment, an employee, inventory, etc. associated with the one or more drink orders. The controller may receive the metadata with the one or more drink orders or separately from the one or more drink orders.

At block 404, the controller builds recipes for all or a portion of the selected drink orders, including any input received from the user or customizations. In some examples, the main display or dashboard can also display the recipes and any customizations for all or a portion of the beverage orders, including any or all steps to build the beverage order such as ingredient portions and parameters.

To build the recipes (e.g., the recipes including a plurality of build steps), the controller can dynamically generate any number of build steps to include in all or a portion of the recipes. The controller may dynamically generate the build steps to include in the recipes by parameterizing the recipes (e.g., breaking the recipe down into a plurality of parameters that correspond to one or more build steps). The controller can identify one or more sets of build steps that can be utilized in a recipe to build a drink. In some cases, the controller can select a set of build steps from a plurality of different sets of build steps for building the recipe. The controller may compare two or more sets of build steps and identify a set of build steps that is more environmentally conscious than another set of build steps (e.g., a set of build steps with a carbon output that is less than a carbon output of another set of build steps), a set of build steps associated with a time period for completion that is less than a time period for completion another set of build steps, a set of build steps associated with an expertise level for building the drink that is less than an expertise level for building a drink corresponding to another set of build steps, a set of build steps that uses less, different, or less expensive ingredients than another set of build steps, a set of build steps that uses less, different, or less expensive equipment than another set of build steps, etc.

Based on the recipes, the controller can dynamically build or generate a file. For example, a file may correspond to a given recipe. Further, the controller can dynamically build or generate computer-executable instructions to be included in the file. The computer-executable instructions may cause the execution of the build steps of a particular recipe. The computer-executable instructions may include a plurality of subsets or portions of computer-executable instructions. All or a portion of the plurality of subsets or portions of the computer-executable instructions may cause the implementation of a particular build step, the implementation of a predecessor to a particular build step, etc. The controller may dynamically assign all or a portion of the plurality of subsets or portions of computer-executable instructions to a particular subsystem for execution. For example, the controller may dynamically assign a first portion of computer-executable instructions to a first subsystem that, when executed by the first subsystem, cause the first subsystem to dispense a particular amount of coffee and a second portion of computer-executable instructions to a second subsystem that, when executed by the second subsystem, cause the second system to dispense a particular amount of whipping cream.

In some cases, the controller may identify a pre-built file based on a particular recipe. For example, the controller may identify that the build steps of a recipe correspond to a previously built file. Based on identifying that the build steps of the recipe correspond to the previously built file, the controller may access the previously built file instead of building the file.

At block 406, the controller adds the one or more drink orders to a queue. For example, the queue may be a digital or virtual queue, which can be referred to as a master queue. To add the one or more drink orders to the queue, the controller can transmit data identifying the one or more drink orders to a computing device, which can cause display of the drink orders via a display of the computing device based on the data identifying the one or more drink orders. The queue can be displayed on a main display of the beverage preparation system 100. As discussed herein, the beverage preparation system 100 can include a main display or dashboard. The main display or dashboard can also display the progress or status of the various drink orders. The main display or dashboard can also display the various drink orders in the queue that have been received at block 110 and that are ready to be initiated. In some variants, drink orders can be allocated to two or more main displays or dashboards to enable multiple users (e.g., two or more) to prepare different drink orders simultaneously. All or a portion of the main displays or dashboards can include a queue that includes one or more (e.g., one, two, three, or more) orders pulled from the master queue such that the queue of one main display or dashboard does not include orders that are included in the queue of another main display or dashboard. Orders can be allocated from the master queue to the main displays or dashboards based on priority and/or capacity.

At block 408, the controller can cause display, via one or more main displays, beverage orders on the queue with build steps of the corresponding recipe organized into build sets. The displayed queue can be a portion of the queue, including a highest priority portion (e.g., a portion of the queue with a priority that exceeds the priority of another portion of the queue), referenced at block 406. The build steps can be organized into build sets based on one or more actions to be taken to build the corresponding beverage order. Actions for a beverage order may include shaking ingredients together, blending ingredients together, manual actions, and/or others. Accordingly, build steps relating to dispensing ingredients that are to be shaken together can be organized into a build set. Similarly, build steps relating to dispensing ingredients that are to be blended together can be organized into a build set. Similarly, build steps relating to manually adding ingredients can be organized into a build set.

At block 410, the controller can receive a selection of one or more drink orders on the queue. For example, the controller can receive information identifying a selection of the one or more drink orders on the queue. The main display or dashboard can act as a user interface, allowing a user to select one or more beverage orders to start working on by selecting it on the queue. The user can select several beverage orders to work on simultaneously. In some examples, the user can work on at least two beverage orders to work on simultaneously. In some examples, the user can work on up to four beverage orders to work on simultaneously. This advantageously allows a user to work on multiple beverage orders simultaneously and efficiently, without having to build beverages serially. In some examples, the main display can display the recipes and any customizations for the selected beverage orders, including any or all steps to build the beverage order such as ingredient portions and parameters. In some examples, the main display can receive input from a user to modify the drink orders or the queue for the drink orders. In some variants, the drink order of highest priority on the queue (e.g., a drink order with a priority that exceeds the priority of other drink orders of the queue) can be automatically selected.

At block 412, the controller can send the build step to the corresponding substation. To send the build step to the corresponding substation, the controller can send a portion of computer-executable instructions from the file and corresponding to the build step to the substation dynamically assigned to execute the build step. The execution of the computer-executable instructions by the substation can cause the performance of the build step. Therefore, the controller can cause the performance of the build step. For example, the controller can instruct and/or control the substation to perform the build step. As previously described, the various substations can dispense various types of ingredients and/or perform an action. In some examples, the corresponding substation can display the build step on a display at the substation.

At block 414, the controller can cause display, via the substation display of the corresponding display, the build step (e.g., build step information) received by the corresponding substation. The substation display can indicate an ingredient to be dispensed. The substation can indicate a status of the build step, such as ready to perform, performing, and/or completed. The substation display can indicate information associating the build step with the corresponding object, such as object name, customer name, and/or other information. The substation display can display a visual identifier, such as a color, graphic, pattern, etc., that visually associates the build step with the corresponding object. The main display can display a corresponding visual identifier, which can share the same color, graphic, patter, etc.

At block 416, the substation can determine that a trigger at substation is initiated. In some examples, the trigger can be a paddle, a tap, a switch, or a button. In some variants, the trigger can be a sensor that determines a container is at the substation so that detection of the container indicates that the trigger has been initiated. The initiation of the trigger may cause data indicating that the trigger has been initiated. In one example, if the build step is to add an ingredient to a container, the controller can route computer-executable instructions to cause the execution of the build step to the corresponding substation that dispenses the appropriate ingredient. The substation may include a trigger that is utilized in the process of executing the build step. The substation can then determine when a trigger at the substation is activated or triggered.

In some examples, the initiation of the trigger can cause an ingredient to be dispended at the substation. In some examples, the initiation of the trigger can cause the initiation of an action. For example, the initiation of the trigger can cause the substation to perform or activate heating, blending, whipping, shaking, foaming, or steaming ingredients. For example, the one or more substations can include a heater, a blender, a whip cream dispenser, a steam wand, a steamer, or a frother. For example, the one or more substations can include equipment that allows for rinsing and/or drying, such as a rinser or dryer. For example, the build step may be to add a tea or juice to a beverage. The build step can be sent to the substation that contains the tea or juice dispenser and the substation can determine a trigger has been activated, such as a tap being flipped. In another example, the build step may be to add water, syrup, cold coffee, or other ingredients to the beverage. In some examples, the build step may be to take an action, such as blending one or more ingredients. The build step can be sent to a substation that contains the blending mechanism and the substation can determine a trigger has been activated, such as a button has been pushed.

At block 417 based on determining that the trigger at the substation is initiated (e.g., paddle pushed), the controller can cause the substation to dispense the ingredient or take an action. In some embodiments, the substation can dispense the ingredient in the desired amount in accordance with the beverage order recipe. In some embodiments, the substation can dispense the ingredient for as long as the user activates the trigger, such as flipping the switch. For example, the substation can dispense the ingredient while the trigger is activated. Therefore, the user can control the amount of ingredient dispensed based on activation of the trigger. In some embodiments, the substation can take an action in accordance with the build step. In some embodiments, the substation can perform an action for a period of time in accordance with the beverage order recipe. In some embodiments, the substation can perform an action for as long as the user activates the trigger, such as flipping the switch. The user can then control the action based on activation of the trigger. For example, the substation can initiate blending of one or more ingredients. In some embodiments, the substation can blend the one or more ingredients for a predetermined amount of time in accordance with the beverage order. In other embodiments, the substation can blend the one or more ingredients for as long as the user activates the trigger, such as pushing a button.

At block 418, the controller can cause display, via the substation display of the corresponding display, the build step status. For example, the substation display can indicate that the build step is ready to be performed, is being performed, and/or is complete. For dispensing an ingredient, the statuses can include ready to pour, pouring, and/or done.

At decision block 420, the controller can determine for all or a portion of the build sets if the build set is complete. As discussed, build sets can include one or more build steps that are grouped together based on an action to be performed. Accordingly, the controller can receive indications, such as data signals from the one or more substations, when build steps are performed. When all of the build steps for a build set have been completed, the method can progress to block 422 and cause display, via the one or more main displays, an indication that the corresponding build set has been completed, which can include adding a check mark over the build set, graying out the build set, etc. The method can progress to decision block 424 after block 422 or if a build set has not been completed.

At block 424, the controller can determine if an order has any uncompleted build sets. If an order does not include uncompleted build sets, the method can progress to block 426 and the beverage order is complete. When a beverage is complete, the controller can cause display, via one or more main displays, an indication that the beverage order is complete. In some variants, the controller can cause the beverage order to be removed from the queue and added to a historical log of completed beverages. If there are any uncompleted build sets, the method can progress to decision block 428 and determine, for all or a portion of the uncompleted build sets, if there is a predecessor build set. If there is no predecessor build set, the method can progress to block 430 and cause display, via the one or more main displays, an indication that the build is active, which can include highlighting the build set, can returning to block 416. If there is a predecessor build set, the method can progress to decision block 432 and the controller can determine if the predecessor build set has been completed. If the predecessor build set has been completed, the method can proceed to block 430 and proceed as described. If the predecessor set has not been completed, the method can proceed to block 434 and cause display, via the one or more main displays, an indication that the build set is inactive, which can including displaying the build set without highlighting. If a beverage order is not selected (e.g., not actively being built), the build sets of the beverage order can be displayed as inactive. The method can return from block 434 to block 416.

Blocks 420-434 have been described in the context of build sets. However, these same processes can be applied to the build steps themselves. For example, the build steps can be displayed by the one or more main displays, and as completed, the controller can cause the status of the build steps to be displayed.

FIG. 2B is a flow diagram illustrative of an embodiment of a method 248 implemented by the beverage preparation system 100 to dynamically assist a user in creating multiple beverages. Although described as being implemented by a controller, it will be understood that the elements outlined for method 248 can be implemented by one or more computing devices or components that are associated with the beverage preparation system 100. Thus, the following illustrative embodiment should not be construed as limiting.

At block 250, the controller receives multiple drink or beverage orders. The multiple drink orders can be received from a plurality of locations, such as through one or more point of service systems in a restaurant or through mobile orders. Customers can customize the one or more drink orders. Further, the controller can receive the multiple drink orders directly or via a network from one or more computing systems. The controller can receive the multiple drink orders as one or more packets of data. In some cases, the controller can identify metadata associated with the multiple drink orders. For example, the controller can identify a store, a customer, equipment, an employee, inventory, etc. associated with the one or more drink orders. The controller may receive the metadata with the multiple drink orders or separately from the multiple orders.

At block 252, the controller adds the multiple drink orders to a queue. For example, the queue may be a digital or virtual queue. To add the multiple drink orders to the queue, the controller can transmit data identifying the multiple drink orders to a computing device and cause display of the drink orders via a display of the computing device based on the data identifying the multiple drink orders. The queue can be displayed on a main display of the beverage preparation system 100. As discussed herein, the beverage preparation system 100 can include a main display or dashboard. The main display or dashboard can also display the progress or status of the multiple drink orders. The main display or dashboard can also display the multiple drink orders in the queue that have been received at block 250 and that are ready to be initiated. In some variants, the beverage preparation system can include two or more main dashboards, which can display the same master queue and/or separate queues with orders pulled from the master queue based on capacity and/or priority. All or a portion of the two or more main dashboards can be associated with a different user or team of users.

At block 254, the controller receives a selection of multiple drink orders on the queue, which can include the master queue and/or the separate queues associated with the main dashboards. For example, the controller can receive information identifying a selection of multiple drink orders on the queue. The main display(s) or dashboard(s) can act as a user interface, allowing one or more users to select multiple beverage orders to start working on simultaneously. The user(s) can select multiple beverage orders to work on simultaneously. In some examples, the user(s) can work on at least two beverage orders simultaneously. In some examples, the user(s) can work on up to four beverage orders to work on simultaneously. This advantageously allows one or more users to work on multiple beverage orders simultaneously and efficiently, without having to build beverages serially. In some examples, the main display(s) can display the recipes and any customizations for the selected multiple beverage orders, including any or all steps to build the beverage order such as ingredient portions and parameters. In some examples, the main display can receive input from a user to modify the drink orders or the queue for the multiple drink orders. The main display(s) or dashboard(s) can display the multiple drink orders in the queue that have been selected at block 254.

At blocks 256-262, the controller can assist one or more users in creating multiple beverage orders simultaneously, such as in parallel. The controller can move through blocks 406-434 of method 400 as previously described for two or more beverages simultaneously. The blocks 406-434 for the two or more beverages can be performed simultaneously. This advantageously allows one or more users to work on multiple beverage orders simultaneously and/or in parallel and efficiently, without limiting the beverage orders to being built serially. Moreover, this can advantageously allow one or more users to work on multiple steps simultaneously and/or in parallel and efficiently move between various steps for a single beverage order or multiple beverage orders. For example, the one or more users can select two espresso-based drinks or blended drinks, which can include lengthy build steps that take time, such as preparing the espresso shots, steaming milk, or blending ingredients. The one or more users can simultaneously select two cold drinks or drip coffee drinks, which can include shorter steps or less steps than other beverage orders. The one or more users can work on shorter steps (e.g., adding ice) while waiting for a lengthy build step (e.g., pulling an espresso) of multiple beverage orders. The controller may not move through blocks 406-434 for beverages at the same pace, such that multiple beverages may not be started or finished at the same time. Rather, the one or more users can decide which steps to jump between among the multiple beverage orders to create multiple beverage orders simultaneously. Additionally, the one or more users can select to start an additional beverage when already working on one or more beverage orders.

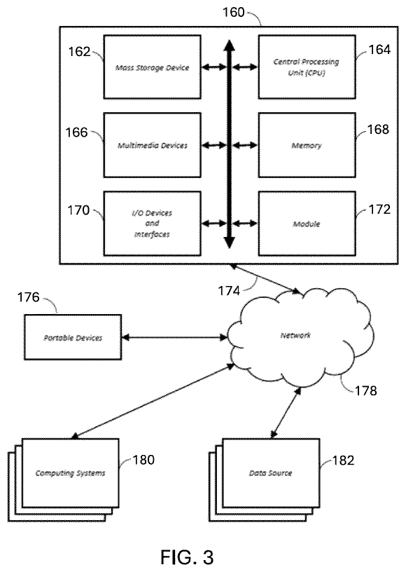

FIG. 3 is a block diagram depicting an embodiment of a computer hardware system configured to run software for implementing one or more embodiments disclosed herein.

In some embodiments, the systems, processes, and methods described herein are implemented using a computing system. The computing system 160 is in communication with one or more computing systems 180, portable devices 176, and/or one or more data sources 182 (e.g., databases, data stores, sensors, computing devices, etc.) via a network 178 (e.g., one or more networks). While FIG. 3 illustrates an embodiment of the computing system 160, it is recognized that the functionality provided for in the components and modules of the computing system 160 may be combined into fewer components and modules, or further separated into additional components and modules.

The computing system 160 can comprise a module 172 that carries out the functions, methods, acts, and/or processes described herein. The module 172 is executed on the computing system 160 by a central processing unit 164 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Further, in some embodiments, process blocks described herein may be altered, rearranged, combined, and/or omitted.

Depending on the embodiment, certain acts, events, or functions of any of the processes or algorithms described herein can be performed in a different sequence, can be added, merged, or left out altogether (for example, not all described operations or events are necessary for the practice of the algorithm). Moreover, in certain embodiments, operations or events can be performed concurrently.

The various illustrative logical blocks, substations, routines, and algorithm steps described in connection with the embodiments disclosed herein can be implemented as electronic hardware, computer software, or combinations of both. To clearly illustrate this interchangeability of hardware and software, various illustrative components, blocks, substations, and steps have been described above generally in terms of their functionality. Whether such functionality is implemented as hardware or software depends upon the particular application and design constraints imposed on the overall system. The described functionality can be implemented in varying ways for a particular application, but such implementation decisions should not be interpreted as causing a departure from the scope of the disclosure.

Moreover, the various illustrative logical blocks and substations described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The computing system 160 includes one or more processing units (e.g., the central processing unit 164), which may comprise a microprocessor. The computing system 160 further includes a physical memory 168, such as random-access memory (RAM) for temporary storage of information, a read only memory (ROM) for permanent storage of information, and a mass storage device 162, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computing system 160 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computing system 160 includes one or more input/output (I/O) devices and interfaces 170, such as a keyboard, mouse, touch pad, and printer. The I/O devices and interfaces 170 can include one or more display devices, such as a monitor, that allows the visual presentation of data to a user. More particularly, a display device provides for the presentation of GUIs as application software data, and multi-media presentations, for example. The I/O devices and interfaces 170 can also provide a communications interface to various external devices. The computing system 160 may comprise one or more multi-media devices 166, such as speakers, video cards, graphics accelerators, and microphones, for example.

The computing system 160 may run on a variety of computing devices, such as a server, a Windows server, a Structure Query Language server, a Unix Server, a personal computer, a laptop computer, and so forth. In other embodiments, the computing system 160 may run on a cluster computer system, a mainframe computer system and/or other computing system suitable for controlling and/or communicating with large databases, performing high volume transaction processing, and generating reports from large databases. The computing system 160 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computing system 160 illustrated in FIG. 3 is coupled to a network 178, such as a LAN, WAN, or the Internet via a communication link 174 (wired, wireless, or a combination thereof). Network 178 communicates with various computing devices and/or other electronic devices. Network 178 is communicating with one or more computing systems 180, portable devices 176 (e.g., tablet, personal computer, laptop, smartphone, smart watch, wearable, etc.) and the one or more data sources 182. The module 172 may access or may be accessed by the one or more computing systems 180 and/or the one or more data sources 182 through a web-enabled user access point. Connections may be a direct physical connection, a virtual connection, and other connection type. The web-enabled user access point may comprise a browser module that uses text, graphics, audio, video, and other media to present data and to allow interaction with data via the network 178.

Access to the module 172 of the computing system 160 by the one or more computing systems 180 and/or by the one or more data sources 182 may be through a web-enabled user access point of the one or more computing systems 180 or the one or more data sources 182 (e.g., through a personal computer, cellular phone, smartphone, laptop, tablet computer, e-reader device, audio player, or another device capable of connecting to the network 178). Such a device may have a browser module that is implemented as a module that uses text, graphics, audio, video, and other media to present data and to allow interaction with data via the network 178.

The output module may be implemented as a combination of an all-points addressable display such as a cathode ray tube (CRT), a liquid crystal display (LCD), a plasma display, or other types and/or combinations of displays. The output module may be implemented to communicate with the I/O devices and interfaces 170 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the beverage preparation system more directly such as through a system terminal connected to the score generator without communications over the Internet, a WAN, or LAN, or similar network.

In some embodiments, the computing system 160 may comprise a physical or logical connection established between a remote microprocessor and a mainframe host computer for the express purpose of uploading, downloading, or viewing interactive data and databases on-line in real time. The remote microprocessor may be operated by an entity operating the computing system 160, including the client server systems or the main server system, an/or may be operated by the one or more data sources 182 and/or the one or more computing systems 180. In some embodiments, terminal emulation software may be used on the microprocessor for participating in the micro-mainframe link.

In some embodiments, the one or more computing systems 180 who are internal to an entity operating the computing system 160 may access the module 172 internally as an application or process run by the central processing unit 164.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 160 may include one or more internal and/or external data sources (for example, the one or more data sources 182). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Caché), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or Amazon QLDB), a non-relational database, or a record-based database.

The computing system 160 may also access the one or more data sources 182. The one or more data sources 182 may be stored in a database or data repository. The computing system 160 may access the one or more data sources 182 through a network 178 or may directly access the database or data repository through the I/O devices and interfaces 170. The data repository storing the one or more data sources 182 may reside within the computing system 160.

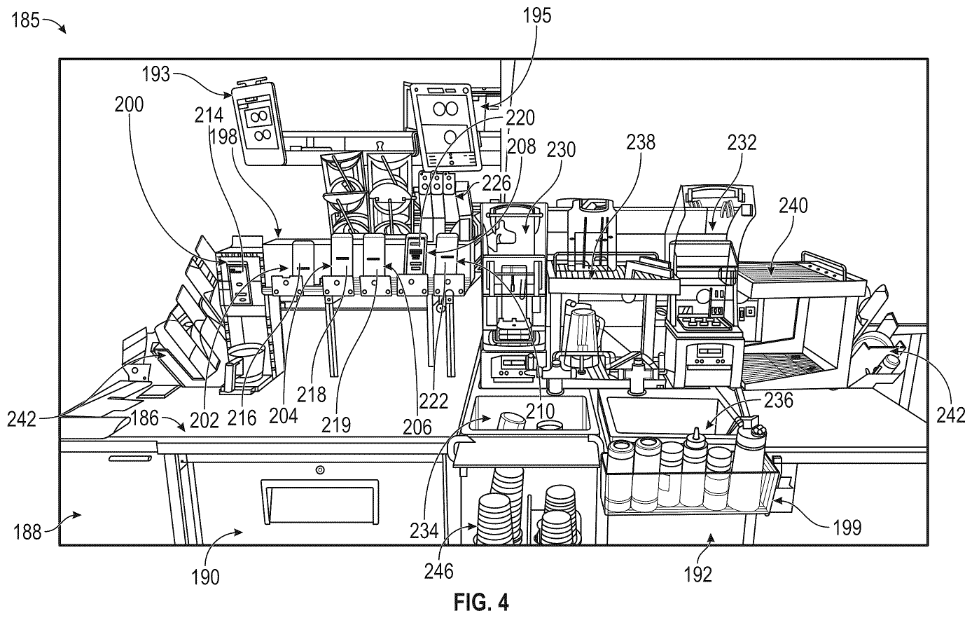

As noted above, the beverage preparation system and/or the beverage preparation station can be customizable and configured in a variety of ways. FIG. 4 illustrates an example beverage preparation station 185 (e.g., which may be part of the beverage preparation system 100). The beverage preparation station 185 can be configured for a single user preparing beverage orders or a team of users (e.g., two or more) that perform build steps for beverage orders in series (e.g., one user performs initial steps and another user performs finishing steps). The features of the beverage preparation station 185 can be distributed along a line. In some variants, the feature of the beverage preparation station 185 can be distributed along an L shape. The beverage preparation station 185 can include a preparation surface 186, which can be a table surface. The preparation surface 186 can be disposed at a height to be used by standing users. Various substations can be disposed on, adjacent to, and/or underneath the table 730, such as on a floor or shelf.

As shown in FIG. 4, the beverage preparation station 185 can include one or more features to hold equipment and/or ingredients. For example, the beverage preparation station 185 can include a storage unit 192, storage unit 190, and/or storage unit 188-any of which can be used to store and/or dispense ingredients and/or beverages. In some variants, one or more of the storage unit 192, storage unit 190, and/or storage unit 188 can be climate controlled, which can include controlling temperature, humidity, and/or other characteristics. In some variants, one or more of the storage unit 192, storage unit 190, and/or storage unit 188 can be a refrigerator and/or freezer.

The beverage preparation station 185, as shown in FIG. 4, can include various equipment and/or appliances. For example, the beverage preparation station 185 can include a blender 230, blender 232, sink 234, sink 236, drying rack 238, and/or drying rack 240. In some variants, the sink 234 and/or the sink 236 can include one or more faucets (e.g., rinsers), which can include one, two, three, or more faucets. The beverage preparation station 185 can include one or more lid racks 242. In some variants, the one or more lid racks 242 can be disposed at ends of the beverage preparation station 185, which can be ends of the preparation surface 186. The beverage preparation station 185 can include one or more cup racks 246. The beverage preparation station 185 can include one or more trays 199, which can be disposed on (e.g., coupled to) the preparation surface 186. The one or more trays 199 (e.g., rails) can hold ingredients (e.g., finishing ingredients such as cinnamon powder, whipped cream, etc.) to be administered manually by a user. The beverage preparation station 185 can include a label maker 226 that can print labels with beverage order information (e.g., customer name, beverage order name, customizations, etc.) that can be disposed on (e.g., adhered to) a cup).

The beverage preparation station 185 can include a first main display 193 (e.g., dashboard) and/or a second main display 195 (e.g., dashboard). In some variants, the beverage preparation station 185 may include one of the first main display 193 and second main display 195. In some variants, the first main display 193 and/or the second main display 195 can be touchscreens that can receive user input. In some variants, the first main display 193 and second main display 195 can display the same information simultaneously but with the first main display 193 oriented for viewing from the perspective at a first location where a first user can stand and the second main display 195 oriented for viewing from the perspective at a second location where a second user can stand. The first main display 193 and/or the second main display 195 can display uncompleted beverage orders from a master queue of uncompleted beverage orders. The first main display 193 and/or the second main display 195 can display additional information (e.g., build instructions) for one or more (e.g., one, two, three, or more) beverage orders, which can include one or more beverage orders of highest priority (e.g., one or more beverage orders with a priority that exceeds respective priorities of one or more other beverage orders of respective queues). In some cases, the priority may be based on the user. The controller may determine the priority at least based on the criteria described herein, which can be time an order was received (e.g., oldest orders prioritized ahead of newer orders). For example, the first main display 193 and/or the second main display 195 can display additional information (e.g., build instructions) for the oldest order pending. The first main display 193 and/or the second main display 195 can be disposed at a higher height than other features of the beverage preparation station 185 while still being reachable by a user. The first main display 193 and/or the second main display 195 can be controlled by a controller.

The beverage preparation station 185 can include a dispense system 198, which can also be referred to as an ingredient dispensing system, pouring system, etc. The dispense system 198 can include a plurality of substations, which can include substation 200, substation 202, substation 204, substation 206, substation 208, and/or substation 210. The substation 200, the substation 202, the substation 204, the substation 206, the substation 208, and/or the substation 210 can be disposed in a line. In some variants, one or more of the substation 200, the substation 202, the substation 204, the substation 206, the substation 208, and/or the substation 210 can be positioned (e.g., physically positioned) higher or lower than other substations. All or a portion of the substation 200, the substation 202, the substation 204, the substation 206, the substation 208, and/or the substation 210 can dispense an ingredient or a plurality of ingredients. For example, substation 200 can dispense ice. Substation 200 can be disposed at an end of the dispense system 198, which can include being disposed at an end of the line of the substations of the dispense system 198. The substation 200 can be disposed at a lower height compared to the substation 202, the substation 204, the substation 206, the substation 208, and/or the substation 210. The substation 202 can dispense powder ingredients, which can include a variety of power ingredients and the like. The substation 204 can dispense coffee ingredients, which can include a variety of coffee ingredients such as cold pressed extracts (CPE) and the like. The substation 206 can dispense milk ingredients, which can include a variety of milk ingredients and the like. The substation 208 can dispense tea and/or refresher ingredients, which can include a variety of tea and/or refresher ingredients and the like. The substation 210 can dispense syrup ingredients, which can include a variety of syrup ingredients and the like. All or a portion of the substation 200, the substation 202, the substation 204, the substation 206, the substation 208, and/or the substation 210 can include a substation display. For example, the substation 200 can include a display 214. The substation 202 can include a display 216. The substation 204 can include a display 218. The substation 206 can include a display 219. The substation 208 can include a display 220. The substation 210 can include a display 222. The display 214, the display 216, the display 218, the display 219, the display 220, and/or the display 222 can be and/or can include touchscreen(s).

As described herein, the beverage preparation station 185 can facilitate a single user preparing beverage orders or a team of two or more users preparing beverage orders by performing build steps in series. The master queue of beverage orders can be displayed on the first main display 193 and/or the second main display 195, which can include displaying part of a master queue (e.g., highest priority orders on the master queue), that have not been completed. The first main display 193 and/or the second main display 195 can display the same information. The first main display 193 and/or the second main display 195 can display additional information regarding one or more (e.g., two) highest priority orders, which can be referred to as prioritized beverage orders. The additional information can include build steps for the highest priority orders, which can be organized into build step sets. The build step sets (e.g., groupings of build steps) can include build steps that correspond to the same action (e.g., ingredients to be shaken together, ingredients to be blended together, etc.). The build step sets can be organized by steps to be performed by a first user and those to be performed by a second user.

A user can select one of the prioritized beverage orders to initiate building the selected beverage order, which can include a user touching a beverage order displayed on the first main display 193 or the second main display 195. The controller can send data (e.g., instructions) regarding the build steps associated with the selected beverage order to the substation(s). The substation(s) can, in some variants, perform actions to prepare for performing the build step(s) associated with the beverage order. For example, if the recipe for the selected beverage order calls for ice, the substation 200 configured to dispense ice can prepare to dispense a quantity of ice pursuant to the recipe for the selected beverage order. The displays of the substations with build steps associated with the recipe for the selected beverage order can display instructions and/or other information (e.g., ingredient information, order information, etc.) to the user, which can include displaying information and/or visual identifier(s) (e.g., colors, patterns, and/or graphics) associating the instructions and/or other information to the selected beverage order to avoid a user confusing build steps for different orders. In some variants, the displays of the substations with build steps associated with the recipe for the selected beverage can sequentially display instructions and/or other information in the order that the build steps are to be performed. In some variants, the displays of the substations with build steps associated with the recipe for the selected beverage order can simultaneously display instructions and/or other information.

As described herein, the recipes for beverage orders can include build step sets (e.g., groupings of build steps) that correspond to the same action (e.g., ingredients to be shaken together, ingredients to be blended together, etc.) and/or are to be performed by a first user or a second user after the first user has completed one or more build step sets. For example, the first user may select a beverage order, such as a prioritized beverage order, for an iced shaken espresso. The beverage order can display build steps for the iced shaken espresso grouped in build step sets (e.g., groupings). A first build step set can be intended for a first user and include one or more build steps associated with shaking ingredients together, which can include dispensing ice, coffee, and syrup that is to be shaken together. A second build step set can be intended for a second user and include one or more build steps associated with after shaking ingredients together, which can include dispensing milk. When the first user selects the beverage order for the iced shaken espresso, build instructions from the recipe for the iced shaken espresso can be sent to the substations. The substations can prepare to perform actions for the build steps (e.g., prepare to dispense ingredients). The displays of the substations can display instructions and/or other information to guide performance of the build steps according to the recipe of the selected beverage order. For the ice shaken espresso beverage order, the substation 200 configured to dispense ice, substation 204 configured to dispense espresso, and substation 210 configured to dispense syrup, and substation 206 configured to dispense milk can prepare to dispense. The first main display 193 and/or the second main display 195 can indicate that a first build step, which can be associated with the first user, is actively being performed. The displays of the substation 200, the substation 204, the substation 210, and/or the substation 206 can display (e.g., in sequence or simultaneously) instructions and/or other information to guide performance of the build steps according to the recipe for the ice shaken espresso beverage order. The first user or the second user can acquire a cup with a size associated with the ice shaken espresso beverage order. The first user or the second user can print a label with information regarding the ice shaken espresso beverage order using the label maker 226 and apply it to the acquired cup. In some variants, the label can automatically print when a beverage order is selected using the first main display 193 and/or the second main display 195. The first user can acquire a container (e.g., shaking container). The first user can be guided by the displays of the substations and/or main displays to dispense ingredients into the container for shaking together. For example, the display 214 of the substation 200 can prompt the first user to dispense ice into the container. The first user can interact with an interface of the substation 200 (e.g., push a paddle with the container) to dispense ice into the container. The display 218 for the substation 204 can prompt the first user to dispense espresso into the container. The first user can interact with an interface of the substation 204 (e.g., push a paddle with the container) to dispense espresso into the container. The display 222 for the substation 210 can prompt the first user to dispense syrup into the container. The first user can interact with an interface of the substation 210 (e.g., push a paddle with the container) to dispense syrup into the container. The first main display 193 and the second main display 195 and/or one or more of the substation displays can instruct shaking the ice, espresso, and syrup together. Accordingly, the first user can close the container and shake the contents thereof. In some variants, the first user can give the container to the second user to shake. With the first build step set complete (e.g., ice, espresso, and syrup dispensed), the first main display 193 and/or second main display 195 can indicate that the first build step is complete and the second build step set is actively being performed. The display 219 of the substation 206 can prompt the second user to dispense milk. In some variants, the second user can interact with an interface of the substation 206 (e.g., push a paddle) to dispense milk into the container, which is then poured into the cup. In some variants, the second user can pour the contents of the container into the cup and interact with the interface of the substation 206 to dispense milk directly into the cup. With the ice, espresso, syrup, and milk in the cup, the second user can place a lid on the cup to complete the beverage order. The first user, in some variants, can select a second beverage order from the first main display 193 and/or second main display 195 while the second user is still performing build steps for the first selected beverage order so that build steps for two or more beverage orders are being performed simultaneously to avoid delay.

The layout of the beverage preparation station 185 can be advantageous for two or more users working in series on beverage orders (e.g., a first user performing initial steps and a second user performing finishing steps). For example, the first user can be positioned in front of the dispense system 198 and be tasked with performing most if not all dispense build steps. The second user can be positioned by features (e.g., the one or more trays 199, blender 230, blender 232, sink 234, sink 236, drying rack 238, drying rack 240, and/or others) for performing build steps or other actions primarily performed after dispensing or after a substantial portion of the dispensing has been performed. The one or more trays 199, blender 230, blender 232, sink 234, sink 236, drying rack 238, drying rack 240, and/or others can be disposed on one side of the dispense system 198, which can be advantageous for the first user performing dispense steps and the second user performing subsequent steps using one or more of the one or more trays 199, blender 230, blender 232, sink 234, sink 236, drying rack 238, and/or drying rack 240.

In some variants, it can be desirable to utilize a parallel beverage order preparation process in which the first user and the second user are preparing beverage orders in parallel that are pulled from the master queue. The first user can perform all the build steps for a first beverage order and, simultaneously, the second user performs all the build steps for a second beverage order. The first main display 193 can be associated with the first user. The second main display 195 can be associated with the second user. The first main display 193 can display beverage orders pulled from the master queue. The second main display 195 can display different orders pulled from the master queue such that the first user and the second user do not prepare the same beverage orders. The controller can automatically allocate beverage orders from the master queue to the first main display 193 or second main display 195. The allocation of beverage orders from the master queue to the first main display 193 or second main display 195 can be based on capacity and/or priority.

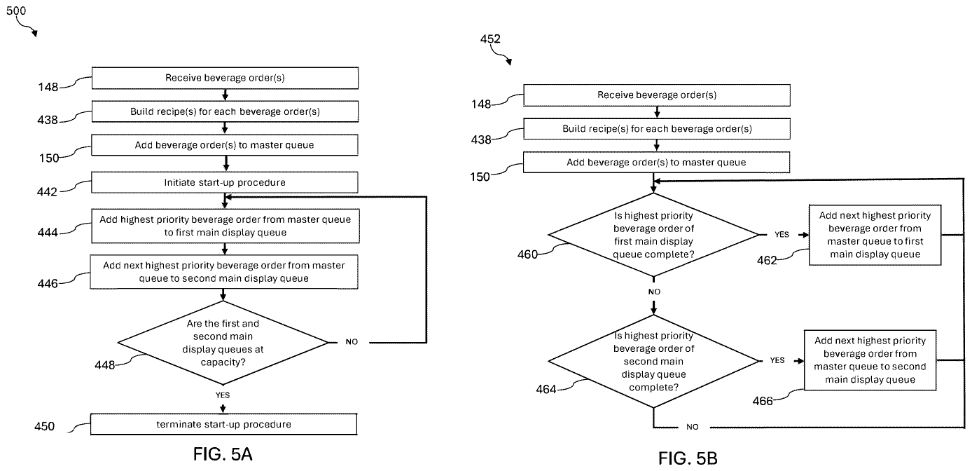

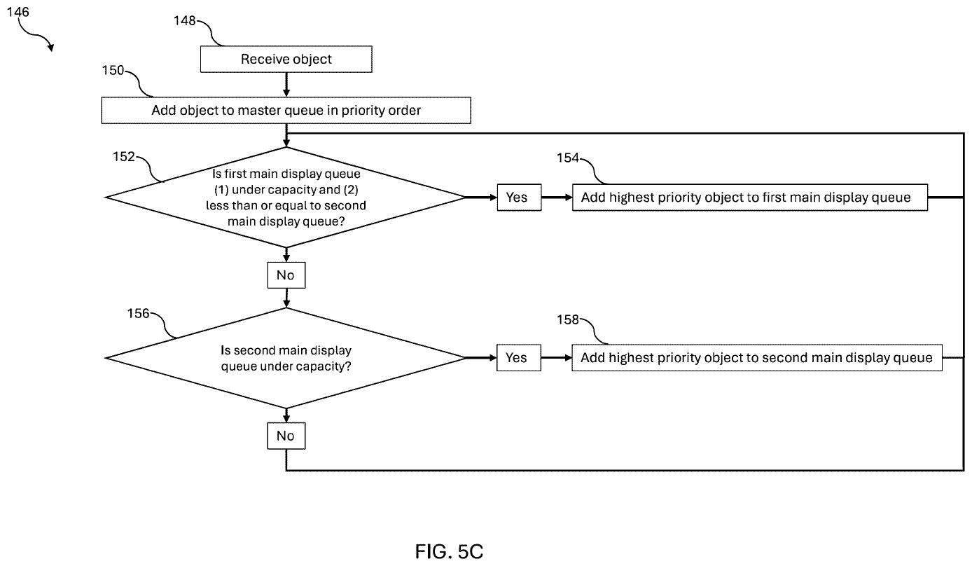

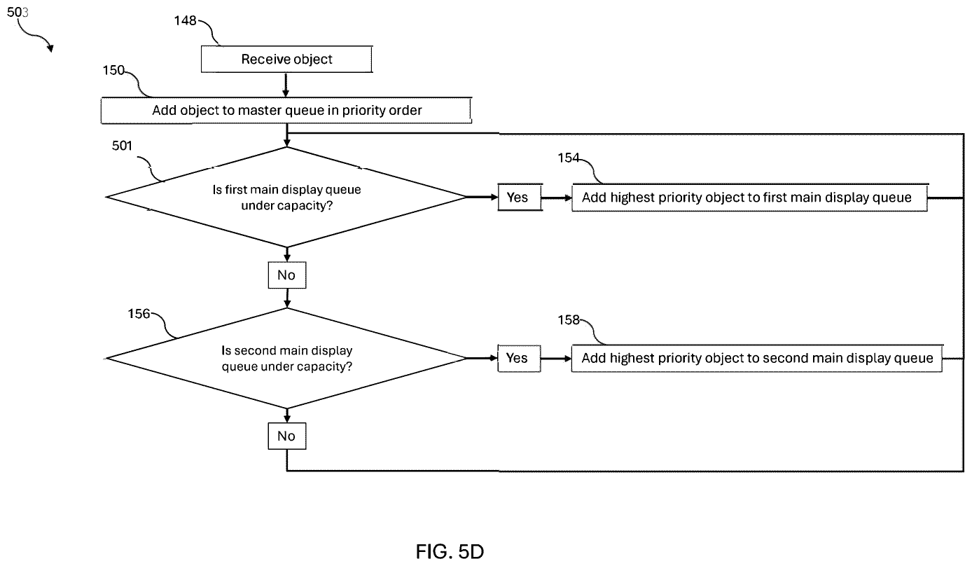

FIG. 5A is a flow diagram illustrative of an embodiment of a method 500 implemented by any of the beverage preparation stations and/or the beverage preparation systems described herein to dynamically allocate beverage orders from a master queue to the queues of a first main display (e.g., a first queue, a first subordinate queue, a first downstream queue, a first main display queue, etc.) and/or a second main display (e.g., a second queue, a second subordinate queue, a second downstream queue, a second main display queue, etc.). Although described as being implemented by a controller, it will be understood that elements outlined for method 500 can be implemented by one or more computing devices or components that are associated with any of the beverage preparation stations and/or the beverage preparation systems described herein, which can include the beverage preparation station 184 and/or beverage preparation station 185. Thus, the following illustrative embodiment should not be construed as limiting.

At block 148, the controller can receive one or more objects (e.g., beverage orders). The one or more beverage orders can be received from a plurality of locations, such as through one or more point of service systems in a restaurant or through mobile orders. Customers can customize the one or more beverage orders. Further, the controller can receive the one or more drink beverage directly or via a network from one or more computing systems. The controller can receive the one or more beverage orders as one or more packets of data. In some cases, the controller can identify metadata associated with the one or more beverage orders. For example, the controller can identify a store, a customer, equipment, an employee, inventory, etc. associated with the one or more beverage orders. The controller may receive the metadata with the one or more beverage orders or separately from the one or more beverage orders.

At block 438, the controller can build recipe(s) for each beverage order received as described at block 404 of method 400. In some variants, building the recipe can be performed after addition to the master queue, after addition to the first or second main display queues, or after selection.

At block 150, the controller can add the one or more object (e.g., beverage orders) to a master queue. The master queue can be a digital or virtual queue. To add the one or more beverage orders to the queue, the controller can transmit data identifying the one or more beverage orders to a computing device. The master queue can order the one or more beverage orders, which can include ordering the one or more beverage orders by priority. Priority can be based on a customer associated with the drink order, a time of receipt of the drink order (e.g., older orders prioritized ahead of newer orders), a type of the drink order (e.g., an americano with multiple additions, a black coffee with no additions, etc.), an order type of the drink order (e.g., an online order, an in-person order, etc.), and/or other characteristics. In some variants, a user can establish priority for one or more of the beverage orders. For example, with priority based on receipt time, the beverage orders may be ordered from oldest to newest.

At block 442, the controller can initiate a start-up procedure. The start-up procedure can be initiated at the start of a business day before order building has begun. The start-up procedure can be initiated upon turning on the beverage preparation system. The start-up procedure, as described, can allocate orders from the master queue in an alternating manner to the first and second main displays.

At block 444, the controller can add a highest priority beverage order from the master queue to the first main display queue, which can remove the highest priority beverage order from the master queue. Upon addition to the first main display queue, the controller can cause, via the first main display, the beverage order added to the first main display queue to be displayed.

At block 446, the controller can add a highest priority beverage order from the objects still on the master queue to the second main display queue. Upon addition to the second main display queue, the controller can cause, via the second main display, the beverage order added to the second main display queue to be displayed.

At decision block 448, the controller can determine if the first and the second main display queues are at their capacities of orders. In some variants, the capacities of the first and the second main display queues can be the same. In some variants, the capacities of the first and second main display queues can be different. In some variants, the first and the second main display queues can each have a capacity (e.g., a threshold, a threshold order capacity, a threshold order quantity, etc.) of one, two, three, four, or more orders. If the first and second main display queues are not at their capacities (e.g., a quantity of orders in the first main display queue does not satisfy a first threshold and a quantity of orders in the second main display queue does not satisfy a second threshold), the method can return to block 444. If the first and the second main display queues are at their capacities of orders, the method can progress to block 450 and terminate the start-up procedure.

FIG. 5B is a flow diagram illustrative of an embodiment of a method 452 implemented by any of the beverage preparation stations and/or the beverage preparation systems described herein to dynamically allocate beverage orders from a master queue to the queues of a first main display or second main display. Although described as being implemented by a controller, it will be understood that elements outlined for method 452 can be implemented by one or more computing devices or components that are associated with any of the beverage preparation stations and/or the beverage preparation systems described herein, which can include the beverage preparation station 184 and/or beverage preparation station 185. Thus, the following illustrative embodiment should not be construed as limiting. The block 148, the block 438, and the block 150 are described in reference to FIG. 5A. In some variants, method 452 can be a continuation of method 500.

At decision block 460, the controller can determine if the highest priority beverage order of the first main display queue has been completed, which can be based on data signals received from the various substations. If the highest priority beverage order (e.g., oldest by receipt date) of the first main display queue has been completed, the method can proceed to block 462 and add the next highest priority beverage order from the master queue to the first main display queue and return to decision block 460. If the highest priority beverage order of the first main display queue has not been completed, the method can progress to decision block 464. At decision block 464, the controller can determine if the highest priority beverage order (e.g., oldest by receipt date) of the second main display queue has been completed. If the highest priority beverage order of the second main display queue has been completed, the method can progress to block 466 and add the next highest priority beverage order from the master queue to the second main display queue. If the highest priority beverage order of the second main display queue has not been completed, the method can return to decision block 460.

FIG. 5C is a flow diagram illustrative of an embodiment of a method 146 implemented by any of the beverage preparation stations and/or the beverage preparation systems described herein to dynamically allocate beverage orders from a master queue to the queues of a first main display or second main display. Although described as being implemented by a controller, it will be understood that elements outlined for method 146 can be implemented by one or more computing devices or components that are associated with any of the beverage preparation stations and/or the beverage preparation systems described herein, which can include the beverage preparation station 184 and/or beverage preparation station 185. Thus, the following illustrative embodiment should not be construed as limiting. The block 148 and the block 150 are described in reference to FIG. 5A.

At decision block 152, the controller can determine if the quantity of beverage orders of a first main display queue, which can be a queue associated with the first main display associated with the first user, is (1) under capacity and (2) exceeds (e.g., is greater than, more than, includes more orders, etc.), does not exceed (e.g., is less than, includes less orders, etc.), or is equal to (e.g., includes the same quantity of orders) the quantity of beverage orders of a second main display queue, which can be a queue associated with the second main display associated with the second user. The first main display queue can be displayed on the first main display. The first main display queue can include the beverage orders assigned to the first user. The second main display queue can be displayed on the second main display. The second main display queue can include the beverage orders assigned to the second user. The capacity (e.g., a maximum number of beverage orders that a queue may include), in some variants, for the first main display queue and the second main display queue can be the same. The capacity for the first main display queue, in some variants, can be two beverage orders. Accordingly, if the number of beverage orders of the first main display queue is less than a capacity and less than or equal to the number of beverage orders of the second main display queue, the controller, at block 154, can add the highest priority object (beverage order) from the master queue to the first main display queue and return to decision block 152. Priority can be based on time such that the oldest beverage order (e.g., the beverage order that was received prior to other beverage orders of the queue, the beverage order that has been pending for a time period that exceeds a time period that other beverages of the queue have been pending, etc.) has the highest priority. In some variants, a user, such as the first user, can designate a beverage order on the master queue as having highest priority such that the designated beverage order is added to the first main display queue ahead of older beverage orders on the master queue.

If the number of beverage orders of the first main display queue is not less than a capacity or less than or equal to the number of beverage orders of the second main display queue, the controller can determine at decision block 156 if the number of objects (e.g., beverage orders) on the second main display queue is under capacity (e.g., under the maximum number of beverage orders). In some variants, the first main display queue and the second main display queue can be the same. The capacity for the second main display queue, in some variants, can be two beverage orders. If the number of objects (e.g., beverage orders) of the second main display queue is under capacity, the controller, at block 158, can add the highest priority object (e.g., beverage order) from the master queue to the second main display queue and return to decision block 152. Priority can be based on time such that the oldest beverage order (e.g., based on receipt time) has the highest priority. In some variants, a user, such as the second user, can designate a beverage order on the master queue as having highest priority such that the designated beverage order is added to the second main display queue ahead of older beverage orders on the master queue. If the second main display queue is not under capacity, the controller can return to decision block 152.

To provide an example of method 146, the controller can receive ten beverage orders, all or a portion of the beverage orders having a respective timestamp. The ten beverage orders can be added to a master queue in order from oldest (e.g., based on which beverage order was received temporally first by the controller) to newest (e.g., based on which beverage order was received temporally last by the controller) to establish the priority order of the beverage orders. The first main display queue and the second main display queue may have zero beverage orders. Accordingly, the controller may determine that the first main display queue is under capacity (e.g., has less than two beverage orders) and is equal to the second main display queue (e.g., both have zero) and proceed to add the highest priority (e.g., oldest based on receipt time) beverage order from the master queue to the first main display queue such that the first main display queue has one beverage order, which can be displayed on the first main display, and the second main display queue has zero beverage orders. The controller may determine that the first main display queue is under capacity but is not less than the second main display queue and proceed to determine if the second main display queue is under capacity (e.g., has less than two beverage orders). The controller may determine that with zero beverage orders the second main display is under capacity and add the next highest priority (next oldest based on receipt time) beverage order to the second main display queue so that the second main display queue has one beverage order, which may be displayed on the second main display. The controller may then determine that the first main display queue is under capacity (e.g., less than two beverage orders) and equal to the second main display queue (e.g., the first main display queue and the second main display queue have the same number of beverage orders at one) and proceed to add the next highest priority beverage order to the first main display so that the first main display queue has two beverage orders, which may be displayed on the first main display. The controller may then determine that the first main display queue is at capacity (e.g., has two beverage orders) and proceed to determine ﬁ the second main display queue is under capacity. The controller may determine that the second main display queue is under capacity (e.g., less than two beverage orders) and add the next highest priority beverage order to the second main display queue so that the second main display queue has two beverage orders, which may be displayed on the second main display.

FIG. 5D is a flow diagram illustrative of an embodiment of a method 503 implemented by any of the beverage preparation stations and/or the beverage preparation systems described herein to dynamically allocate beverage orders from a master queue to the queues of a first main display or second main display. Although described as being implemented by a controller, it will be understood that elements outlined for method 146 can be implemented by one or more computing devices or components that are associated with any of the beverage preparation stations and/or the beverage preparation systems described herein, which can include the beverage preparation station 184 and/or beverage preparation station 185. Thus, the following illustrative embodiment should not be construed as limiting. The block 148 and the block 150 are described in reference to FIG. 5A.

At block 501, the controller can determine if the quantity of beverage orders of a first main display queue is under capacity (e.g., predetermined capacity), such as two beverage orders. If the quantity of beverage orders of the first main display queue is under capacity, the controller, at block 154, can add the highest priority object (beverage order) from the master queue to the first main display queue and return to block 501. If the quantity of beverage orders of the first main display queue is not under capacity, the controller, at decision block 156, can determine if the quantity of beverage orders of the second main display queue is under capacity. If the quantity of beverage orders of the second main display queue is under capacity, the controller, at block 158, can add the highest priority object (beverage order) from the master queue to the second main display queue and return to block 501. If the quantity of beverage orders of the second main display queue is not under capacity, the controller can return to block 501.

In some variants, at the outset of populating the first and second main display queues, the controller can initiate a start-up procedure and add the highest priority objects to the first and second main display queues until capacity is reached (e.g., two per queue) in an alternating manner (e.g., first highest to first queue, second highest to second queue, third highest to third queue, and fourth highest to fourth queue).

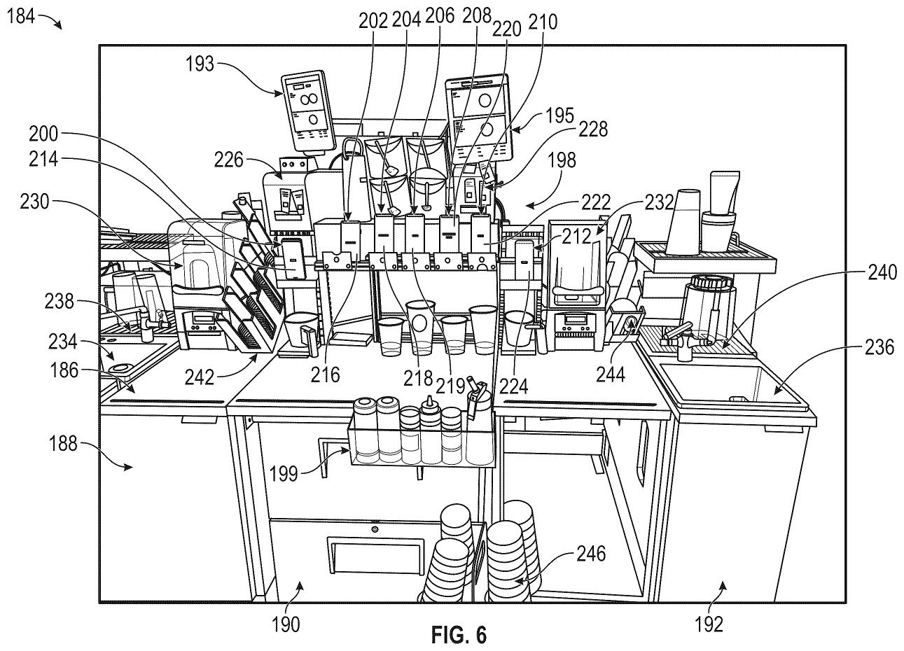

FIG. 6 illustrates an example beverage preparation station 184. The beverage preparation station 184 can be configured for two users simultaneously (e.g., in parallel) preparing different beverage orders pulled from the master queue. The beverage preparation station 184 can be configured to operate with a controller (e.g., a controller of the beverage preparation system) to add beverage orders from the master queue to the first main display queue displayed on first main display 193 for the first user and the second main display queue displayed on the second main display 195 for the second user. The beverage preparation station 184 can include any of the features of the beverage preparation station 185. In contrast to the beverage preparation station 185, the beverage preparation station 184 can be arranged to provide both the first user and the second user convenient access to the features of the beverage preparation station 184 to complete all the build steps for the recipe of a beverage order. For example, one side (e.g., the left side) of the beverage preparation station 184 can be conveniently accessible to the first user and include the first main display 193, label maker 226, blender 230, one or more lid racks 242, sink 234, and/or drying rack 238. Another side (e.g., the right side) of the beverage preparation station 184 can be conveniently accessible to the second user and include the second main display 195, label maker 228, blender 232, one or more lid racks 244, sink 236, and/or drying rack 240. Certain features of the beverage preparation station 184 can be centrally located to be conveniently accessible to the first user and the second user, which can include the dispense system 198, one or more trays 199, and/or one or more cup racks 246. The dispense system 198 can include a substation 212 (e.g., an additional substation) with an display 224. The substation 212 can be disposed on an opposite side (e.g., right side) of the dispense system 198, which can be more conveniently accessed compared to the substation 200. The substation 212 can be configured to dispense ice according to a recipe of a selected beverage order. In some variants, the controller will send build instructions for ice for beverage orders from the first main display 193 to the substation 200 and from the second main display 195 to the substation 212. The one or more trays 199, which can include finishing ingredients, and/or the one or more cup racks 246 can be shared features disposed centrally to be conveniently accessible by both the first and second users.

In use, beverage orders can be allocated from the master queue to the first main display queue displayed on the first main display 193 and the second main display queue displayed on the second main display 195 as described in reference to method 146. The first user can use the first main display 193. The second user can use the second main display 195. The first user can select (e.g., tap) one of the beverage orders of the first main display queue, which can cause the controller to send build instructions for the recipe of the selected beverage order to the relevant substations. The second user can, independently of the first user, select (e.g., tap) one of the beverage orders of the second main display queue, which can cause the controller to send build instructions for the recipe of the selected beverage order to the relevant substations. In some variants, the highest priority beverage order on the first main display queue can be automatically selected. In some variants, the highest priority beverage order on the second main display queue can be automatically selected. The selected beverage order shown on the first main display 193 and the instructions shown on the displays of the substations that received associated build instructions can share a first visual identifier (e.g., color, border, graphic, pattern, symbol, etc.) that provides a visual association. The selected beverage order shown on the second main display 195 and the instructions shown on the displays of the substations that received associated build instructions can share a second visual identifier (e.g., color, border, graphic, pattern, symbol, etc.) that provides a visual association. The first visual identifier and the second visual identifier can be different to avoid confusing instructions at the substations for one beverage order with another, which can enable the first user and the second user to efficiently and accurately prepare beverage orders simultaneously. In some variants, the displays at the substations can simultaneously display instructions for different beverage orders. For example, at the substation 210 configured for dispensing syrup, the display 224 can, in some variants, display instructions for dispensing brown sugar syrup for one beverage and vanilla syrup for another beverage. The instructions can, in some variants, include visual identifiers to avoid erroneously adding the wrong syrup to a beverage order.

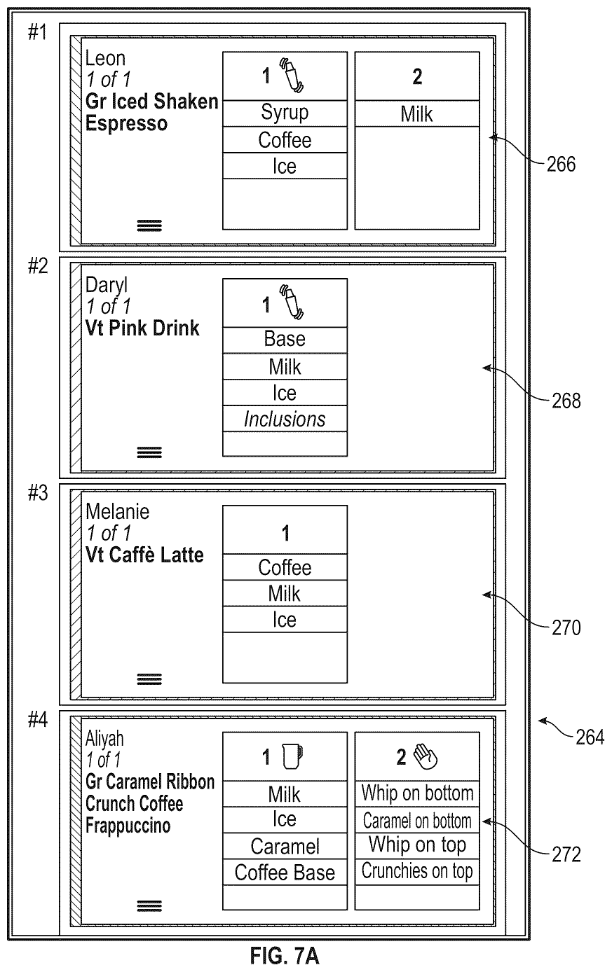

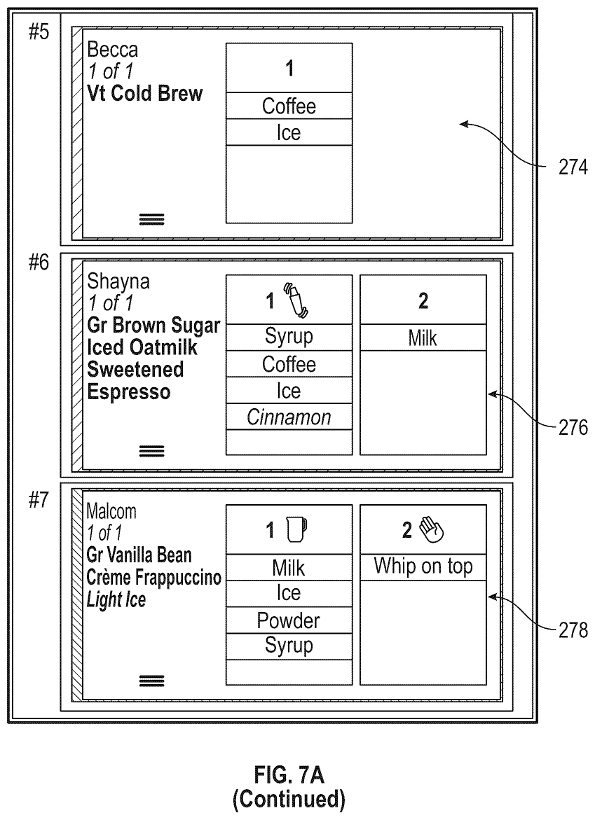

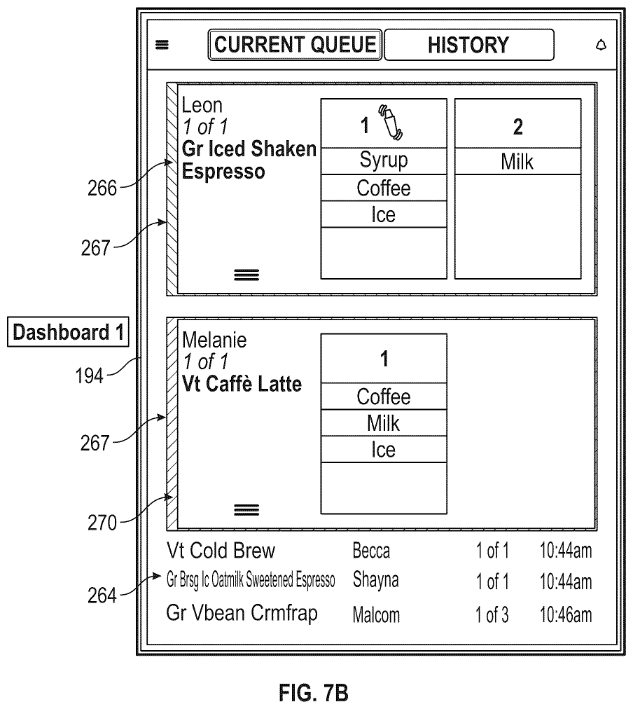

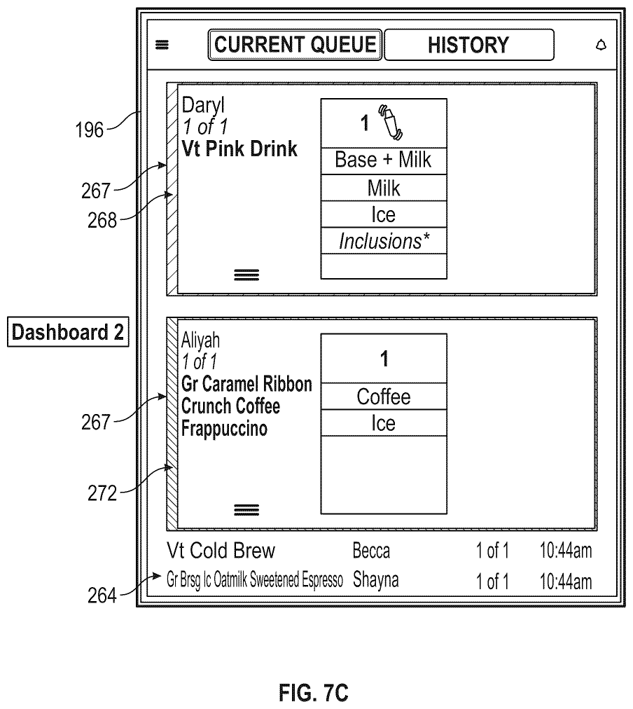

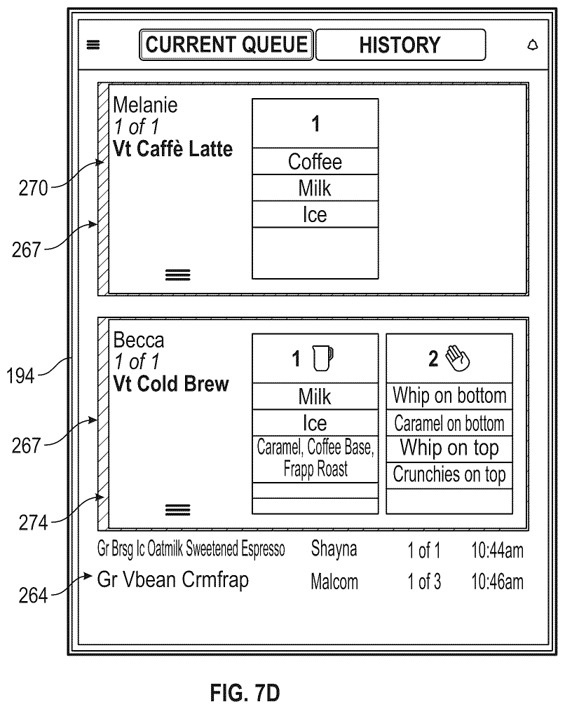

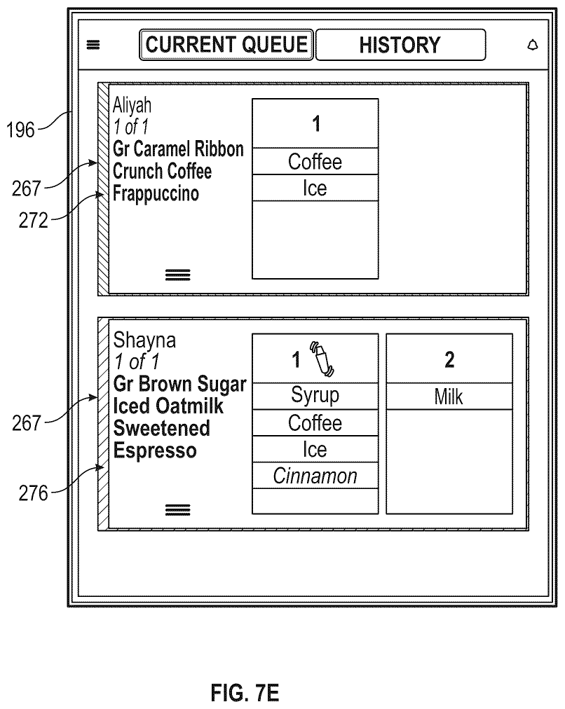

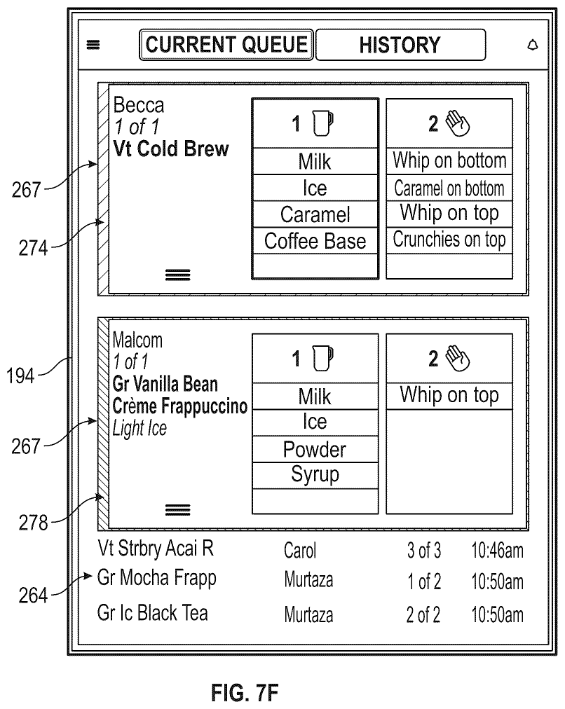

FIG. 7A illustrates an example master queue 264 that can include objects (e.g., beverage orders, food orders, etc.) received by the controller. The beverage orders of the master queue 264 can be ordered by priority, which can at least include any of the prioritizing methods described herein. In some variants, the beverage orders can be ordered by receipt time such that the older beverage orders have priority over the newer beverage orders (e.g., a first beverage order that has been pending for a greater amount of time than, was received prior to, etc. a second beverage order may be considered older than the second beverage order and the second beverage order may be considered newer than the first beverage order). In the example shown, the master queue 264 includes seven beverage orders, including a first beverage order 266, second beverage order 268, third beverage order 270, fourth beverage order 272, fifth beverage order 274, sixth beverage order 276, and seventh beverage order 278. Using the method described in reference to method 248 and/or method 400, the beverage orders can be allocated from the master queue 264 to the queues associated with the first main display 193 and the second main display 195. FIGS. 7B, 7D, and 7F illustrate a graphical user interface 194 of the first main display 193 sequentially through time as beverage orders are removed and added to the first main display queue. FIGS. 7C and 7E illustrate a graphical user interface 196 of the second main display 195 sequentially through time as beverage orders are removed and added to the second main display queue. FIGS. 7B and 7C respectively show the graphical user interface 194 of the first main display 193 and the graphical user interface 196 of the second main display 195 at the same moment in time. FIGS. 7D and 7E respectively show the graphical user interface 194 of the first main display 193 and the graphical user interface 196 of the second main display 195 at the same moment in time.

As shown in FIGS. 7B and 7C, the first beverage order 266 can be added first to the first main display queue, the second beverage order 268 can be added second to the second main display queue, the third beverage order 270 can be added third to the first main display queue, and the fourth beverage order 272 can be added fourth to the second main display queue. The first user can start preparing the first beverage order 266. The second user can start preparing the visual order identifier 267. As shown, the first user finished the first beverage order 266 before the second user finished the visual order identifier 267 such that, as shown in FIGS. 7D and 7E, the fifth beverage order 274 was added to the first main display queue and then the sixth beverage order 276 was added to the second main display queue. If the second user had finished the second beverage order 268 before the first user had finished the first beverage order 266, the fifth beverage order 274 would have been added to the second main display queue and the sixth beverage order 276 would have been added to the first main display queue. The first user can start preparing the third beverage order 270 and the second user can start preparing the fourth beverage order 272. As shown in FIG. 7F, the first user finished the third beverage order 270 before the second user finished the fourth beverage order 272 such that the seventh beverage order 278 was added to the first main display queue. The first and second main display queues can include beverage orders from the master queue up to a capacity (e.g., two) that can be ordered in priority with highest priority positioned above a lower priority beverage order as compared to the priority of other beverage orders. As shown, all or a portion of the beverage orders displayed on the first main display 193 and second main display 195 can have a visual order identifier 267, which can at least be a color, pattern, symbol, graphic, etc. that can quickly differentiate one beverage order from another and associated build steps displayed at substations. The visual order identifier 267, in some variants, can include a border around information associated with a beverage order, which can include a border with a color, pattern, and/or graphic. Visual order identifiers can be repeated as beverage orders are complete such that the same visual order identifier may not be displayed for two different beverage orders at the same time on the first main display 193 and second main display 195 as shown. For example, the visual order identifier 267 for the second beverage order 268 and the visual order identifier 267 for the fifth beverage order 274 can be the same, as shown in FIGS. 7C and 7D, because second beverage order 268 was completed prior to fifth beverage order 274 being added to the first main display queue (e.g., displayed on the graphical user interface 194 of the first main display 193. As shown in FIGS. 7B, 7C, 7D, 7E, and 7F, a portion (e.g., highest priority portion) of the master queue 264 that has not been added to the first main display queue or the second main display queue can be displayed on the graphical user interface 194 and the graphical user interface 196 of the first main display 193 and the second main display 195. As beverage orders are added to the first main display queue or the second main display queue, the displayed portion of the master queue 264 that has not been added to the first main display queue or the second main display queue can be updated to accurately reflect the beverage orders still on the master queue.

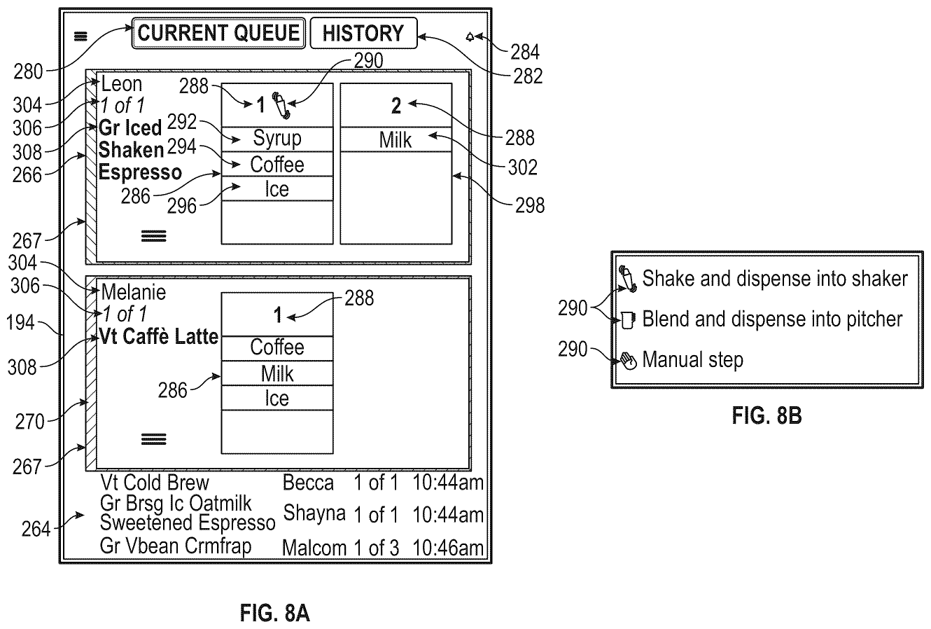

FIG. 8A illustrates an example graphical user interface 194 for the first main display 193. The graphical user interface 196 for the second main display 195 can include the same or similar features as the graphical user interface 194. The graphical user interface 194 can display beverage orders assigned to the first main display queue from the master queue. For example, the graphical user interface 194 can display a first beverage order 266 and a third beverage order 270. The first beverage order 266 can include a visual order identifier 267 that is different from the visual order identifier 267 of the third beverage order 270. All or a portion of the first beverage order 266 and the third beverage order 270 can include a customer identifier 304 (e.g., customer name), customer order count 306 (e.g., one of one, one of two, two of three, etc. for the particular customer), and/or order name 308. The order name 308 can include a descriptor for the beverage ordered (e.g., iced shaken espresso, caffe latte, etc.) and/or beverage size ordered (e.g., small, medium, large, Demi, Short, Tall, Grande, Venti, Trenta), which can include abbreviated terms. The first beverage order 266 and second beverage order 268 can include build step sets, which can include build steps (e.g., ingredients) organized into sets based on actions associated with the build steps. For example, the first beverage order 266 can include a first build step set 286 and a second build step set 298, which can be differentiated with alphanumeric symbols 288 (e.g., 1 and 2 respectively). The first build step set 286 can be associated with a first action and the second build step set 298 can be associated with a second action, which can be planned to be second to the first. For example, the first build step set 286 can be associated with ingredients that, according to the recipe associated with the first beverage order 266, are to be shaken together, which can include being dispensed into a container (e.g., shaker) and shaken. The first build step set 286 can include an action icon 290 that can communicate to the user the action to be taken for the first build step set 286. For example, the action icon 290 can include an illustrated shaker being shaken, indicating that ingredients associated with the action icon 290 are to be shaken together (e.g., dispensed by the dispensing system into a container or cup and shaken). The first build step set 286 can include one or more build steps (e.g., including build step 292, build step 294, and/or build step 296). The one or more build steps can indicate ingredients to be dispensed by the dispensing system for the first build step set 286. For example, the build step 292 can include dispensing a syrup, the build step 294 can include dispensing a coffee, and the build step 296 can include dispensing ice. The information associated with the first build step set 286, which can include the alphanumeric symbols 288, action icon 290, build step 292, build step 294, and/or build step 296, can be enclosed within a border to help delineate information associated with first build step set 286. The action icon 290 can include other icons, which can include a blender pitcher and/or hand as illustrated in FIG. 8B. The blender pitcher can indicate that ingredients are to dispensed and then blended, which can include being dispensed into a blender pitcher for blending. The manual step can indicate that the user will perform a manual step for the associated build step. The second build step set 298 can include a build step 302, which can include dispensing milk. Accordingly, in practice, the first build step set 286 can be completed, which can include dispensing and shaking the ingredients together and then pouring them into a cup, followed by the second build step set 298, which can include dispensing milk into the cup, to finish the first beverage order 266. With a parallel process, the first build step set 286 and the second build step set 298 can be performed by the same user. With a serial process, the first build step set 286 can be performed by a first user and the second build step set 298 can be performed by a second user.

When a build step set is completed, the graphical user interface 194 can indicate it with respect to the build step set. In some variants, when a build step is completed, the graphical user interface 194 can indicate it. When the first beverage order 266 is completed, the graphical user interface 194 can indicate it. When the first beverage order 266 is completed, the first beverage order 266 can be removed from the current first main display queue and moved to a historical first main display queue, which can maintain a queue of completed beverage orders associated with the first main display 193 and/or second main display 195 (e.g., a queue of beverage orders completed within a duration of time, such as minutes, hours, and/or days, or a queue of a set quantity of completed beverage orders, such as the last 5 beverage orders, 10 beverage orders, 15 beverage orders, 20 beverage orders, 30 beverage orders, 40 beverage orders, 50 beverage orders, 125 beverage orders, or more). The user can toggle between the current first main display queue and the historical queue utilizing the button 280 and button 282, which can be clickable (e.g., tappable) visual element of the graphical user interface 194. The graphical user interface 194 can include a notification icon 284 to notify a user of information.

The third beverage order 270 can include similar information as the first beverage order 266. The third beverage order 270 can include one or more build step sets. For example, the third beverage order 270 can include a first build step set 286, which can include a one or more build steps to be performed (e.g., dispensing coffee, milk, and/or ice with the dispensing machine). In some variants, the lack of an action icon 290 can indicate that the build steps associated with the build step set are just to be dispensed with the dispensing system without additional action, such as shaking or blending.

A portion of the master queue 264 (e.g., highest priority portion not allocated to the first main display queue or the second main display queue) can be displayed on the graphical user interface 194 and/or graphical user interface 196. The portion of the master queue 264 can include beverage order information for one, two, three, four, five, six, or more beverage orders. The portion of the master queue 264 can indicate information for the displayed beverage orders, which can include an order name (e.g., beverage order descriptor, size indication, etc.), customer name, customer order count (e.g., one of one, one of two, two of three, etc.), and/or order receipt time (e.g., 10:44 AM), which can assist a user in being aware of upcoming beverage orders.

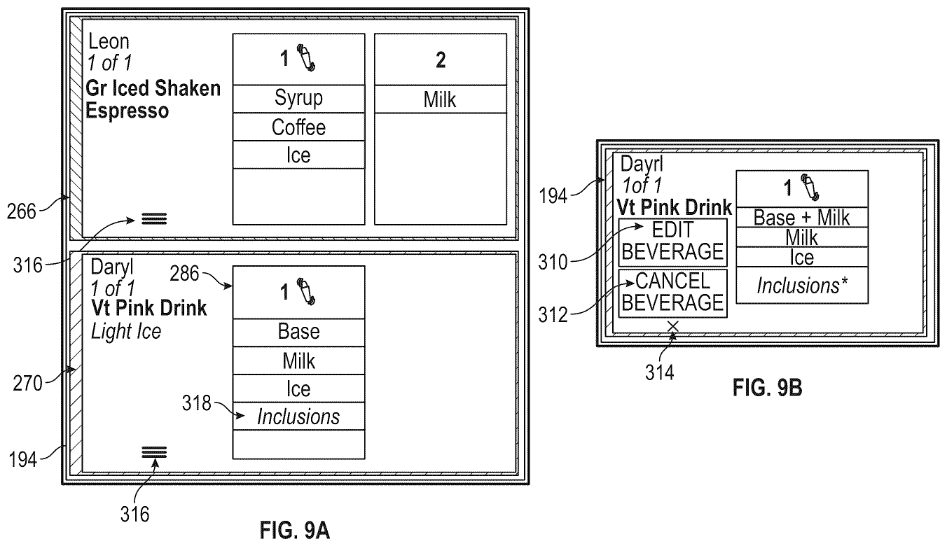

As illustrated in FIG. 9A, a build step set can include a build step 318 for inclusions, which can include ingredients to be added manually instead of dispensed by the dispensing system. All or a portion of the beverage orders can include a button 316 (e.g., clickable visual element) that a user can engage with (e.g., tap) to display options (e.g., a menu) for the associated beverage order. For example, as illustrated in FIG. 9B, the graphical user interface 194 can display a button 310 (e.g., clickable visual element) that a user can engage with (e.g., tap) to edit the associated beverage order. The graphical user interface 194 can display a button 312 (e.g., clickable visual element) that a user can engage with (e.g., tap) to cancel the associated beverage order. The graphical user interface 194 can display a button 314 (e.g., clickable visual element) that a user can engage with (e.g., tap) to exit the displayed options for the associated beverage order and return to the graphical user interface 194 shown in FIG. 9A.

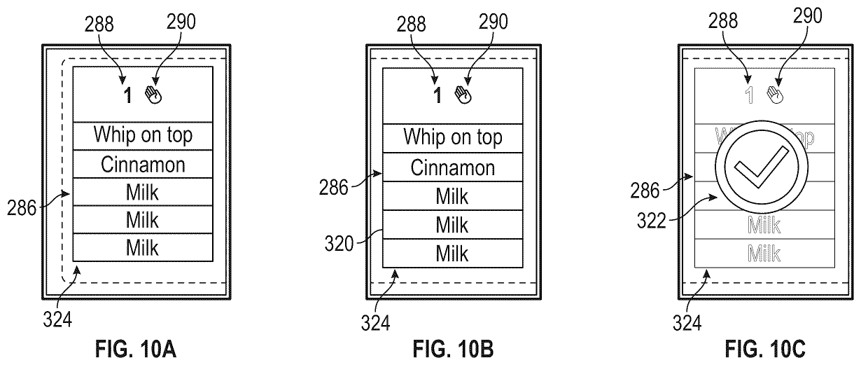

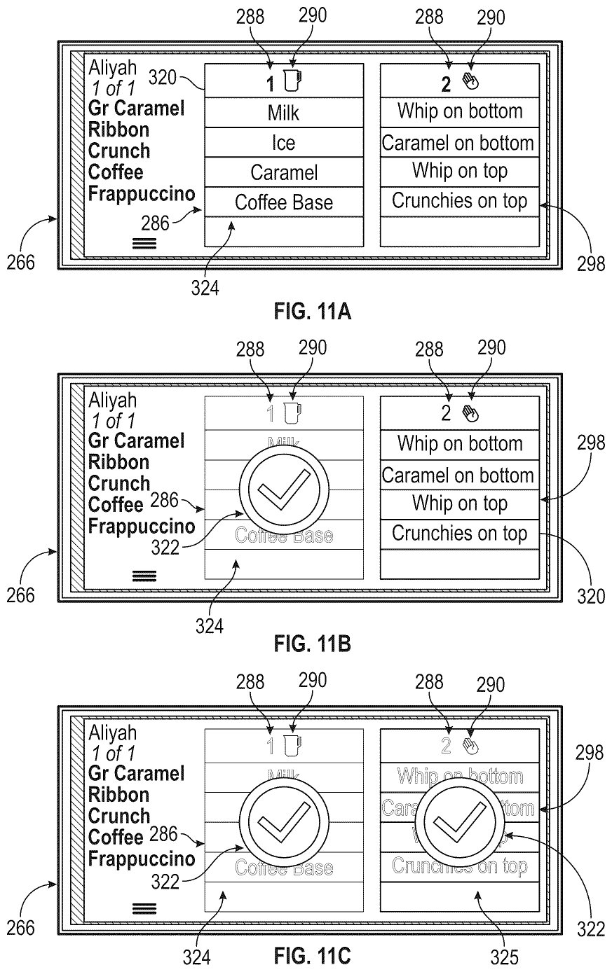

FIG. 10A, FIG. 10B, and FIG. 10C illustrate the different statuses for a build step set that a graphical user interface of the first main display 193 and/or second main display 195 can display. As illustrated in FIG. 10A, the graphical user interface 194 can indicate that a build step set for a beverage order is inactive (e.g., that work on the build step set has not commenced). For example, the border surrounding the build step set can be the same color and/or width as lines separating build steps of the build step set. As illustrated in FIG. 10B, the graphical user interface 194 can indicate that a build step set for a beverage order is active (e.g., ready to be performed and/or performance is underway). For example, the border surrounding the build step set can be changed to a different color and/or thickness. As illustrated in FIG. 10C, the graphical user interface 194 can indicate that a build step set for a beverage order has been completed. For example, the graphical user interface 194 can show the build step set dimmed and/or faded. The graphical user interface 194 can overlay a graphic, such as a check mark and/or other features, on the build step set to indicate completion. Accordingly, when creating a beverage order, the graphical user interface 194 can progress through the variations of FIGS. 10A, 10B, and 10C. For example, FIGS. 11A, 11B, and 11C illustrate how the graphical user interface 194 can progress through the variations. FIG. 11A illustrates the first beverage order 266 with the first build step set 286 active, as denoted by the active indication 320 (e.g., thickened and/or contrasting-in-color border) and the second build step set 298 inactive. FIG. 11B illustrates the first beverage order 266 with the first build step set 286 complete, which can be after the ingredients for the first build step set 286 have been dispensed, and second build step set 298 active, which can be automatic when the first build step set 286 is indicated as complete. FIG. 11C illustrates the first beverage order 266 with the first build step set 286 and the second build step set 298 complete.

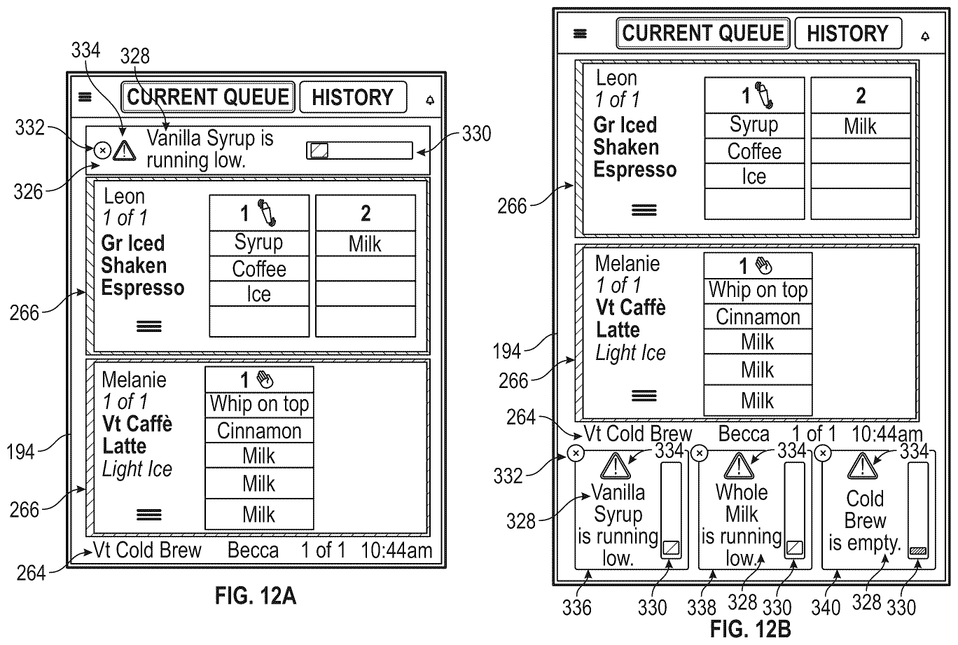

In some variants, the graphical user interface 194 can indicate statuses of one or more ingredients. The graphical user interface 194 can indicate when an ingredient is running low or empty. For example, as illustrated in FIG. 12A, an ingredient quantity notification 326 can appear (e.g., appear in a banner across the top portion of the graphical user interface 194) to indicate that an ingredient is running low or empty. The ingredient quantity notification 326 can include an icon 334 (e.g., warning icon), ingredient quantity descriptor 328 (e.g., indicate the name of the ingredient and if the ingredient is running low or empty), and/or graphic 330 (e.g., graphic showing a visual indication of the quantity of ingredient remaining relative to full, which can include a bar gauge, radial gauge, etc.). The ingredient quantity notification 326 can include a button 332 (e.g., clickable visual element) to close the ingredient quantity notification 326. The controller can cause the ingredient quantity notification 326 to be displayed when an ingredient level reaches a low threshold or empty. The beverage preparation system can include one or more sensors to monitor ingredient levels. In some variants, users can monitor ingredient levels and indicate to the controller by way of an interface (e.g., touchscreen) when an ingredient level reaches a low threshold or empty.

As illustrated in FIG. 12B, after a period of time (e.g., 5, 10, 15 seconds, etc.), the ingredient quantity notification 326 can be removed and an ingredient quantity notification 336 for the same ingredient can be shown at a bottom portion of the graphical user interface 194. The ingredient quantity notification 336 can include the icon 334, ingredient quantity descriptor 328, graphic 330, and/or button 332. Multiple ingredient quantity notifications can be displayed on the graphical user interface 194 (e.g., two, three, or more). For example, the graphical user interface 194 can display an ingredient quantity notification 338 and/or ingredient quantity notification 340. As shown with respect to the ingredient quantity notification 340, the ingredient quantity notification 340 can indicate when an ingredient is empty, which can include changing a color of the icon 334 and/or graphic 330 (e.g., from orange when the ingredient was low to red when the ingredient was empty).

As illustrated in FIG. 12C, one or more of the storage units (e.g., storage unit 188) of a beverage preparation station can house ingredients, which can include housing ingredients in a controlled environment (e.g., one or more of temperature, humidity, etc.). The storage unit 188 can include a door 342 that can be opened to access inside the storage unit 188 where one or more ingredients are stored. The ingredients can be stored in ingredient containers 348 (e.g., separate ingredient containers), which can include removable lids. The ingredient containers 348 can be filled with additional ingredients as needed. The ingredient containers 348 can be coupled to ports 350, which can be features of the storage unit 188, that can direct ingredients from the ingredient containers 348 to the substations for dispensing. In some variants, the fill levels of the ingredients can be automatically sensed using one or more sensors that provide fill level data to the controller. In some variants, the fill levels of the ingredients can be monitored by users that provide updates to the controller. In some variants, the beverage preparation station can include a display 346, which can be disposed on a storage unit 344, that can show ingredient fill levels for the various ingredients. In some variants, the ingredient containers 348 can include fill lines that a user can reference to determine the fill level of an ingredient containers 348. The fill lines can include a maximum fill line, low fill line, and an empty fill line. In some variants, the beverage preparation system can include lights (e.g., LED lights) to indicate fill level, which can include lights within the storage unit 188 or outside the storage unit 188. The light associated with an ingredient container can emit red when empty and yellow when low. The light associated with the ingredient container can emit no light when full. The light associated with the ingredient container can emit green when properly placed on a port of the ports 350 (e.g., the correct port). In some variants, an ingredient container may couple with a correct port of the ports 350 (e.g., include features that prevent coupling with an incorrect port of the ports 350) to avoid the wrong ingredient being dispensed from a substation.

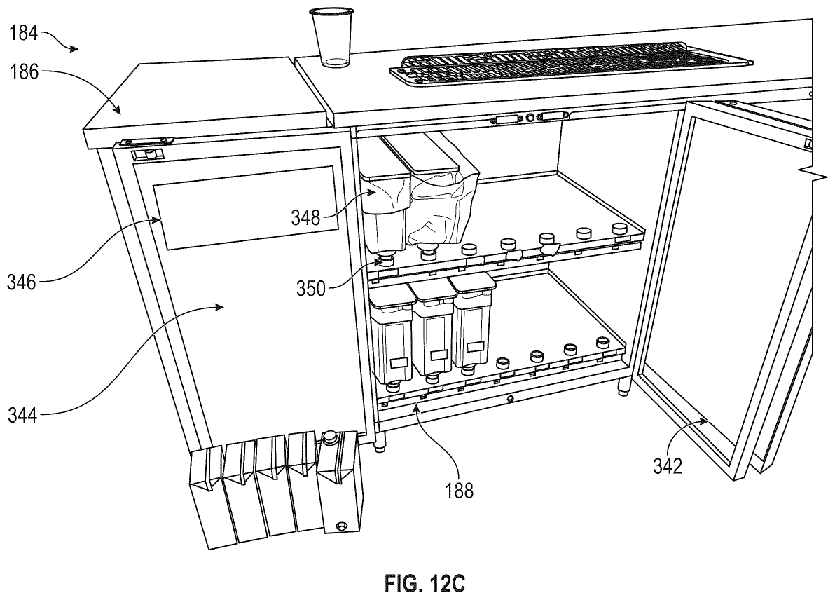

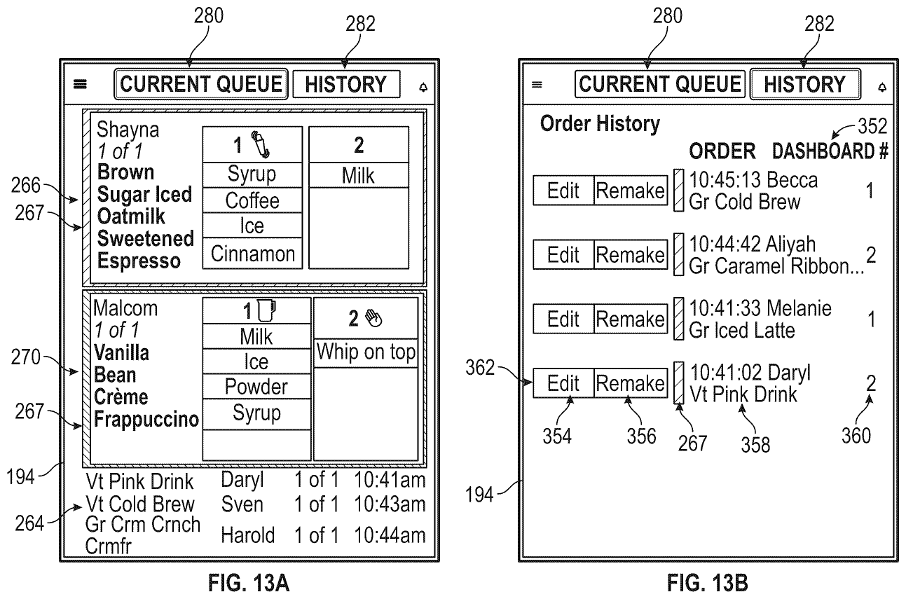

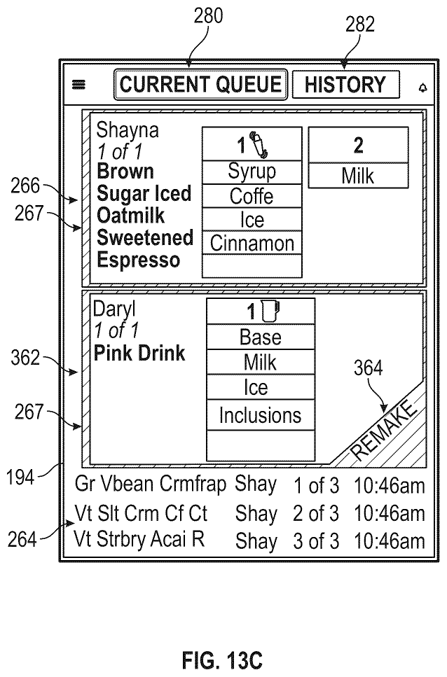

FIG. 13A illustrates an example graphical user interface 194 for the first display first main display 193, which can be the same as or similar to the graphical user interface 196 for the second main display 195. The graphical user interface 194 can include a first beverage order 266 and a third beverage order 270 shown as the current queue of the first main display. The graphical user interface 194 can include the button 282 to access the historical queue of the first main display. In some variants, the historical queue can include completed beverage orders associated with the first main display queue and/or the second main display queue.

FIG. 13B illustrates the historical queue 352 (e.g., a historical list, a tracked queue, etc.) as shown with the graphical user interface 194. For all or a portion of the beverage orders on the historical queue 352, information can be provided, which can include the main display identification 360 (e.g., whether allocated to first main display 193 or graphical user interface 194), order information 358 (e.g., time order received, time order completed, customer name, order descriptor, size descriptor, etc.), and/or the visual order identifier 267 associated with the beverage order (e.g., color, pattern). For all or a portion of the historical beverage orders, the graphical user interface 194 can provide two options, which can include edit the historical beverage order or remake the historical beverage order. The two options can be presented as button 354 and button 356 (e.g., clickable visual element) that the user can interact with (e.g., tap) to select. The button 354 can be tapped to edit the historical beverage order. The button 356 can be tapped to remake the historical beverage order. For example, the button 356 associated with the historical beverage order 362 can be interacted with (e.g., tapped) to instruct the controller that the historical beverage order 362 is to be remade. The controller can then remove the third beverage order 270 (e.g., lower priority beverage order allocated to the first main display queue) from the first main display queue, which can include adding the third beverage order 270 to the master queue 264, and adding the historical beverage order 362 to the current first main display queue to be made again. The historical beverage order 362 can include a remake indication 364 (e.g., label, identifier, badge) to indicate to the user that the historical beverage order 362 is a remake.

FIG. 13C illustrates the current queue as shown with the graphical user interface 194. Based on an interaction with the historical queue 352 to remake a historical beverage order 362, the beverage preparation system can add the historical beverage order 362 to the current queue with a remake indication 364 as discussed herein.

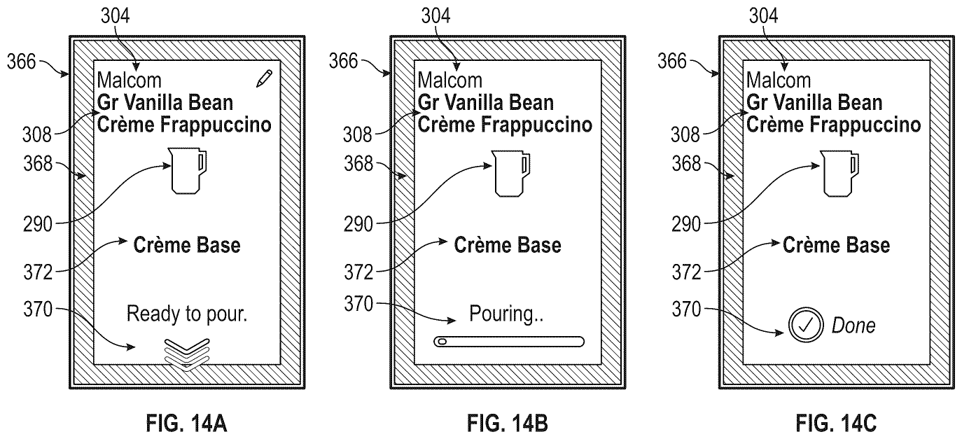

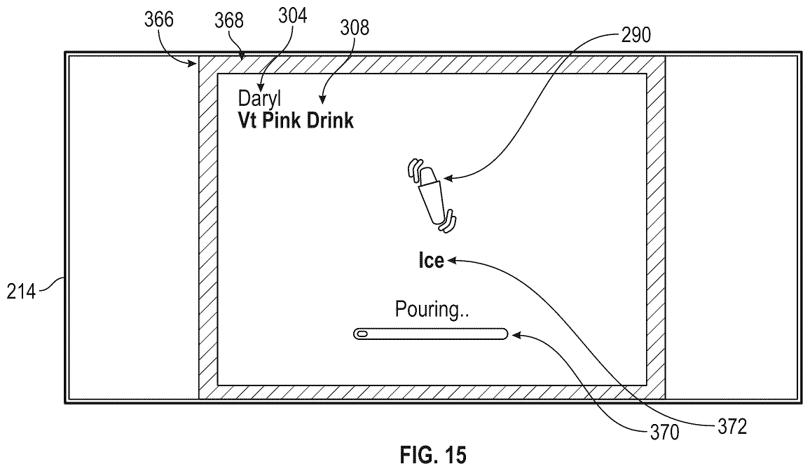

FIG. 14A, FIG. 14B, and FIG. 14C illustrate the ingredient graphical user interfaces 366 that can be displayed at a substation display to guide a user in dispensing an ingredient according to a build step of a recipe for a beverage order. The ingredient graphical user interfaces 366 can include a visual order identifier 368 to visually associate (e.g., by sharing one or more characteristics such as color, pattern, etc.) the ingredient graphical user interfaces 366 with the corresponding beverage order displayed on the graphical user interface 194 of the first main display 193 or graphical user interface 196 of the second main display 195. For example, the ingredient graphical user interfaces 366 can include a border with a same color as the border of the associated beverage order displayed on the graphical user interface 194 of the first main display 193 or graphical user interface 196 of the second main display 195. The ingredient graphical user interfaces 366 can include order information such as a customer identifier 304 (e.g., customer name), order name 308 (e.g., order descriptor, size indication, etc.), etc. The ingredient graphical user interfaces 366 can include an ingredient name 372 (e.g., crème base) to be dispensed by the substation associated with the ingredient graphical user interfaces 366. The ingredient graphical user interfaces 366 can include an action icon 290 associated with the ingredient to be dispensed and/or build step set with which the ingredient is associated. For example, the action icon 290 can include a blender container (e.g., pitcher), which can indicate that the ingredient is to be dispensed (e.g., dispensed into a blender container) and then blended. Ingredient graphical user interfaces for other ingredients with the same action icon (e.g., a blender container) can be dispensed (e.g., dispensed into the blender container) and then blended together as well. The ingredient graphical user interfaces 366 can include a substation status indication 370 that can indicate that the substation associated with the ingredient graphical user interfaces 366 is ready to dispense (e.g., pour) the ingredient indicated by the ingredient name 372. The substation status indication 370 can indicate that the substation associated with the ingredient graphical user interfaces 366 is ready to dispense (e.g., pour) the ingredient indicated by the ingredient name 372 with one or more symbols (e.g., chevron shapes, etc.) and/or text (e.g., text that indicates “ready to pour”). When the substation is dispensing (e.g., pouring) the ingredient, the substation status indication 370 can indicate so as illustrated in FIG. 14B, which can include displaying a bar gauge indicating the dispense progress (e.g., visually indicate with a bar gauge the amount of dispensing that has been performed relative to the anticipated full amount of dispensing) and/or text (e.g., text that indicates “pouring . . . ”). When the substation has completed dispensing (e.g., pouring) the ingredient, the substation status indication 370 can indicate so as illustrated in FIG. 14C, which can include displaying a graphic (e.g., a check mark) and/or text (e.g., text that indicates “done”). The substation status indication 370 can indicate that the substation has completed dispensing (e.g., pouring) for a duration of time (e.g., one, two, three, four, or more seconds) before ceasing to display the ingredient graphical user interfaces 366 for the dispensed ingredient. As shown in FIGS. 14A, 14B, and 14C, the ingredient graphical user interfaces 366 can be sized to occupy approximately half of a display of the substation, which can enable another ingredient graphical user interface for a different order to be displayed simultaneously. As shown in FIG. 15, the ingredient graphical user interface 369, in some variants, can occupy approximately all of the display of the substation when sharing the display is not anticipated. For example, in the beverage preparation station 184, all or a portion of the first user and the second user may have their own ice substations such that the ingredient graphical user interface 369 for the ice substations may not provide display space for a second ingredient graphical user interface.

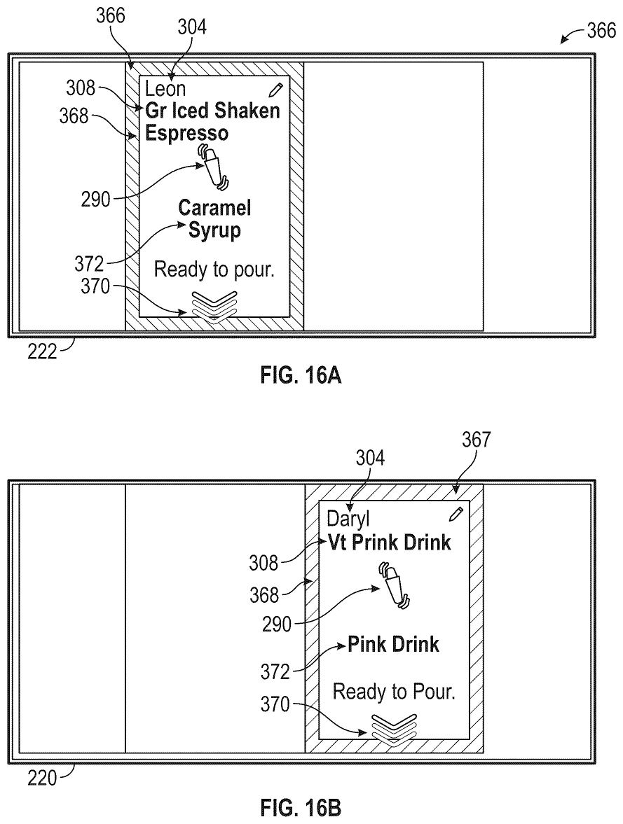

As shown in FIGS. 16A and 16B, a first ingredient graphical user interface 371 associated with beverage orders from the first main display queue can be disposed on one side (e.g., left side) of displays of the substations and a second ingredient graphical user interface 367 associated with beverage orders from the second main display queue can be disposed on the other side (e.g., right side) of displays of the substations, which can avoid user confusion and/or maintain open display space for beverage orders being prepared by the other user.

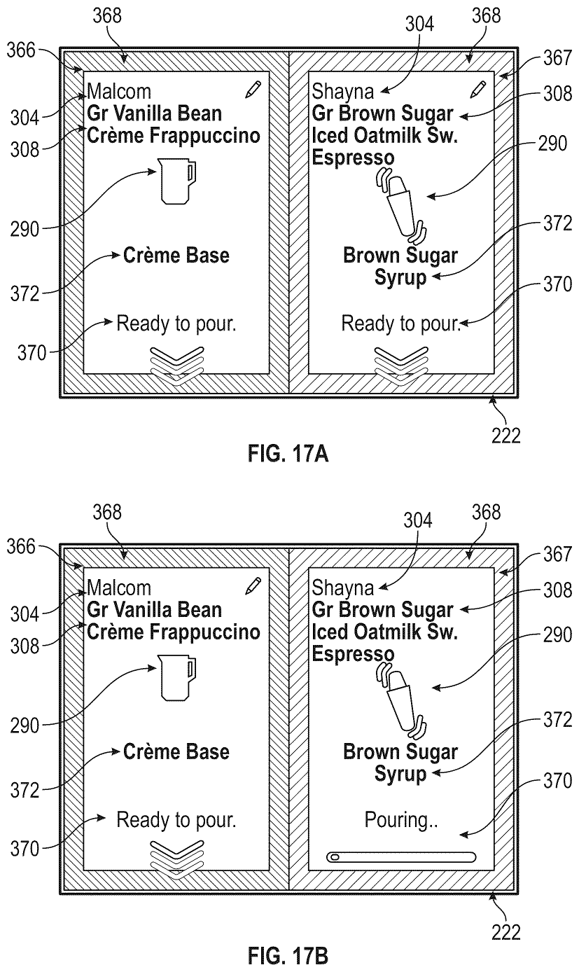

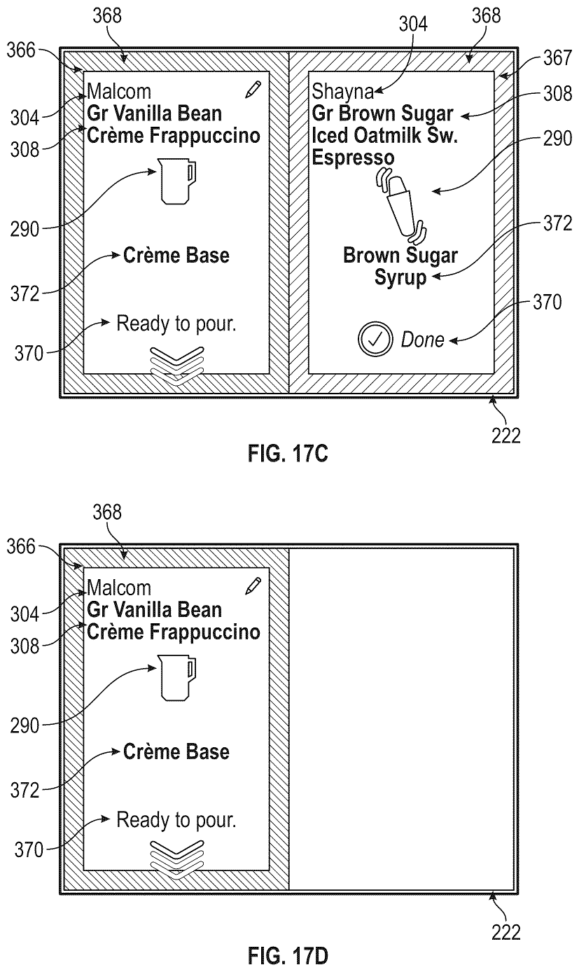

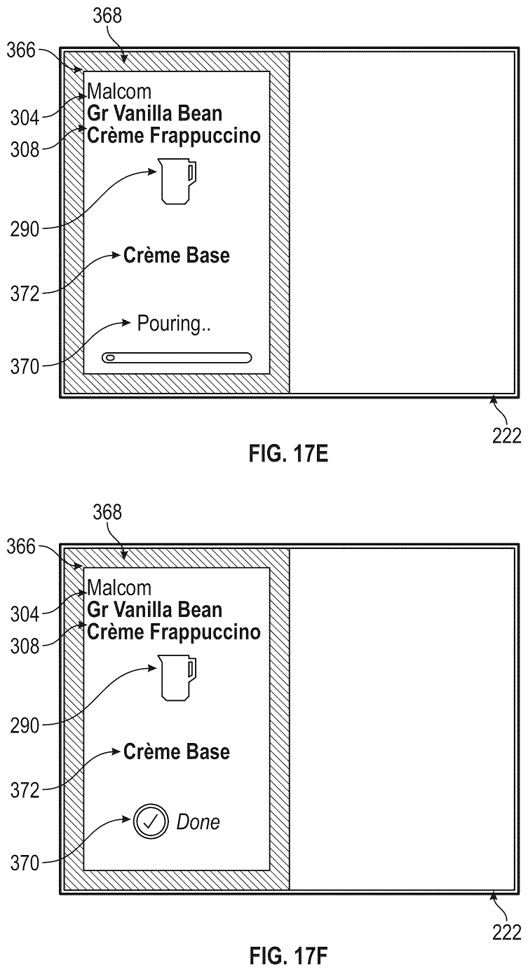

As shown in FIG. 17A, the first ingredient graphical user interface 373 associated with a beverage order from the first main display queue and the second ingredient graphical user interface 367 associated with a beverage order from the second main display queue can be simultaneously displayed on a display of a substation, which can include the first ingredient graphical user interface 373 occupying a left side of the display and the second ingredient graphical user interface 367 occupying a right side of the display. The substation can include one or more interfaces to command the substation to display the ingredients listed on the ingredient name 372 of the first ingredient graphical user interface 373 and second ingredient graphical user interface 367. In some variants, the substation can include two interfaces (e.g., paddles, buttons)-one associated with one side (e.g., the left side, beverage orders from the first main display queue) and another associated with the other side (e.g., right side, beverage orders from the second main display queue) that the users can engage with to dispense the ingredients. In some variants, two ingredients cannot be dispensed at the same time from the same substation. For example, if the crème base associated with the first ingredient graphical user interface 373 is being dispensed, the brown sugar syrup for the second ingredient graphical user interface 367 cannot be dispensed until the crème base has been fulling dispensed. FIGS. 17B, 17C, 17D, 17E, and 17F illustrate the first ingredient graphical user interface 373 and the second ingredient graphical user interface 367 shown on the display 222 as the ingredients are dispensed from substation 210. The second user can engage with the right-side interface (e.g., paddle) of the substation 210 to commence dispensing (e.g., pouring) a second ingredient (e.g., brown sugar syrup) from the substation 210, which the second ingredient graphical user interface 367 can indicate with the substation status indication 370. As shown in FIG. 17C, the substation status indication 370 of the second ingredient graphical user interface 367 can indicate when the substation 210 has finished dispensing the brown sugar syrup. The second ingredient graphical user interface 367 can continue to be shown on the display 222 of the substation 210 with the substation status indication 370 indicating that dispensing is complete for a duration of time (e.g., one, two, three, four, or more seconds) until the second ingredient graphical user interface 367 disappears from the display 222 as shown in FIG. 17D. In some variants, the first user can engage with the left-side interface (e.g., paddle) of the substation 210 to commence dispensing (e.g., pouring) a first ingredient (e.g., crème base) from the substation 210 once dispensing of the brown sugar syrup is complete. In some variants, the crème base cannot be dispensed from the substation 210 until the second ingredient graphical user interface 367 with the substation status indication 370 indicating dispensing is complete has disappeared from the display 222. When the first user engages with the left-side interface (e.g., paddle) of the substation 210 to commence dispensing (e.g., pouring) the crème base from the substation 210, the substation status indication 370 of the first ingredient graphical user interface 373 can indicate that the crème base is being dispensed as illustrated in FIG. 17E. When the substation 210 has finished dispensing the crème base, the substation status indication 370 for the first ingredient graphical user interface 373 can indicate that dispensing is complete as illustrated in FIG. 17F, which can be displayed on the display 222 for a period of time (e.g., one, two, three, four, or more seconds) before disappearing from the display 222.

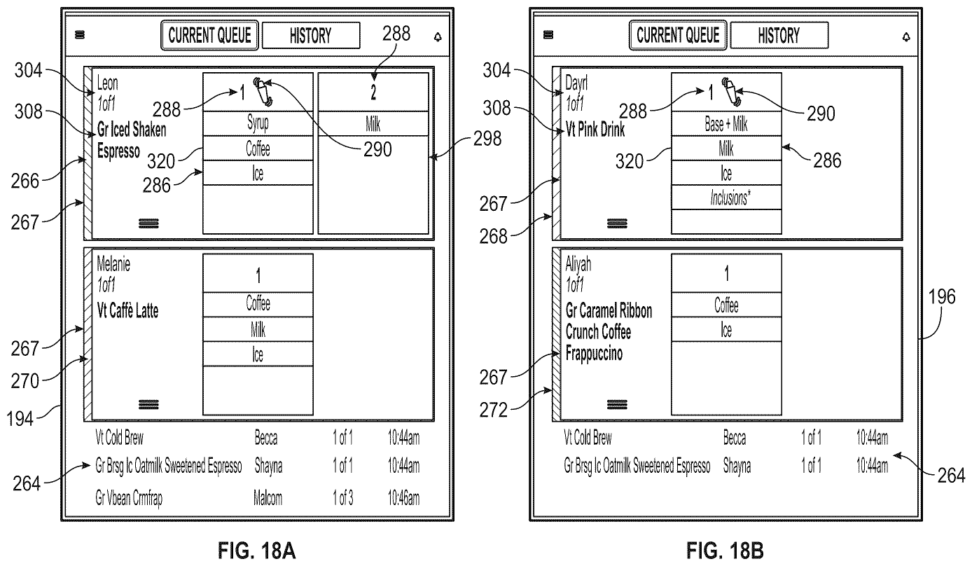

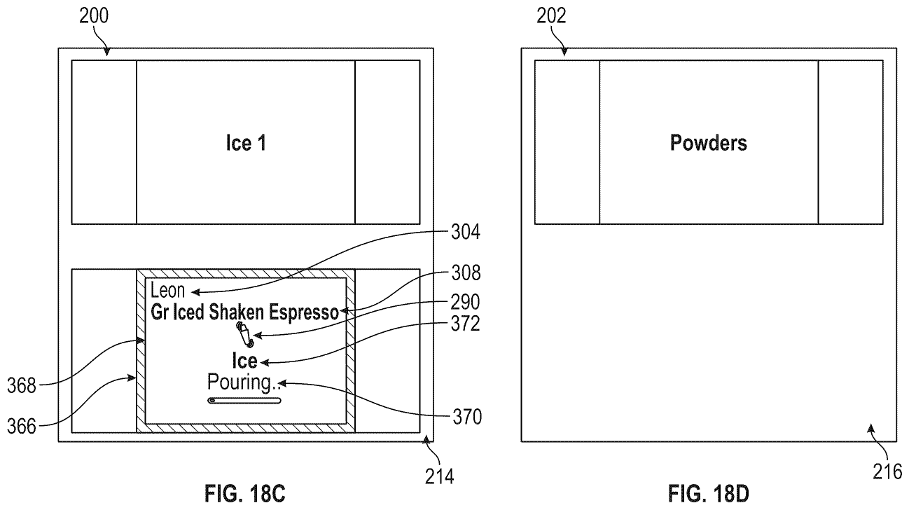

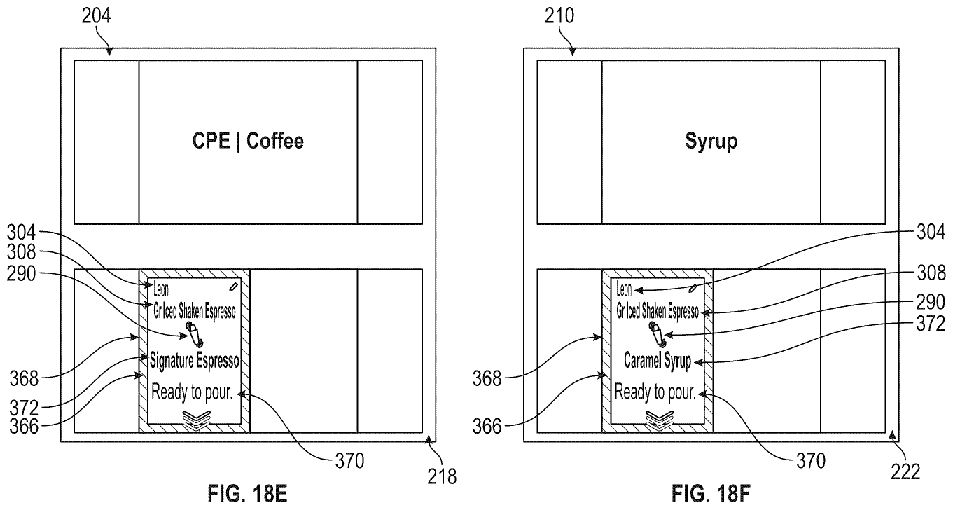

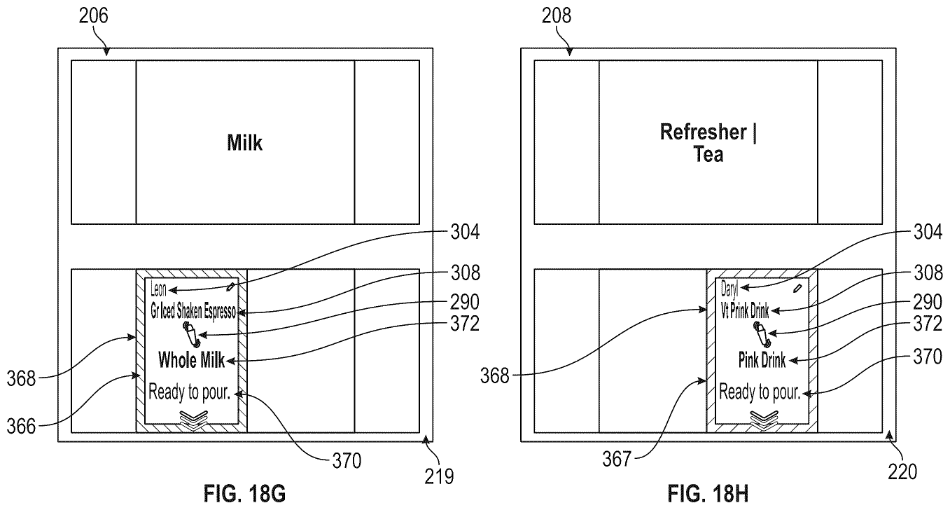

FIGS. 18A and 18B respectfully illustrate the graphical user interface 194 displayed on the first main display 193 and the graphical user interface 196 displayed on the second main display 195. The graphical user interface 194 shows a first beverage order 266 with a visual order identifier 267, first build step set 286 that is indicated as active by the active indication 320, and a second build step set 298. The first build step set 286 includes three dispense build steps for three ingredients (syrup, coffee, and ice) associated with a shaker action as denoted by the action icon 290 of a shaker. The second build step set 298 includes one dispense build step for one ingredient (milk). The build step instructions for the first beverage order 266 have been sent to the relevant substations, including the substation 200, the substation 204, the substation 210, and/or the substation 206, as illustrated in FIGS. 18C, 18D, 18E, 18F, 18G, 18H, and 18I. The display 214, the display 218, the display 222, and/or the display 219 for the substation 200, the substation 204, the substation 210, and/or the substation 206 can show a first ingredient graphical user interface 377 that indicates instructions and/or other information for the first user to perform the build steps, as described herein, to build the recipe for the first beverage order 266. In some variants, the display 214, the display 218, the display 222, and/or the display 219 can simultaneously and/or sequentially show a first ingredient graphical user interface 377 that displays instructions and/or other information for the first user to perform the build steps. The first ingredient graphical user interface 377 can include a visual order identifier 368 (e.g., same color border) that corresponds to the visual order identifier 267 of the first beverage order 266 displayed on the graphical user interface 194 of the first main display 193.

Similarly, the graphical user interface 196 can show a second beverage order 268 with a visual order identifier 267 and a first build step set 286 that is indicated as active by the active indication 320 as shown in FIG. 18B. The first build step set 286 can include one or more build steps, which can be associated with an action (e.g., shaker action). The build instructions for the second beverage order 268 can be sent to the relevant build stations. The displays for the relevant build stations can show a second ingredient graphical user interface 367, as shown in FIGS. 18C, 18D, 18E, 18F, 18G, 18H, and 18I, that indicate instructions and/or other information for the second user to perform the build steps, as described herein, to build the recipe for the second beverage order 268. In some variants, the displays of the relevant substations can simultaneously and/or sequentially show a second ingredient graphical user interface 367 that display instructions and/or other information for the second user to perform the build steps. The second ingredient graphical user interface 367 can include a visual order identifier 368 (e.g., same color border) that corresponds to the visual order identifier 267 of the second beverage order 268 displayed on the graphical user interface 196 of the second main display 195, which can help differentiate the build steps for the first beverage order 266 and second beverage order 268.

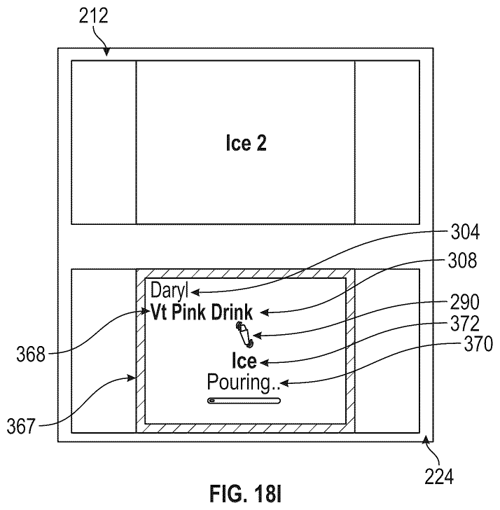

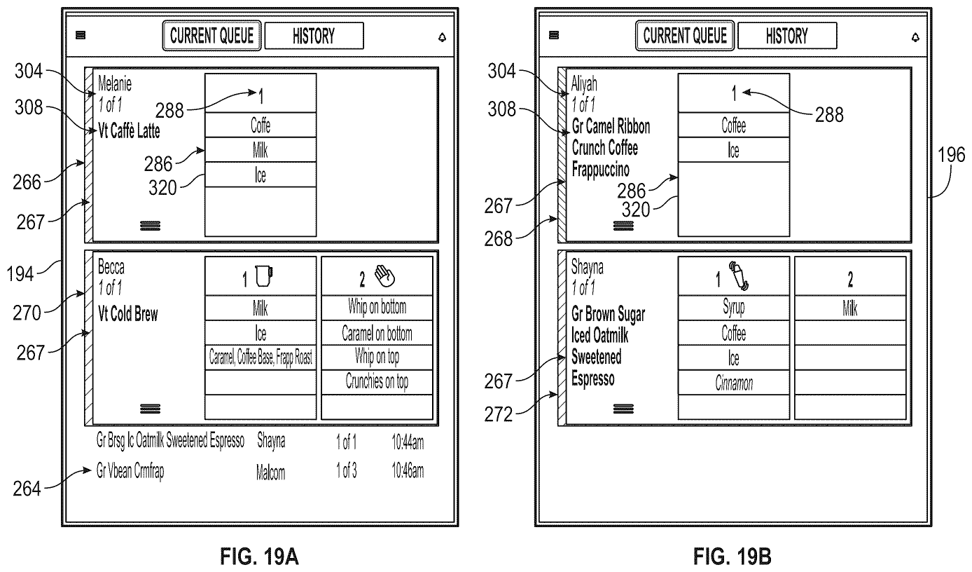

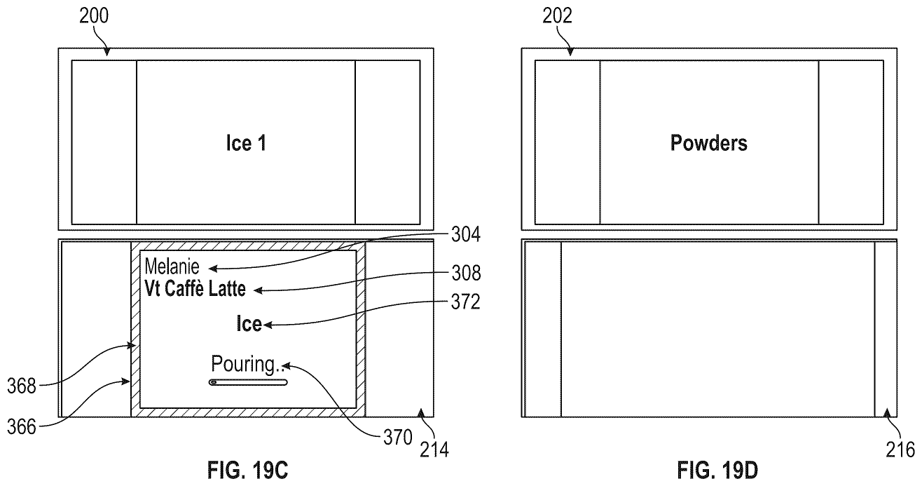

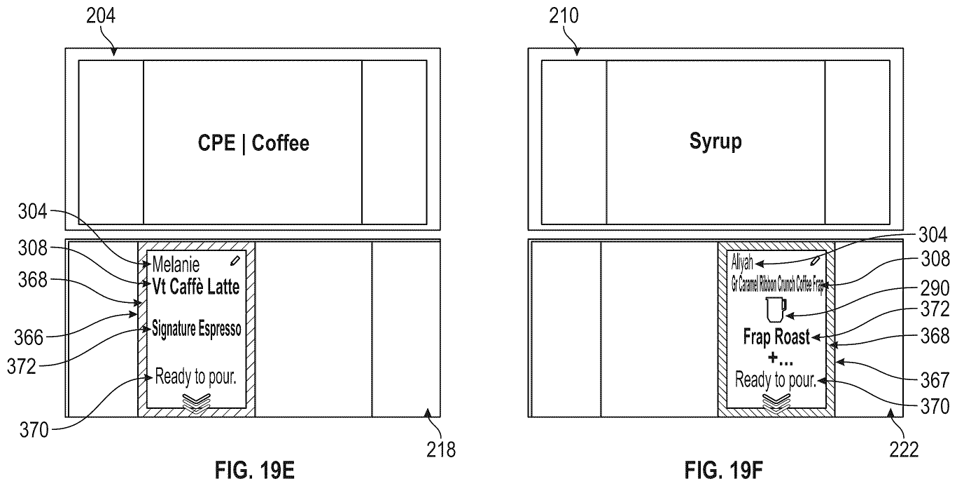

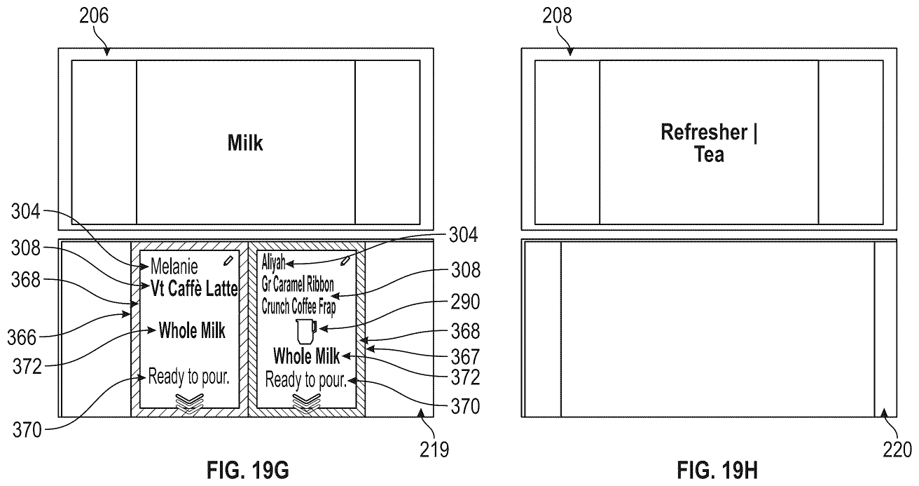

Similar to FIGS. 18A and 18B, FIGS. 19A and 19B illustrate the graphical user interface 194 displayed on the first main display 193 and the graphical user interface 196 displayed on the second main display 195. The graphical user interface 194 shows a first beverage order 266 with a visual order identifier 267 and a first build step set 286 that is indicated as active by the active indication 320. Similarly, the graphical user interface 196 shows a second beverage order 268 with a visual order identifier 267 and a first build step set 286 that is indicated as active by the active indication 320. All or a portion of the build steps for the first build step set 286 of the first beverage order 266 and the first build step set 286 of the second beverage order 268 can be sent to the relevant build stations. The displays for the relevant build stations can show a first ingredient graphical user interface 379 and a second ingredient graphical user interface 367, as shown in FIG. 19C, FIG. 19D, FIG. 19E, FIG. 19F, FIG. 19G, FIG. 19H, and FIG. 19I, that indicate instructions and/or other information for the first and second users to perform the build steps, as described herein, to build the recipes for the first beverage order 266 and second beverage order 268. The first ingredient graphical user interface 379 can include a visual order identifier 368 that corresponds to the visual order identifier 267 of the first beverage order 266. The second ingredient graphical user interface 367 can include a visual order identifier 368 that corresponds to the visual order identifier 267 of the second beverage order 268.

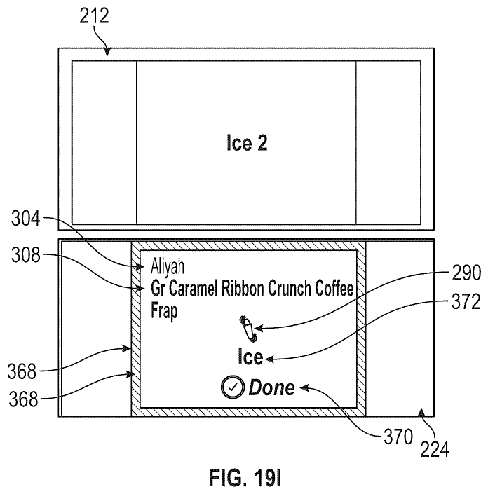

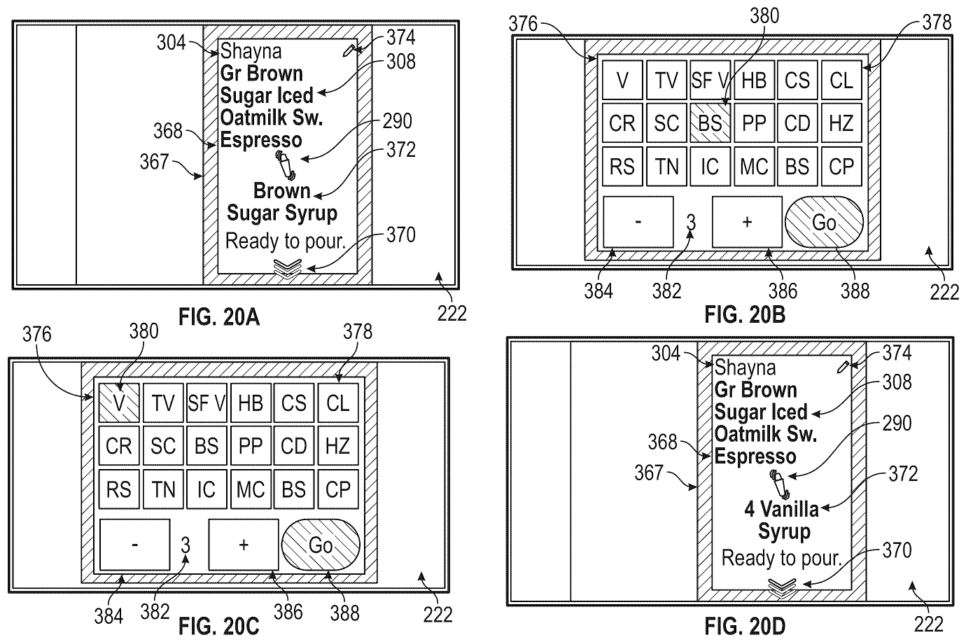

FIGS. 20A, 20B, 20C, and 20D illustrate how ingredients for an order can be edited at a substation. FIG. 20A shows a second ingredient graphical user interface 367 displayed on the display 222. The second ingredient graphical user interface 367 can include a button 374 (e.g., clickable visual element), which can be in the shape of a pencil icon, that a user can interact with (e.g., tap) to access an ingredient selection graphical user interface 376 as shown in FIG. 20B. The ingredient selection graphical user interface 376 can include ingredient options 378 for the corresponding substation. For example, the ingredient selection graphical user interface 376 shown in FIG. 20B shows syrup options, which includes the selected ingredient 380 (e.g., a currently selected ingredient of brown sugar syrup which is abbreviated to “BS”). The names of the ingredients can be abbreviated (e.g., abbreviated to two letters or less) for space. The selected ingredient 380 can be shown as selected based on color and/or other visual features that differ from the remainder of the ingredient options. A user can select a different ingredient by tapping on the ingredient, which can change the selected ingredient 380 to the tapped ingredient (e.g., vanilla syrup) as illustrated in FIG. 20C. The quantity of the selected ingredient 380 to be dispensed can be indicated by a quantity indication 382 (e.g., number, number indicating pumps). The quantity of the selected ingredient 380 to be dispensed can be altered using the decrease button 384 and the increase button 386 (e.g., clickable visual elements). When the desired ingredient edits have been made, the user can interact with (e.g., tap) the button 388 to return to the second ingredient graphical user interface 367 which reflects the edits made (e.g., change from brown sugar syrup to four pumps of vanilla syrup) as illustrated in FIG. 20D.

As described herein, the beverage preparation system described herein can allocate and/or order beverage orders from a master queue to first and second main display queues using various criteria. For example, in some variants, the beverage preparation system can allocate beverage orders based on receipt time, capacity of the first and second main display queues, and/or others. In some variants, the beverage preparation system (e.g., controller) can allocate and/or order beverage orders based on the type of beverage orders.

For example, blended beverage orders can take significant time, and the blending machine can be a bottle neck that slows down beverage order production. While a first beverage order is being blended, a second beverage order may wait to be blended if placed sequentially next in a queue. Accordingly, in some variants, the beverage preparation system can position a non-blended beverage order between blended beverage orders on the first and second main display queues to avoid a bottle neck at the blending machine. In some variants, the beverage preparation system can allocate blended beverage orders between the first and second main display queues based on a blender machine availability, which can include projected availability, for the blenders associated with the first and second main display queues. In some variants, the beverage preparation system can allocate blended beverage orders between the first and second main display queues to avoid sequentially ordering two blended beverage orders next to each other on a queue. In some variants, the beverage preparation system can allocate blended beverage orders evenly between the first and second main display queues to avoid one of the queues receiving more than the other. In some variants, the beverage preparation system can alternatingly allocate blended beverage orders between the first and second main display queues.

In some variants, the beverage preparation system can allocate beverage orders between the first and second main display queues based on an estimated build time for the beverage order. For example, some beverage orders take significantly more time to prepare; accordingly, it can be desirable to avoid allocating these time intensive beverage orders disproportionately to one of the first and second main display queues. In some variants, the beverage preparation system can alternately allocate beverage orders with an estimated build time above a threshold between the first and second main display queues.

In some variants, the beverage preparation system can allocate beverage orders between the first and second main display queues based on the number of build steps associated with the beverage order. For example, some beverage orders have significantly more build steps than others; accordingly, it can be desirable to avoid allocating these build-step intensive beverage orders disproportionately to one of the first and second main display queues. In some variants, the beverage preparation system can alternatingly allocate beverage orders with a number of build steps above a threshold between the first and second main display queues.

In some variants, the beverage preparation system can allocate beverage orders between the first and second main display queues based on one or more characteristics of a first user associated with the first main display queue and/or a second user associated with the second main display queue. The one or more characteristics can include a user's experience with preparing one or more beverages. For example, if a first user has more experience making a beverage type (e.g., blended Frappuccino) than a second user, the beverage preparation system can allocate more or all of that beverage type to the first user. The one or more characteristics can include a user's preferences. For example, if a second user dislikes preparing a beverage type (e.g., blended Frappuccino), the beverage preparation system can allocate more or all of that beverage type to the first user. The one or more characteristics can include a user's performance history. For example, if a first user has a history of producing beverages of a certain type (e.g., blended Frappuccino) at a faster production speed and/or with less remake requests than a second user, the beverage preparation system can allocate more or all of that beverage type to the first user. The one or more characteristics can include a user's abilities (e.g., physical abilities). For example, if a first user is unable to perform an action (e.g., shake a bottle), the beverage preparation system can allocate all of that beverage type to the second user.

In some variants, multiple beverages on the first or second main display queues can be built simultaneously. For example, in some variants, the first and/or the second main display queues can include two, three, four, five, or more beverage orders to be prepared. The user can select multiple beverage orders from one of the first or second main display queues to cause the beverage preparation system to send build step instructions to substations to build the selected beverage orders.

In some variants, the beverage preparation system can allow and/or prompt a user to begin preparing a second beverage order when a first beverage order is being blended. For example, when the beverage preparation system receives an indication that a build set associated with a blending action has been completed (e.g., ingredients to be blended have been dispensed), the beverage preparation system can allow and/or prompt the user to begin preparing a second beverage order, which can avoid wasteful down time. The user can select the second beverage order to prompt the beverage preparation system to send build step instructions to the substations to build the second beverage order.

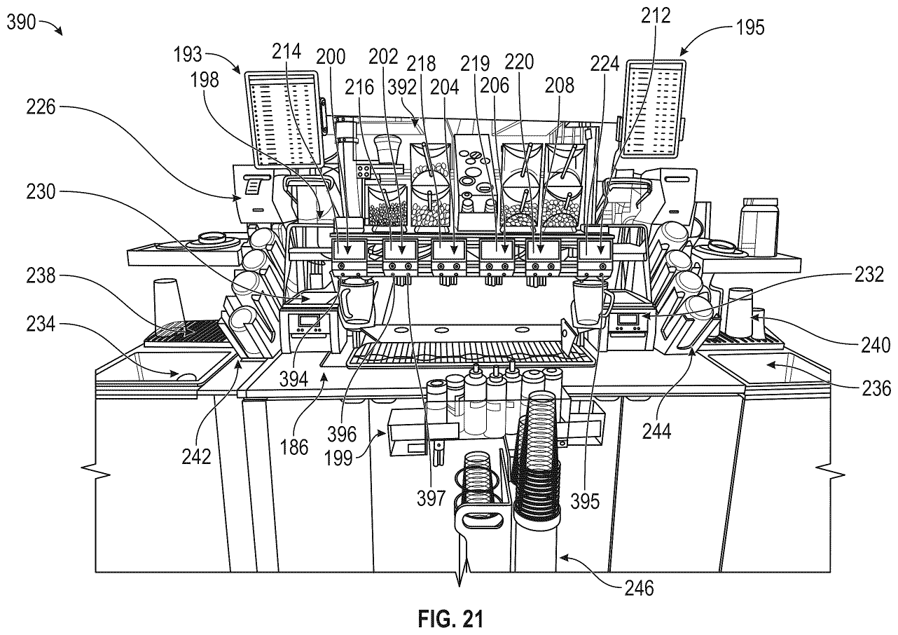

FIG. 21 illustrates an example beverage preparation station 390. The beverage preparation station 390 can be configured for two users simultaneously (e.g., in parallel) preparing different beverage orders pulled from the master queue. The beverage preparation station 390 can enable a first user to pause allocation of orders from the master queue to the first main display queue for the first user, which can still permit orders to continue to be allocated from the master queue to the second main display queue for the second user as the second user completes orders. The beverage preparation station 390 can enable a second user to pause allocation of orders from the master queue to the second main display queue for the second user, which can still permit orders to continue to be allocated from the master queue to the first main display queue for a first user as the first user completes orders. In some variants, the beverage preparation station 390 can enable the first and second users to independently pause allocation of orders from the master queue to the first main display queue and second main display queue, respectively. The beverage preparation station 184 can include any of the features of the beverage preparation station 184 and/or the beverage preparation station 185.

The dispense system 198, as illustrated in FIG. 21, can include a plurality of substations, which can at least include the substation 200, the substation 202, the substation 204, the substation 206, the substation 208, the substation 212, and/or others. All or a portion of the substation 200, the substation 202, the substation 204, the substation 206, the substation 208, and/or the substation 212 can include a display. For example, the substation 200 can include the display 214, the substation 202 can include the display 216, the substation 204 can include the display 218, the substation 206 can include the display 219, the substation 208 can include the display 220, and/or the substation 212 can include the display 224. All or a portion of the substation 200, the substation 202, the substation 204, the substation 206, the substation 208, and/or the substation 212 can dispense (e.g., pour) one or more ingredients. For example, one or more of the substation 200, the substation 202, the substation 204, the substation 206, the substation 208, and/or the substation 212 can dispense a plurality of ingredients of a certain type such as syrups, coffee products, and/or others. As described herein, the substation 200, the substation 202, the substation 204, the substation 206, the substation 208, and/or the substation 212 can be arranged in a row. The substation 200 and the substation 212 can be disposed at opposite ends of the row. The substation 200 and the substation 212 can be configured to dispense ice. The substation 200 can be associated with the first main display 193 such that the first user and not the second user dispenses ice at the substation 200. For example, orders selected for preparation by the first user can be displayed on the first main display 193 and ice for those orders can be dispensed at the substation 200, which can include the controller sending commands to the substation 200 for ice dispensing for orders selected for preparation by the first user. The substation 200 can have a user interface 394 (e.g., button, toggle, switch, etc.) with which the first user can interface to command the substation 200 to dispense. The user interface 394 can be disposed on a side (e.g., left side) of the substation 200. The substation 212 can be associated with the second main display 195 such that the second user and not the first user dispenses ice at the substation 212. For example, orders selected for preparation by the second user can be displayed on the second main display 195 and ice for those orders can be dispensed at the substation 212, which can include the controller sending commands to the substation 212 for ice dispensing for orders selected for preparation by the second user. The substation 212 can have a user interface 395 (e.g., button, toggle, switch, etc.) with which the second user can interface to command the substation 212 to dispense. The user interface 395 can be disposed on a side (e.g., right side) of the substation 212.

All or a portion of the substation 202, the substation 204, the substation 206, and/or the substation 208, which can be referred to as the shared substations, can be associated with both the first main display 193 and the second main display 195. For example, ingredients for orders selected for preparation by the first user or the second user can be dispensed at the substation 202, the substation 204, the substation 206, and/or the substation 208, which can include the controller sending commands to the substation 202, the substation 204, the substation 206, and/or the substation 208 for dispensing ingredients for orders selected for preparation by the first user or the second user. All or a portion of the substation 202, the substation 204, the substation 206, and/or the substation 208 can include two user interfaces (e.g., buttons, toggles, switches, etc.) which can include having a user interface 396 for the first user and a user interface 397 for the second user. Having distinct user interfaces for the first and second users can avoid the first user erroneously performing a build step (e.g., dispensing an ingredient) for an order being prepared by the second user or the second user erroneously performing a build step (e.g., dispensing an ingredient) for an order being prepared by the first user, especially when the display associated with the substation is simultaneously displaying build steps (e.g., ingredients to be dispensed) for two orders. The user interface 396 and the user interface 397 can be disposed on opposite sides, which can include the user interface 396 being disposed on the left side and the user interface 397 being disposed on the right side.

The beverage preparation station 390 can include an add-in station 392 (e.g., topping station). The add-in station 392 can be disposed above the dispense system 198, which can include being disposed on a shelf above the dispense system 198. The add-in station 392 can include a plurality of containers that can hold ingredients to be manually added to (e.g., scooped into) a beverage.

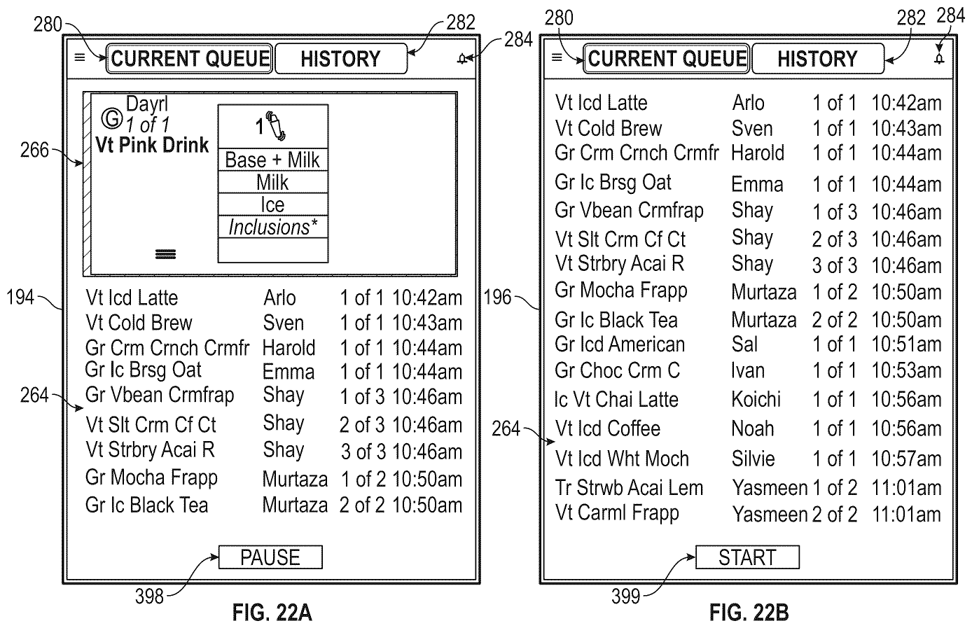

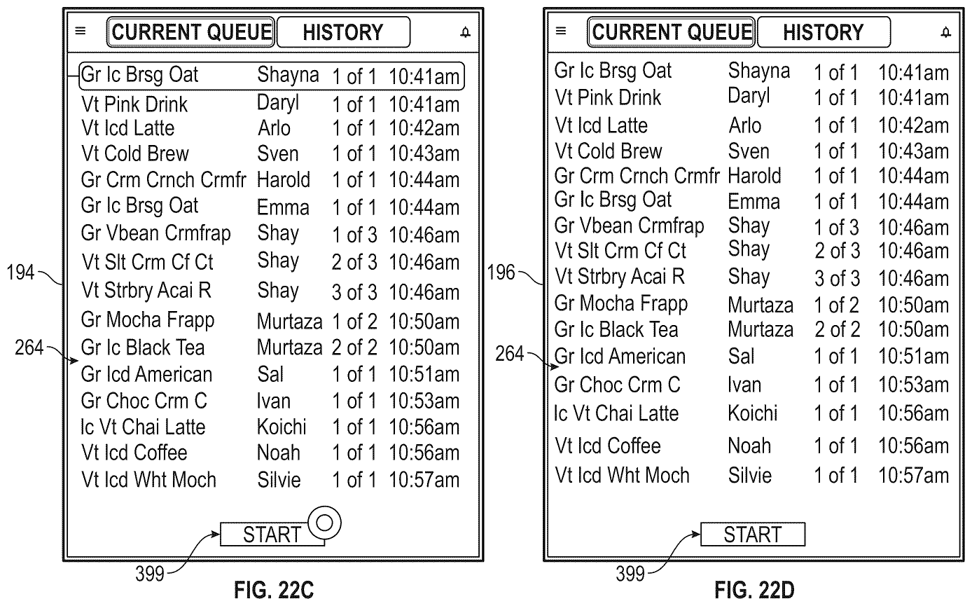

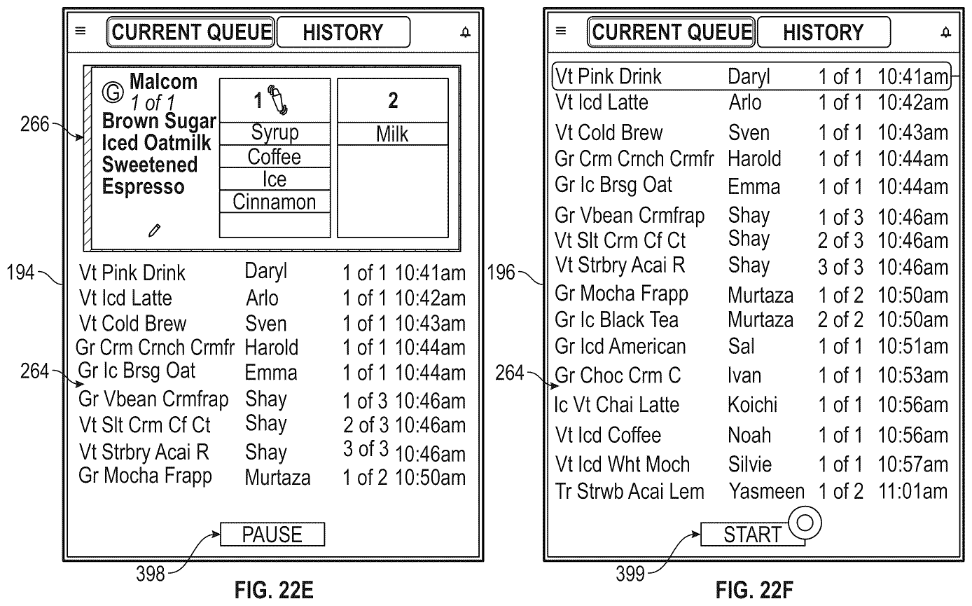

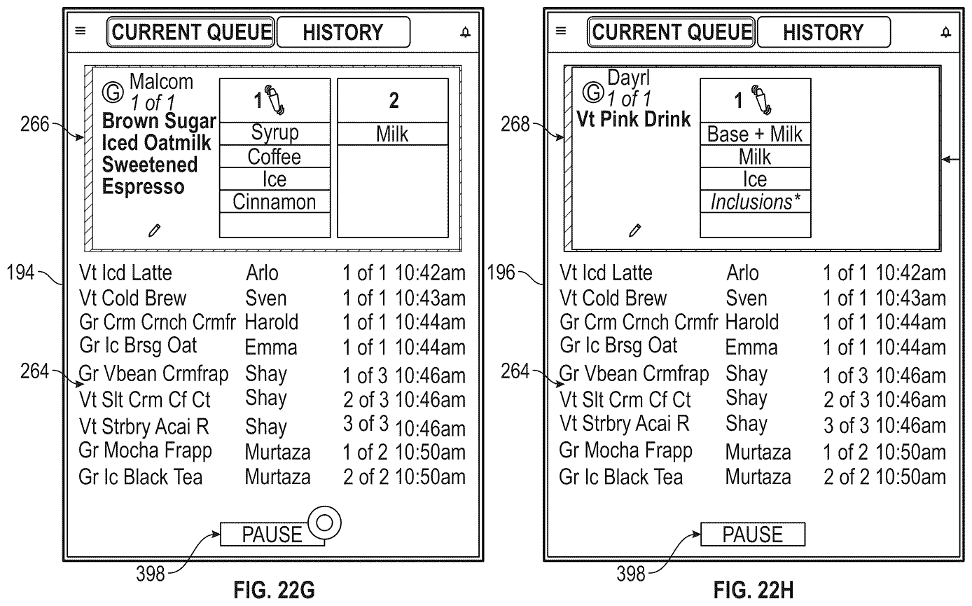

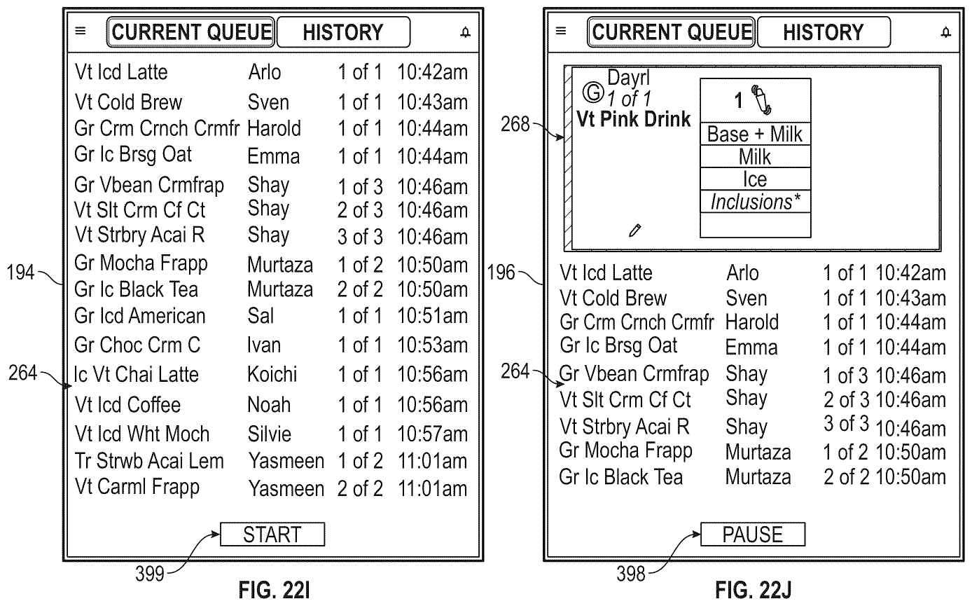

FIG. 22A illustrates an example graphical user interface 194 for the first main display 193 at a first instance. FIG. 22B illustrates an example graphical user interface for the second main display 195 at the first instance. As illustrated in FIGS. 22A and 22B, the same master queue (e.g., the master queue 264 or a portion thereof) can be displayed on both the graphical user interface 194 and graphical user interface 196. As described herein, orders on the master queue 264 can be allocated to a first main display queue associated with the first user and/or a second main display queue associated with the second user. Orders can be allocated to the first main display queue and the second main display queue using any of the criteria and/or processes described herein. In some variants, the first main display queue can include no more than one order for active preparation and the second main display queue can include no more than one order for active preparation.

FIG. 22A illustrates the graphical user interface 194 for the first main display 193 in an active state. The active state can correspond to when the first user is actively preparing and/or receiving beverage orders. FIG. 22A shows a first beverage order 266 that has been allocated from the master queue 264 to the first main display queue for detailed display (e.g., build step sets, build steps, actions associated with build step sets, etc.) on the graphical user interface 194 as described herein. The first beverage order 266 is an active beverage order (e.g., currently being prepared by the first user, one or more build steps are being performed at a substation, one or more build steps are pending performance at a substation). When the first user completes the first beverage order 266, a next beverage order from the master queue 264 will be added to the first main display queue for detailed display on the graphical user interface 194 and build step instruction(s) for the next beverage order can be sent to the relevant substations for beverage preparation. As illustrated in FIG. 22A, the graphical user interface 194 in the active state can include a pause button 398 (e.g., clickable visual element). The first user can interact with (e.g., press, touch) the pause button 398 to pause allocation of beverage orders from the master queue 264 to the first main display queue (e.g., pause assignment of beverage orders to the first user), which can be referred to as the inactive state (e.g., paused state). The first user can complete a beverage order currently being prepared, and upon completion, the beverage preparation system will not allocate another beverage order from the master queue 264 to the first main display queue in the inactive state. If the second user has not initiated the inactive state, the beverage preparation system can continue to allocate beverage orders from the master queue 264 to the second main display queue for detailed display on the graphical user interface 196 as the second user completes beverage orders. The first user can pause allocation of beverage orders to the first main display queue as needed (e.g., when completing a shift, attend to another task, take a break, change first users, etc.) and resume allocation of beverage orders to the first main display queue when desired.

FIG. 22B illustrates the graphical user interface 196 for the second main display 195 in an inactive state (e.g., paused state). The inactive state can correspond to when the second user is not receiving beverage orders to prepare. A user can elect the inactive state by interacting with the pause button 398. In the inactive state, the graphical user interface 196 can display the master queue 264 of the graphical user interface 196. In the inactive state, the graphical user interface 196 may, in some variants, not display a beverage order as being actively prepared. In some variants, the graphical user interface 196 can display a beverage order actively being prepared, but upon completion of said beverage order, the graphical user interface 196 may not display another beverage order as being actively prepared until the second user elects the active state. The second user can elect the active state by interacting with (e.g., pressing, touching) a start button 399 (e.g., clickable visual element) that is displayed via the graphical user interface 196 while in the inactive state to assume the active state to permit the allocation of orders from the master queue 264 to the second main display queue for preparation by the second user.

As orders are allocated from the master queue 264 to the first main display queue and/or the second main display queue, the master queue 264 displayed on both the graphical user interface 194 and graphical user interface 196 can be updated. For example, an order on the master queue 264 can be removed from the master queue 264 displayed on both the graphical user interface 194 and graphical user interface 196 when allocated to one of the first and the second main display queues, which can enable the first and second users to visually monitor the master queue 264 in real time.

FIGS. 22C and 22D respectively illustrate the graphical user interface 194 in an inactive state and the graphical user interface 196 in an inactive state. In the inactive state, the graphical user interface 194 and graphical user interface 196 display the same master queue (e.g., the master queue 264) but orders are not allocated from the master queue 264 to the first and the second main display queues. In the inactive state, the graphical user interface 194 and/or the graphical user interface 196 may display a start button 399, providing users the option to elect the active state to begin allocating orders to one of the graphical user interface 194 and graphical user interface 196.

In use, the first user can interact with the start button 399 of the graphical user interface 194 to elect the active state and begin beverage order allocation from the master queue 264 to the first main display queue. FIG. 22E illustrates the graphical user interface 194 in the active state with a first beverage order 266 allocated to the first main display queue, which can be a queue with a capacity for a single order at a time. With the first beverage order 266 allocated from the master queue 264 to the first main display queue, the master queue 264 displayed on the graphical user interface 194 and the graphical user interface 196 can be updated to remove the first beverage order 266 as illustrated in FIGS. 22E and 22F, which can enable the first and second users to visually monitor the master queue 264 in real time as orders are allocated. Detailed information (e.g., status, build step(s), build step set(s), action(s), etc.) regarding the first beverage order 266 can be displayed by the graphical user interface 194. Once allocated to the first main display queue, build step instructions for the first beverage order 266 can be sent to the relevant substations to build the first beverage order 266 as described herein. The substations can communicate status information for a build step to the controller which can update the status of the first beverage order 266 on the graphical user interface 194, which can include the status of a build step, build step set, and/or other information.

The second user can interact with the start button 399 of the graphical user interface 196 shown in FIG. 22F to elect the active state and begin beverage order allocation from the master queue 264 to the second main display queue as illustrated in FIG. 22H. FIG. 22H illustrates the graphical user interface 196 in the active state with a second beverage order 268 allocated to the second main display queue, which can be a queue with a capacity for a single order at a time. With the second beverage order 268 allocated from the master queue 264 to the second main display queue, the master queue 264 displayed on the graphical user interface 194 and the graphical user interface 196 can be updated to remove the second beverage order 268 as illustrated in FIGS. 22G and 22H, which can enable the first and second users to visually monitor the master queue 264 in real time as orders are allocated. Detailed information (e.g., status, build step(s), build step set(s), action(s), etc.) regarding the second beverage order 268 can be displayed by the graphical user interface 196. Once allocated to the second main display queue, build step instructions for the second beverage order 268 can be sent to the relevant substations to build the second beverage order 268 as described herein. The substations can communicate status information for a build step to the controller which can update the status of the second beverage order 268 on the graphical user interface 196, which can include the status of a build step, build step set, and/or other information.

With the graphical user interface 194 and graphical user interface 196 in active states, the beverage preparation system can allocate beverage orders from the master queue 264 to the first and second main display queues as beverage orders are completed and update the master queue 264 displayed on the graphical user interface 194 and graphical user interface 196. The graphical user interface 194 and/or the graphical user interface 196 can display the pause button 398 in the active states, which can enable a user to pause additional allocation of beverage orders to the first main display queue or the second main display queue. For example, the first user can interact with the pause button 398 of the graphical user interface 194 to elect the inactive state illustrated in FIG. 22I to pause allocate of beverage orders to the first main display queue. In some variants, the first user can complete the first beverage order 266, and upon completion, no additional beverage orders are allocated from the master queue 264 to the first main display queue in the inactive state. With the graphical user interface 194 in the inactive state as illustrated in FIG. 22I but the graphical user interface 196 in the active state as illustrated in FIG. 22J, orders can continue to be allocated to the second main display queue from the master queue 264 for preparation.

It will be understood that the beverage preparation system (or a separate component) may cause display of the graphical user interfaces discussed herein. Further, the beverage preparation system may provide outputs (e.g., alerts), receive inputs, provide operability, etc. via the graphical user interfaces.

### Certain Terminology

Beverage order, as used herein, can be replaced with object herein. Object can be replaced with beverage order herein. As used herein, the term “beverage” has its ordinary and customary meaning, and includes, among other things, any edible liquid or substantially liquid substance or product having a flowing quality (e.g., juices, coffee beverages, teas, milk, beer, wine, cocktails, liqueurs, spirits, cider, soft drinks, flavored water, energy drinks, soups, broths, combinations of the same, or the like). In some cases, the term “object” may include a beverage associated with a drink order, a food item associated with a food order, etc.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

The terms “approximately,” “about,” and “substantially” as used herein represent an amount close to the stated amount that still performs a desired function or achieves a desired result. For example, in some embodiments, as the context may dictate, the terms “approximately,” “about,” and “substantially” may refer to an amount that is within less than or equal to 10% of the stated amount. Numbers preceded by a term such as “about” or “approximately” include the recited numbers and should be interpreted based on the circumstances (e.g., as accurate as reasonably possible under the circumstances, for example. For example, “about 1 gram” includes “1 gram.” In the embodiments described in this application, terms such as “about” or “approximately” within the specification or claims that precede values or ranges can be omitted such that this application specifically includes embodiments of the recited values or ranges with the terms “about” or “approximately” omitted from such values and ranges such that they can also be claimed without the terms “about” or “approximately” before the disclosed range. The term “generally” as used herein represents a value, amount, or characteristic that predominantly includes, or tends toward, a particular value, amount, or characteristic. As an example, in certain embodiments, as the context may dictate, the term “generally parallel” can refer to something that departs from exactly parallel by less than or equal to 20 degrees and/or the term “generally perpendicular” can refer to something that departs from exactly perpendicular by less than or equal to 20 degrees.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

The following example embodiments identify some possible permutations of combinations of features disclosed herein, although other permutations of combinations of features are also possible.

Although certain aspects, advantages, and features are described herein, it is not necessary that any particular embodiment include or achieve any or all of those aspects, advantages, and features. For example, some embodiments may not achieve the advantages described herein, but may achieve other advantages instead. Any structure, feature, or step in any embodiment can be used in place of, or in addition to, any structure, feature, or step in any other embodiment, or omitted. This disclosure contemplates all combinations of features from the various disclosed embodiments. No feature, structure, or step is essential or indispensable. In addition, although this disclosure describes certain embodiments and examples of beverage systems and methods, many aspects of the above-described systems and methods may be combined differently and/or modified to form still further embodiments or acceptable examples. All such modifications and variations are intended to be included herein within the scope of this disclosure.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Some embodiments have been described in connection with the accompanying drawings. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Also, any methods described herein may be practiced using any device suitable for performing the recited steps.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of beverage dispensing systems and methods have been disclosed. Although the systems and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

What is claimed is:

1. A computing system for dynamically allocating objects between first and second queues, the computing system comprising:
one or more processors; and
a computer-readable storage medium storing computer-readable instructions that, when executed by the one or more processors, cause the one or more processors
identify one or more objects;
add the one or more objects to a master queue;
allocate the one or more objects from the master queue to one or more of a first main display queue or a second main display queue until one or more capacities of the first main display queue and the second main display queue are reached;
determine that a build step of a first object of the first main display queue is complete;
in response to determining that the build step of the first object of the first main display queue is complete, add a second object from the master queue to the first main display queue;
determine that a build step of a third object of the second main display queue is complete;
in response to determining that the build step of the third object of the second main display queue is complete, add a fourth object from the master queue to the second main display queue;
cause display, via one or more first main displays, of a first graphical user interface with one or more objects from the first main display queue; and
cause display, via one or more second main displays, of a second graphical user interface with one or more objects from the second main display queue.

2. The computing system of claim 1, wherein execution of the computer-readable instructions by the one or more processors, further causes the one or more processors to:
dynamically generate computer-executable build instructions for building the one or more objects from the first main display queue and the one or more objects from the second main display queue;
group portions of the computer-executable build instructions into build sets based on one or more actions for building the one or more objects from the first main display queue and the one or more objects from the second main display queue; and
cause display, via the one or more first main displays or the one or more second main displays, of the build sets.

3. The computing system of claim 2, wherein execution of the computer-readable instructions by the one or more processors, further causes the one or more processors to:
identify one or more substations, each of the one or more substations corresponding to a respective portion of the computer-executable build instructions; and
for each respective portion of the computer-executable build instructions:
transmit the respective portion of the computer-executable build instructions to a corresponding substation of the one or more substations, wherein the corresponding substation executes the respective portion of the computer-executable build instructions, wherein executing the respective portion of the computer-executable build instructions causes the corresponding substation to perform a respective build step of a respective object of the one or more objects from the first main display queue and the one or more objects from the second main display queue; and
cause display, via one or more displays of the one or more substations, of the respective build step.

4. The computing system of claim 3, wherein execution of the computer-readable instructions by the one or more processors, further causes the one or more processors to:
cause simultaneous display, via a display of the one or more displays of the one or more substations, of build steps of two objects of the one or more objects from the first main display queue and the one or more objects from the second main display queue.

5. The computing system of claim 3, wherein execution of the computer-readable instructions by the one or more processors, further causes the one or more processors to:
cause display, via the one or more first main displays, for each of the one or more objects from the first main display queue, of a first main visual identifier;
cause display, via the one or more second main displays, for each of the one or more objects from the second main display queue, of a second main visual identifier; and
cause display, via the one or more displays of the one or more substations, of a substation visual identifier visually corresponding to the first main visual identifier or the second main visual identifier.

6. The computing system of claim 5, wherein the substation visual identifier shares a color with the first main visual identifier or the second main visual identifier.

7. The computing system of claim 3, wherein execution of the computer-readable instructions by the one or more processors, further causes the one or more processors to:
for each respective portion of the computer-executable build instructions, cause display, via the one or more displays of the one or more substations, of a respective status of the respective build step.

8. The computing system of claim 7, wherein, for each respective portion of the computer-executable build instructions, the respective status of the respective build step comprises a ready to perform status, a performing status, or a complete status.

9. The computing system of claim 3, wherein, for each respective portion of the computer-executable build instructions, the respective build step comprises dispensing an ingredient.

10. The computing system of claim 2, wherein execution of the computer-readable instructions by the one or more processors, further causes the one or more processors to:
cause display, via the one or more first main displays, of an indication that one or more build sets of the one or more objects from the first main display queue are active, inactive, or complete; and
cause display, via the one or more second main displays, of an indication that one or more build sets of the one or more objects from the second main display queue are active, inactive, or complete.

11. A computing system for dynamically allocating objects between first and second queues, the computing system comprising:
one or more processors; and
a computer-readable storage medium storing computer-readable instructions that, when executed by the one or more processors, cause the one or more processors to:
identify one or more objects;
add the one or more objects to a master queue;
determine that a first quantity of objects from a first main display queue is not at a first capacity;
in response to determining that the first quantity of objects from the first main display queue is not at the first capacity, add a first object from the master queue to the first main display queue;
determine that a second quantity of objects from a second main display queue is not at a second capacity;
in response to determining that the second quantity of objects from the second main display queue is not at the second capacity, add a second object from the master queue to the second main display queue;
cause display, via one or more first main displays, of a first graphical user interface with one or more objects from the first main display queue; and
cause display, via one or more second main displays, of a second graphical user interface with one or more objects from the second main display queue.

12. The computing system of claim 11, wherein execution of the computer-readable instructions by the one or more processors, further causes the one or more processors to:
dynamically generate computer-executable build instructions for building the one or more objects from the first main display queue and the one or more objects from second main display queue;
group the computer-executable build instructions into build sets based on one or more actions for building the one or more objects from the first main display queue and the one or more objects from second main display queue; and
cause display, via the one or more first main displays or the one or more second main displays, of the build sets.

13. The computing system of claim 12, wherein execution of the computer-readable instructions by the one or more processors, further causes the one or more processors to:
identify one or more substations, each of the one or more substations corresponding to a respective portion of the computer-executable build instructions; and
for each respective portion of the computer-executable build instructions:
transmit the respective portion of the computer-executable build instructions to a corresponding substation of the one or more substations, wherein the corresponding substation executes the respective portion of the computer-executable build instructions, wherein executing the respective portion of the computer-executable build instructions causes the corresponding substation to perform a respective build step of a respective object of the one or more objects from the first main display queue and the one or more objects from second main display queue; and
cause display, via one or more displays of the one or more substations, of the respective build step.

14. The computing system of claim 13, wherein execution of the computer-readable instructions by the one or more processors, further causes the one or more processors to:
cause simultaneous display, via a display of the one or more displays of the one or more substations, of build steps of two objects of the one or more objects from the first main display queue and the one or more objects from the second main display queue.

15. The computing system of claim 13, wherein execution of the computer-readable instructions by the one or more processors, further causes the one or more processors to:
cause display, via the one or more first main displays, for each of the one or more objects from the first main display queue, of a first main visual identifier;
cause display, via the one or more second main displays, for each of the one or more objects from the second main display queue, of a second main visual identifier; and
cause display, via the one or more displays of the one or more substations, of a substation visual identifier visually corresponding to the first main visual identifier or to the second main visual identifier.

16. The computing system of claim 15, wherein the substation visual identifier shares a color with the first main visual identifier or the second main visual identifier.

17. A computing system for dynamically allocating objects between first and second queues, the computing system comprising:
one or more processors; and
a computer-readable storage medium storing computer-readable instructions that, when executed by the one or more processors, cause the one or more processors to:
identify one or more objects;
add the one or more objects to a master queue;
determine a first quantity of objects from a first main display queue;
determine a second quantity of objects from a second main display queue;
at least one of:
in response to determining that the first quantity of objects is not at a first capacity and the first quantity of objects is less than or equal to the second quantity of objects, add an object from the master queue to the first main display queue;
in response to determining that the first quantity of objects is not at a first capacity and the first quantity of objects exceeds the second quantity of objects, add an object from the master queue to the second main display queue; or
in response to determining that the first quantity of objects is at the first capacity and the second quantity of objects is not at a second capacity, add an object from the master queue to the second main display queue;
cause display, via one or more first main displays, of a first graphical user interface with one or more objects from the first main display queue; and
cause display, via one or more second main displays, of a second graphical user interface with one or more objects from the second main display queue.

18. The computing system of claim 17, wherein execution of the computer-readable instructions by the one or more processors, further causes the one or more processors to:
dynamically generate computer-executable build instructions for building the one or more objects from the first main display queue and the one or more objects from the second main display queue;
group the computer-executable build instructions into build sets based on one or more actions for building the one or more objects from the first main display queue and the one or more objects from the second main display queue;
cause display, via the one or more first main displays or the one or more second main displays, of the build sets;
identify one or more substations, each of the one or more substations corresponding to a respective portion of the computer-executable build instructions; and
for each respective portion of the computer-executable build instructions:
transmit the respective portion of the computer-executable build instructions to a corresponding substation of the one or more substations, wherein the corresponding substation executes the respective portion of the computer-executable build instructions, wherein executing the respective portion of the computer-executable build instructions causes the corresponding substation to perform a respective build step of a respective object of the one or more objects from the first main display queue and the one or more objects from the second main display queue; and
cause display, via one or more displays of the one or more substations, of a respective status of the respective build step.

19. The computing system of claim 18, wherein, for each respective portion of the computer-executable build instructions, the respective status of the respective build step comprises a ready to perform status, a performing status, or a complete status.

20. The computing system of claim 18, wherein, for each respective portion of the computer-executable build instructions, the respective build step comprises dispensing an ingredient.

21. The computing system of claim 17, wherein execution of the computer-readable instructions by the one or more processors, further causes the one or more processors to:
allocate a second object from the master queue to the first main display queue based on at least one of a characteristic of a user associated with the first main display queue, an equipment availability of equipment associated with the first main display queue, or a build time associated with the second object.

22. The computing system of claim 17, wherein execution of the computer-readable instructions by the one or more processors, further causes the one or more processors to:
receive a first status indication associated with a user, wherein the user is associated with the first main display queue, and wherein the first status indication indicates the user is active;
based on the user being associated with the first main display queue and the first status indication indicating that the user is active, allocate a second object from the master queue to the first main display queue;
receive a second status indication associated with the user, wherein the second status indication indicates the user is inactive; and
based on the user being associated with the first main display queue and the first status indication indicating that the user is inactive, allocate a third object from the master queue to the second main display queue.
